(19) United States
(12) Patent Application Publication
(10) Pub. No.: US 2026/0237047 A1
(43) Pub. Date: Aug. 13, 2026

(54) Future Anomaly Change Prediction Using Images and Platform Data

(71) Applicant: The Boeing Company, Arlington, VA (US)

(72) Inventors: Esteban Fernando Lopez, St. Louis, MO (US); Peter Geoffrey Rhodes, Bridgeton, MO (US); Liessman Eric Sturlaugson, St. Louis, MO (US)

(21) Appl. No.: 19/641,726

(22) Filed: Apr. 8, 2026

Related U.S. Application Data
(63) Continuation-in-part of application No. 19/320,156, filed on Sep. 5, 2025.
(60) Provisional application No. 63/754,875, filed on Feb. 6, 2025.

(51) Int. Cl. G06T 7/00; B64F 5/60; G06V 10/774; G06V 10/776; G06V 10/26

(52) U.S. Cl. CPC G06T 7/0002; B64F 5/60; G06V 10/774; G06V 10/776; G06T 2207/20081; G06V 10/26

(57) ABSTRACT

A method for predicting anomalies. An input image of a location on a platform at a reference time frame, a future time frame, and platform data from the reference time frame to the future time frame are identified. An output image of the location with a number of parameters for an anomaly at the location on the platform is generated using the input image, the reference time frame, the future time frame, the platform data, and the anomaly analysis system in response to identifying the input image, the future time frame, and the platform data. The anomaly analysis system comprises a machine learning model system configured to output images of locations on platforms with parameters predicted for anomalies on platforms for future time frames. A number of actions is performed based on the output image output image of the location with the number of parameters for the anomaly.

### CROSS-REFERENCE TO RELATED APPLICATIONS

This application is a Continuation-in-Part of U.S. Patent Application Serial No. 19/320,156, filed September 5, 2025, and entitled “Anomaly Prediction Using Images,” which claims the benefit of U.S. Provisional Patent Application Serial No. 63/754,875, filed February 6, 2025, and entitled “Anomaly Prediction Using Images,” which are incorporated herein by reference in their entirety.

This application is related to the following U.S. Patent Application Serial No. _________, Attorney Docket No. 24-1740-US-CIP[2], entitled “Anomaly Prediction Using Images,” filed even date hereof, assigned to the same assignee, and incorporated herein by reference in its entirety.

### BACKGROUND INFORMATION

### 1. Field

The present disclosure relates generally to aircraft and in particular, to predicting anomalies in aircraft.

### 2.Background

Anomalies can appear on an aircraft over time. These anomalies can occur from various conditions such as exposure to the environment and stresses operating the aircraft over time. As an aircraft ages, anomalies can also arise from wear and tear. These anomalies can include cracks, corrosion, delamination, dents or other inconsistencies caused by foreign objects.

The presence of these anomalies can impact one or more of the structural integrity, aerodynamics and operating efficiency of the aircraft. As a result, inspections and maintenance are performed on a regular basis to detect and reduce the occurrence of anomalies.

In detecting anomalies on an aircraft, images are captured by sensor systems. These images can include infrared, camera, and ultraviolet images. These images can be used in computer vision and other image processing software to identify and classify anomalies such as cracks, dents, or corrosion.

### SUMMARY

An embodiment of the present disclosure provides an anomaly prediction system comprising a computer system; an anomaly analysis system in the computer system; and anomaly predictor. The anomaly analysis system comprises a machine learning model system configured to output images of locations on platforms with parameters predicted for anomalies on platforms for future time frames using inputs comprising input images of locations on the platforms at reference time frames and platform data for the platforms from the reference time frames to the future time frames. The anomaly predictor is in the computer system and is configured to perform operations. The operations comprise identifying an input image of a location on a platform at a reference time frame, a future time frame after the reference time frame, and the platform data from the reference time frame to the future time frame. The operations comprise generating an output image of the location with a number of parameters for an anomaly at the location on the platform using the input image, the reference time frame, the future time frame, the platform data, and the anomaly analysis system in response to identifying the input image of the location on the platform at the reference time frame, the future time frame after the reference time frame, and the platform data from the reference time frame to the future time frame. The operations comprise performing a number of actions based on the output image of the location with a number of parameters for the anomaly at the location on the platform.

Another embodiment of the present disclosure provides a method for predicting anomalies. An input image of a location on a platform at a reference time frame, a future time frame after the reference time frame, and platform data from the reference time frame to the future time frame are identified. An output image of the location with a number of parameters for an anomaly at the location on the platform is generated using the input image, the reference time frame, the future time frame, the platform data, and the anomaly analysis system in response to identifying the input image of the location on the platform at the reference time frame, the future time frame after the reference time frame, and the platform data from the reference time frame to the future time frame, wherein the anomaly analysis system comprises a machine learning model system configured to output images of locations on platforms with parameters predicted for anomalies on platforms for future time frames using inputs comprising input images of locations on the platforms at reference time frames and platform data for the platforms from the reference time frames to the future time frames. A number of actions is performed based on the output image of the location with the number of parameters for the anomaly at the location on the platform.

Yet another embodiment of the present disclosure provides a computer program product for predicting anomalies. The computer program product comprises a set of one or more computer-readable storage media; and program instructions stored on the set of one or more storage media to perform operations. The operations comprise identifying an input image of a location on a platform at a reference time frame, a future time frame after the reference time frame, and platform data from the reference time frame to the future time frame. The operations comprise generating an output image of the location with a number of parameters for an anomaly at the location on the platform using the input image, the reference time frame, the future time frame, the platform data, and the anomaly analysis system in response to identifying the input image of the location on the platform at the reference time frame, the future time frame after the reference time frame, and the platform data from the reference time frame to the future time frame, wherein the anomaly analysis system comprises a machine learning model system configured to output images of locations on platforms with parameters predicted for anomalies on platforms for future time frames using inputs comprising input images of locations on the platforms at reference time frames and platform data for the platforms from the reference time frames to the future time frames. The operations comprise performing a number of actions based on the output image of the location with the number of parameters for the anomaly at the location on the platform.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of an anomaly detection system of data processing systems in which illustrative embodiments may be implemented;

FIG. 2 is an illustration of a block diagram of an anomaly prediction environment in accordance with an illustrative embodiment;

FIG. 3 is an illustration of a block diagram of an anomaly analysis system in accordance with an illustrative embodiment;

FIGS. 4A-4B are an illustration of a training system to train a machine learning model to output images with parameters predicted for anomalies at locations on platforms for future time frames in accordance with an illustrative embodiment;

FIG. 5 is an illustration of a dataflow of training in a segmentation model in accordance with an illustrative embodiment;

FIG. 6 is an illustration of using a segmentation model to generate an output image with a number of parameters predicted for an anomaly in accordance with an illustrative embodiment;

FIG. 7 is an illustration of using a segmentation model to generate an output image with a number of parameters predicted for an anomaly in accordance with an illustrative embodiment;

FIG. 8 is an illustration of passing data into a segmentation model in accordance with an illustrative embodiment;

FIG. 9 is an illustration of a generative artificial intelligence model used to generate an output image of a number of parameters predicted for an anomaly in accordance with an illustrative embodiment;

FIG. 10 is an illustration of images for an anomaly in accordance with an illustrative embodiment;

FIG. 11 is an illustration of a heat map of an aircraft in accordance with an illustrative embodiment;

FIG. 12 is an illustration of images for growth prediction of an anomaly in accordance with an illustrative embodiment;

FIG. 13 is an illustration of images for change prediction of an anomaly in accordance with an illustrative embodiment;

FIG. 14 is an illustration of images for a subsurface prediction in accordance with an illustrative embodiment;

FIG. 15 is an illustration of a flowchart of a process for predicting an anomaly in accordance with an illustrative embodiment;

FIG. 16 is an illustration of a flowchart of a process for generating output images from output masks in accordance with an illustrative embodiment;

FIG. 17 is an illustration of a flowchart of a process for performing maintenance in accordance with an illustrative embodiment;

FIG. 18 is an illustration of a flowchart of a process for generating material performance data in accordance with an illustrative embodiment;

FIG. 19 is an illustration of a flowchart of a process for generating an output image in accordance with an illustrative embodiment;

FIG. 20 is an illustration of a flowchart of a process for displaying an output image in accordance with an illustrative embodiment;

FIG. 21 is an illustration of a flowchart of a process for training a machine learning model in accordance with an illustrative embodiment;

FIG. 22 is an illustration of a flowchart of a process for predicting an anomaly in accordance with an illustrative embodiment;

FIG. 23 is an illustration of a flowchart of a process for performing actions in accordance with an illustrative embodiment;

FIG. 24 is an illustration of a flowchart of process for predicting current subsurface anomalies in accordance with an illustrative embodiment;

FIG. 25 is an illustration of a flowchart of a process for creating an output image in accordance with an illustrative embodiment;

FIG. 26 is an illustration of a flowchart of a process for predicting future changes in anomalies in accordance with an illustrative embodiment;

FIG. 27 is an illustration of a flowchart of a process for predicting future subsurface anomalies in accordance with an illustrative embodiment;

FIG. 28 is an illustration of flowchart of a process for training machine learning models in accordance with an illustrative embodiment;

FIG. 29 is an illustration of a flowchart of a process for predicting surface and subsurface and surface anomalies in accordance with an illustrative embodiment;

FIG. 30 is an illustration of a flowchart of a process for training machine learning models in accordance with an illustrative embodiment;

FIG. 31 is an illustration of a flowchart of a process for predicting subsurface and surface anomalies in accordance with an illustrative embodiment;

FIG. 32 is an illustration of a flowchart of a process for predicting the change in an anomaly in accordance with an illustrative embodiment;

FIG. 33 is an illustration of a block diagram of a data processing system in accordance with an illustrative embodiment;

FIG. 34 is an illustration of a block diagram of an aircraft manufacturing and service method in accordance with an illustrative embodiment; and

FIG. 35 is an illustration of a block diagram of an aircraft in which an illustrative embodiment may be implemented.

### DETAILED DESCRIPTION

The illustrative embodiments recognize and take into account one or more different considerations as described herein. Machine learning models can be used to analyze images of an airplane. These machine learning models can detect anomalies. For example, the machine learning model such as a convolution on neural network (CNN) can be trained to analyze features such as texture, color changes, and patterns to detect and identify anomalies. These types of models can be trained using training data including examples of different types of anomalies.

However, current machine learning models do not provide for predicting changes or occurrences of anomalies at a future time from a current image of the aircraft. It would be desirable to have an anomaly detection system that can identify anomalies and predict how these anomalies change over time.

In the illustrative examples, an anomaly detection system identifies anomalies in an aircraft structure and predicts how these anomalies will change over time. These changes can be how an anomaly may grow in size, move, or propagate over time.

Further, the anomaly detection system can also make this prediction of future anomalies using physics data. This physics data can be obtained from physics models and may be used to estimate the growth of an inconsistency after a defined amount of use. This defined amount of time can be measured in a number of different ways. For example, the time can be measured in days, hours, a number of flight cycles, flight hours, time since last maintenance, or some other measure of time. Further, the knowledge detection system can also determine whether the anomaly at a future point in time will be within a tolerance. This anomaly detection system can also be used to determine whether an anomaly will develop even though one has not been detected in a current image of the aircraft. This knowledge can help determine when maintenance should be performed on the aircraft.

As used herein, “a number of” when used with reference to items, means one or more items. For example, “a number of flight cycles” is one or more flight cycles.

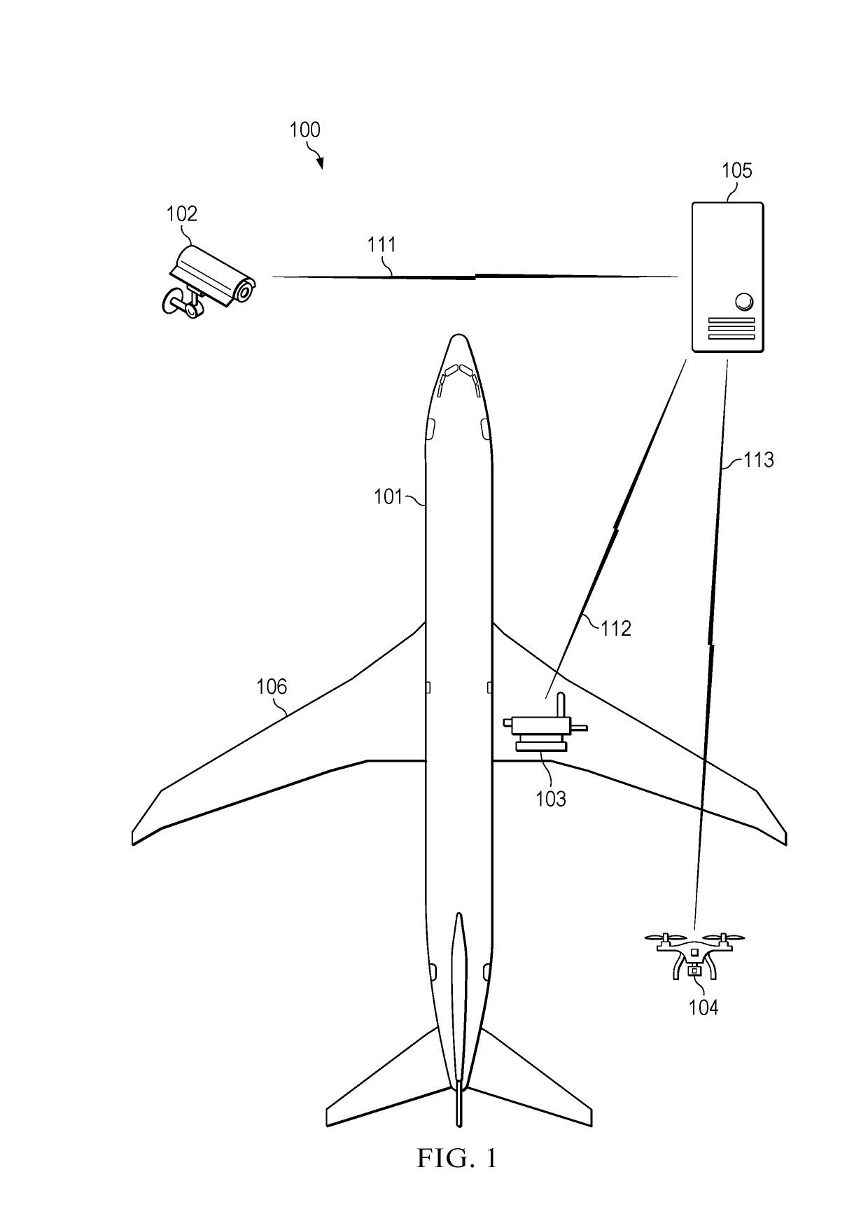

With reference now to the figures and, in particular, with reference to FIG. 1, a pictorial representation of an anomaly detection system of data processing systems is depicted in which illustrative embodiments may be implemented. In this illustrative example, anomaly prediction system 100 detects anomalies on airplane 101. In this example, this anomaly prediction system 100 can predict anomalies at a future point in time using current images generated for airplane 101.

As depicted in this example, anomaly prediction system 100 comprises camera 102, crawler 103, drone 104, and computer 105. In this example, camera 102, crawler 103, and drone 104 form a sensor system in which these components generate images of surface 106 of airplane 101.

Camera 102 is in a fixed location such as in a hangar bay, a maintenance building, or other suitable location where airplane 101 may be located. Crawler 103 moves on surface 106 of airplane 101. Drone 104 flies in locations relative to airplane 101.

Computer 105 is in communication with camera 102, crawler 103, and drone 104 using wireless communications links. For example, camera 102 has wireless communications link 111 with computer 105; crawler 103 has wireless communications link 112 with computer 105; and drone 104 has wireless communications link 113 with computer 105.

Camera 102, crawler 103, and drone 104 generate images of airplane 101. These images are sent to computer 105 over these wireless communications link connections for processing. In this illustrative example, computer 105 has a program code to process the images generated by these devices. For example, computer 105 is configured to predict the occurrence of anomalies or changes in anomalies at a future time frame from the current one in which the images are generated.

In this manner, the prediction of anomalies at a future time frame from current images can be used to determine when maintenance may be needed for airplane 101. Thus, maintenance can be performed in a manner that reduces the unavailability of aircraft when additional time is needed as compared to detecting anomalies at a point in time in which maintenance is needed more quickly.

The illustration of anomaly prediction system 100 in FIG. 1 is one example of an anomaly detection system and is not meant to limit the manner in which other examples can be implemented. For example, in other illustrative examples only stick cameras and stationary positions may be present. In yet other examples, one or more drones in addition to drone 104 may be used with or without crawler 103 and camera 102.

Although camera 102, crawler 103, drone 104 have been described to implement detect sensors that generate images of surface 106, these components in the sensor system can include sensors that detect wavelengths other than the visible light spectrum. For example, at least one of camera 102, crawler 103, and drone 104 can include sensors that generate images in an infrared wavelength. In yet another example, crawler 103 can include a sensor that detects ultrasonic waves to generate ultrasonic images. In yet another illustrative example, one or more of these components can include sensors to detect x-rays emitted from a source through portions of airplane 101.

These different types of images can be used by computer 105 to predict anomalies or changes in anomalies at a future time frame from the current one or at least one of surface anomalies or subsurface anomalies. In other words, an illustrative example can be used to predict surface anomalies, subsurface anomalies, or both surface and subsurface anomalies for future time frames.

For example, images of surface 106 can be used to predict at least one of surface anomalies or subsurface anomalies at a future time frame. In another example, images from ultrasound scans can also be used to predict at least one of surface anomalies or subsurface anomalies at a future time frame.

Further, predictions of subsurface anomalies can be made in addition to surface anomalies at the same time for a future time. In these examples, subsurface anomalies can be from images of surface anomalies at the time at which the image of the surface anomaly is generated. Also in these examples, predictions of subsurface anomalies for future times can be even when surface anomalies are not present at those locations using platform data such as aircraft operational data.

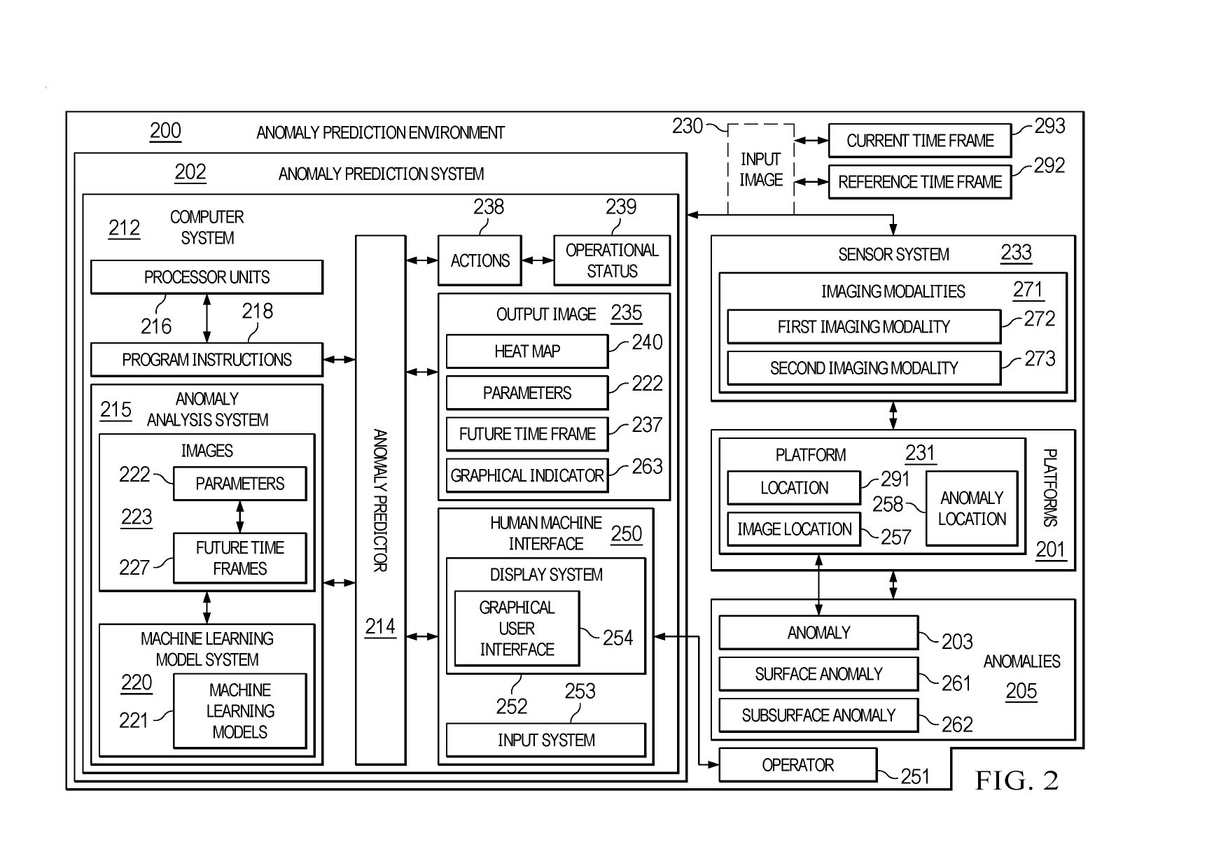

With reference now to FIG. 2, an illustration of a block diagram of an anomaly prediction environment is depicted in accordance with an illustrative embodiment. In this illustrative example, anomaly prediction environment 200 is an environment in which prediction of anomalies 205 at locations on platforms 201 is performed using anomaly prediction system 202. Anomaly prediction system 100 in FIG. 1 is an example of an implementation for anomaly prediction system 202.

In this example, platform 231 in platforms 201 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, an unmanned aerial vehicle, an artificial intelligence controlled drone, a surface ship, a tank, a personnel carrier, a train, a spacecraft, a space station, a satellite, a high altitude platform system (HAPS), a submarine, an automobile, a power plant, a bridge, a dam, a house, a manufacturing facility, a building, and other types of platforms.

In this illustrative example, anomaly prediction system 202 comprises computer system 212, anomaly analysis system 215, and anomaly predictor 214. Anomaly analysis system 215 and anomaly predictor 214 are located in computer system 212.

Anomaly analysis system 215 includes machine learning model system 220. In this illustrative example, machine learning model system 220 is formed from a number of machine learning models 221. Machine learning model system 220 is configured to create images 223 with number of parameters 222 predicted for anomalies 205, at future time frames 227, using inputs comprising input images of platforms 201 and future time frames 227.

In this example, a future time frame can take a number of different forms. For example, the future time frame can be measured in hours, days, flight hours, a selected date in the future, engine cycles, flight cycles, and other measurements of time.

For example, each of the number of machine learning models 221 can be trained to output images with parameters 222 for anomalies 205 at locations on platforms 201 for future time frames 227. Individual machine learning models may be trained to predict particular types of anomalies 205 as compared to other machine learning models in machine learning models 221.

Further, individual machine learning models can also be trained to output images with a number of parameters 222 predicted for anomalies 205 for specific future time frames. In other words, a particular machine learning model can be trained to generate output images with a number of parameters 222 predicted for anomalies 205 for a future time frame such as 250 flight hours while another machine learning model can be trained to output images with a number of parameters 222 predicted for anomalies 205 for a future time frame such as 500 flight hours. In other cases, a machine learning model can be trained to yield output images with a number of parameters 222 predicted for anomalies 205 for ranges of future time frames 227.

In these illustrative examples, machine learning models 221 can be trained to output images with anomalies of different types. For example, an image can include a single type of anomaly or multiple types of anomalies depending on the particular training for a machine learning model.

The types of anomalies 205 can take a number of forms. For example, anomalies 205 can be selected from at least one of a corrosion, a crack, a delamination, a dent, a pealed paint, a buckling, a debonding, an oxidation, a pit, an abrasion, an impact inconsistency, a panel misalignment, a material irregularity, a manufacturing irregularity, and thermal-induced nonuniformity, a fatigue-induced nonuniformity, or other types of anomalies.

In this illustrative example, the number of machine learning models 221 can take a number of different forms. These models can be all of the same type or different types of machine learning models when more than one machine learning model is present in the number of machine learning models 221. For example, the number of machine learning models 221 can select at least one of a segmentation model, a generative artificial intelligence model, a convolution on neural network (CNN), a fully convolutional neural network (CNN), a U-Net model, a DeepLab model, a support vector machine (SVM), or other suitable models that can be trained to perform segmentation functions such as classifying pixels in an image into categories. Models in machine learning models 221 are considered segmentation models even though their primary architecture may not be for classifying pixels in an image into specific categories. These models are considered segmentation models because they can be trained to perform segmentation functions such as classifying pixels in an image into categories.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Anomaly predictor 214 can be implemented in software, hardware, firmware or a combination thereof. When software is used, the operations performed by anomaly predictor 214 can be implemented in program instructions configured to run on hardware, such as a processor unit. When firmware is used, the operations performed by anomaly predictor 214 can be implemented in program instructions and data and stored in persistent memory to run on a processor unit. When hardware is employed, the hardware can include circuits that operate to perform the operations in anomaly predictor 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

Anomaly predictor 214 can identify an input image 230 of platform 231 in platforms 201 selected for inspection. In this example, input image 230 can be identified by being received from sensor system 233. Sensor system 233 is configured to generate input image 230. Sensor system 233 can be comprised of at least one of a camera, a visible light camera, a thermal imaging camera, an ultraviolet light camera, a hyperspectral camera, a laser scanner, an x-ray system, an ultrasound system, a computed-tomography rotating detector array, or other type of sensor that can generate sensor data that can be used to form an image, such as input image 230.

Further in this example, input image 230 can take a number of different forms. For example, input image 230 can be selected from a group comprising a visible light image, an infrared image, an ultraviolet lights image, a synthetic aperture radar image, a three dimensional image, and other suitable types of images that can be processed to generate output images with a number of parameters 222 predicted for anomalies 205.

In this illustrative example, anomalies 205 can include at least one of surface anomaly 261 or subsurface anomaly 262. Surface anomaly 261 can be, for example, one of a corrosion, a crack, a delamination, a dent, pealed paint, buckling, desponding, oxidation, a pit, an abrasion, an impact inconsistency, a panel misalignment, or other types of anomalies found on the surface of platform 231. Subsurface anomaly 262 can be, for example, one of a crack, a corrosion, delamination, a debonding, a material irregularity, a manufacturing irregularity, a thermal-induced nonuniformity, a fatigue-induced nonuniformity, and other anomalies that can be found under the surface of platform 231. In this example, subsurface anomaly 262 is not directly observable by a human operator, such as operator 251, viewing platform 231. Subsurface anomaly 262 can be hidden underneath paint, coatings, and other materials.

Further, in some examples, surface anomaly 261 is not present at location 291 where subsurface anomaly 262 is present. In other words, location 291 may not give any indication that any anomaly is present below the surface.

Anomaly predictor 214 generates output image 235 with the number of parameters 222 predicted for anomaly 203 on platform 231 at future time frame 237 using the input image 230 of platform 231, future time frame 237, and anomaly analysis system 215 in response to identifying input image 230 generated at reference time frame 292 . Output image 235 can take a number of different forms. For example, output image 235 can be selected from a group comprising a mask, a color image, a grayscale image, and other suitable types of images.

In this example, reference time frame 292 is a discrete point in time at which input image 230 is generated. Further in this example, future time frame 237 is a time interval defined relative to reference time frame 292.

In one example, future time frame 237 is a fixed amount of flight hours measured forward from reference time frame 292. For example, if reference time frame 292 occurs at 1,270 flight hours and future time frame 237 is 250 flight hours, future time frame ends at 1,520 flight hours.

In another example, future time frame 237 is a cumulative amount of flight hours relative to a baseline, including flight hours accumulated prior to establishment of the reference time frame 292. For example, if 100 flight hours have already accumulated and future time frame 237 is 250 flight hours, future time frame 237 ends after a total of 350 flight hours.

In this illustrative example, the number of parameters 222 can describe at least one of a size, a shape, a dimension, an aspect ratio, an orientation, a location, or other information about anomaly 203. In this example, size can be represented as an area. The number of parameters 222 can be used to identify at least one of a growth, a change in shape, an expansion, or a movement of anomaly 203.

In some illustrative examples, input image 230 does not show a presence of anomaly 203. Anomaly 203 can develop at future time frame 237 and be visible in output image 235. In other illustrative examples, input image 230 shows anomaly 203 and output image 235 shows a change in anomaly 203.

In the illustrative examples, anomaly predictor 214 can generate output image 235 with the number of parameters 222 predicted for anomaly 203 on platform 231 for a number of future time frames 227 using input image 230 of platforms 201, the number of future time frames 227, and anomaly analysis system 215. In this example, output image 235 provides a visualization of the number of parameters 222 predicted for anomaly 203 for the number of future time frames 227.

In another example, output image 235 provides a visualization of anomaly 203 based on probabilities for anomaly sizes.

Anomaly predictor 214 performs a number of actions 238 based on output image 235. In this illustrative example, the number of actions 238 comprises at least one of storing the output image 235, generating an alert in response to output image 235 for the number of parameters 222 predicted for anomaly 203 at future time frame 237 being out of a tolerance, scheduling maintenance for the platform 231, displaying output image 235, or sending an email message with output image 235, or other suitable actions.

The particular action performed can depend on whether anomaly 203 is out of tolerance. The tolerance can be determined based on specifications, regulations, or other guidelines governing anomalies on platform 231, such as an aircraft.

As another example, anomaly predictor 214 performs a number of actions 238 based on output image 235 in which the number of actions 238 relate to operational status 239 of platform 231. In this example, operational status 239 of platform 231 refers to one or more physical and operational characteristics that collectively define at least one of current state, deployment condition, or readiness for use of platform 231. These characteristics include, for example, at least one of maintenance status, service status, assignment status, or location status.

In this example, maintenance status indicates the operational readiness of platform 231. This status can be operational, under maintenance, or non-operational. An operational maintenance status indicates platform 231 is ready for deployment and use. An under maintenance status indicates platform 231 is undergoing scheduled preventive maintenance, inspections, or repairs. A non-operational status indicates platform 231 is unavailable for use due to required maintenance or other limitations.

The service status indicates whether platform 231 is available for operational deployment and may indicate that platform 231 is in-service or has been removed from service. An in-service status indicates platform 231 is available for active deployment. A removed from service status indicates platform 231 has been withdrawn from active use, grounded, or placed in reserve status.

The assignment status indicates the operational scenario, mission profile, or theater to which platform 231 is deployed and can reflect the specific operational context for which platform 231 is designated. The assignment status may indicate at least one of mission type, operational theater, geographic region, or specific operational scenario. Modifying assignment status can include reassigning platform 231 to a different mission type, designating platform 231 for a different operational theater, or changing the operational scenario for which platform 231 is configured.

The location status indicates the physical position or facility where platform 231 is located and can include deployment position, storage location, base assignment, or geographical area. Modifying location status can include moving platform 231 to a different base, relocating platform 231 to a storage facility, repositioning platform 231 to a different deployment zone, or transferring platform 231 to another geographical region.

Thus, modifying operational status 239 can include taking tangible physical actions that change at least one of these characteristics, thereby altering how the platform is deployed, maintained, assigned, or positioned in operational contexts.

Examples of additional actions for the number of actions 238 can include determining whether an acceptable threshold for an anomaly has been or will be exceeded. This determination can be performed in a number different ways. For example, a linear or binary search can be performed. With a linear search, anomaly values for parameters for the anomaly are evaluated one at a time. When using a binary search, the values for the parameters are sorted into an ascending or descending order. Then a search is performed starting at the midpoint in which the value is compared to the threshold. The lower half of the values are discarded if the anomaly score is less than the threshold. If evaluated midpoint is greater than or equal to the threshold, the values in the upper half are discarded. This type of search can be repeated until values are no longer present for searching or a value exceeding the threshold is found.

In displaying output image 235, anomaly predictor 214 can display output image 235 on human machine interface 250. In this illustration, human machine interface (HMI) 250 is an interface system that can be used by operator 251 to interact with different components in computer system 212. As depicted, human machine interface 250 comprises display system 252 and input system 253.

Display system 252 is a physical hardware system and includes one or more display devices on which graphical user interface 254 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

Operator 251 is a person that can interact with graphical user interface 254 through user input generated by input system 253 for computer system 212. Input system 253 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device.

In another illustrative example, anomaly predictor 214 predicts the number of parameters 222 for a number of anomalies 205 in addition to anomaly 203 to form a plurality of anomalies 205 for future time frame 237. In this example, output image 235 is a heat map indicating locations of the plurality of anomalies 205 at future time frame 237. The plurality of anomalies 205 can be visualized at the locations on platforms 201 in output image 235.

In another illustrative example, anomaly predictor 214 predicts the number of parameters 222 for a number of anomalies 205 in addition to anomaly 203 to form a plurality of anomalies 205 for future time frame 237. With this example, output image 235 is a heat map indicating a size of each of a plurality of anomalies 205 at future time frame 237.

In this illustrative example, the different operations performed to generate output image 235 with the number of parameters 222 can be used in a practical application with respect to platform 231. For example, the practical application of these operations performed by anomaly predictor 214 can be the performance of maintenance on platform 231. The practical application of performing maintenance can include at least one of a human operator or a robotic system performing maintenance on platforms 201. In other examples, this practical application can include scheduling the maintenance. For example, operator 251 can schedule maintenance for platform 231 in response to viewing output image 235 displayed in graphical user interface 254 in display system 252.

Thus, the predictions for future states of anomalies at future time frames can be used to schedule maintenance on aircraft or other platforms. These predictions can determine when maintenance is needed accurately and with more fidelity as compared to normal maintenance schedules. As a result, less unexpected maintenance may be incurred with these more accurate predictions of parameters for anomalies at future states. As a result, the illustrative examples provide a practical application for predicting future states of anomalies.

Additionally, predictions of anomalies 205 not detectable by one type of sensor can be predicted without using another type of sensor. In other words, the prediction of subsurface anomaly 262 can be made from surface anomaly 261 in the current time frame in addition to at one or more future time frames 227.

In an illustrative example, sensor system 233 can generate images with a number of imaging modalities 271. For example, sensor system 233 can use first imaging modality 272 in the number of imaging modalities 271 that operates within a first image-generation domain and employs a first image-formation mechanism. Sensor system 233 can also use second imaging modality 273 in the number of imaging modalities 271 that operates within a second image-generation domain and employs a second image formation mechanism that differs from the first image-formation mechanism.

In these examples, an image generation domain is a classification of imaging operations defined by a category of information sources from which image data is derived, without limitation to any particular wavelength range, sensor architecture, or hardware implementation. An image-formation mechanism is a process or computational procedure by which information associated with an image-generation domain is converted into image data, without limitation to any particular physical principle, detection method, or signal type.

For example, input image 230 can be a visible light image generated by a visible light camera in sensor system 233. This visible light camera is unable to detect subsurface anomaly 262. As a result, subsurface anomaly 262 does not appear in input image 230. However, with anomaly predictor 214 using machine learning model system 220, anomaly predictor 214 can generate output image 235 with a number of parameters 222 for subsurface anomaly 262. This type of prediction can be performed without needing to use additional different types of sensors that are capable of generating images of subsurface anomalies.

Subsurface anomaly 262 can be subsurface corrosion that appears as surface anomaly 261 in the form of paint bubbling or discoloration. As another example, subsurface anomaly 262 can be a subsurface crack that appears as surface anomaly 261 in the form of cracking paint. In yet another example, subsurface anomaly 262 can be a subsurface impact inconsistency that appears as surface anomaly 1410 in the form of surface unevenness.

Thus, anomaly predictor 214 can use machine learning model system 220 to perform subsurface prediction to predict the extent of subsurface anomaly 262 at reference time frame 292 using input image 230 of surface anomaly 261 at the same location. For example, if a paint crack is sanded down, the sanding can expose delamination below the surface. With the use of anomaly predictor 214, this type of prediction can be made to identify the extent of delamination based on input image 230 without needing to perform sanding or otherwise alter platforms 201.

In one example, reference time frame 292 is a current point in time when an inspection is made. In another example, reference time frame 292 can be the time at which the image was taken at a previous time.

Further, anomaly predictor 214 can predict the number of parameters 222 for a number of anomalies 205 in addition to subsurface anomaly 262 to form a plurality of anomalies 205 for future time frame 237. In this example, one or both additional subsurface and surface anomalies can be present at future time frame 237.

These anomalies can be of the same or different type. A change in the type of anomaly from one type to another type can also occur. For example, anomaly predictor 214 can identify input image 230 of location 291 at reference time frame 292 on platform 231 selected for inspection.

Additionally, a number of parameters 222 predicted for the number of anomalies 205 can also include the percentage or likelihood that each of anomalies 205 will be present. For example, the number of parameters 222 can include a prediction that there is a 40 percent chance that a first anomaly will be present and that there is a 31 percent chance that a second anomaly will be present in the number of anomalies 205. Additionally, the number of parameters 222 can include a probability that the sizes, types, severity, or other characteristics of the number of anomalies 205 will occur. For example, an anomaly in the number of anomalies 205 can have a number of parameters that indicates a first size and a probability of that first size occurring. The anomaly can also have a number of parameters that indicates a second size and a probability of that second size being present.

In this example, reference time frame 292 is a time used as the baseline for comparing or analyzing data such as images. Further in this example, location 291 is a bounded area associated for a portion of aircraft. In a two-dimensional form, the location is an area on a surface of platform 231 and is defined by boundaries that identify the extent of that area. In a three-dimensional form, location 291 includes depth that extends the surface area into a volume. Location 291 represents a region of platform 231 as either a surface area, an area under the surface, or a volume.

Anomaly predictor 214 generates output image 235 with the number of parameters 222 for anomaly 203 that predicts a change in anomaly 203 on platform 231 at future time frame 237 from reference time frame 292 using input image 230 of platform 231 and anomaly analysis system 215. In this example, the change is selected from at least one of a change in size of anomaly 203, a type of anomaly 203, or a severity of anomaly 203 at the future time frame.

For example, the change in the size of anomaly 203 can be an increase in the size or a decrease in the size. For example, a decrease in the size of anomaly 203 can occur as an anomaly progresses in severity.

In this example, the type of anomaly 203 can be the current type, such as paint wear, that becomes a new type such as bare metal. The wear can still be present in addition to the bare metal when a change in the type of anomaly occurs. The severity can have different levels such as mild, medium, and severe. In other examples, other numbers of subcategories and types of categories can be used for severity.

The output image 235 can be heat map 240 indicating locations of the plurality of anomalies 205 at future time frame 237. In another example, output image 235 can be heat map 240 indicating a size of each of the plurality of anomalies 205 at future time frame 237.

Also, anomaly predictor 214 can perform a number of operations. These operations comprise identifying input image 230 of surface anomaly 261 on platform 231 selected for inspection. The operations also comprise generating output image 235 with the number of parameters for subsurface anomaly 262 on platform 231 using input image 230 of surface anomaly 261 on platform 231 and anomaly analysis system 215 in response to identifying input image 230.

In this example, one or both additional subsurface and surface anomalies can be present at future time frame 237. These anomalies can be of the same or different type.

In this example, machine learning model system 220 is configured to output images with a number of parameters predicted for subsurface anomalies at locations on platforms 201 using inputs comprising input images of surface anomalies on the platforms.

Anomaly predictor 214 then performs a number of actions 238 based on output image 235 of subsurface anomaly 262. Thus, the use of anomaly prediction system 202 can enable predicting the presence of anomalies that cannot be detected using a particular sensor system such as a visible light camera. This prediction enables reducing the number of sensors needed to perform inspections of a platform 231. Further, this type of prediction may enable performing desired inspections when a particular type of sensor for subsurface anomalies is absent or not functioning. Also, this type of prediction of subsurface anomalies can enable reducing the amount of redundancy needed in sensor system 233.

In yet another illustrative example, input image 230 is an image generated at the image location 257 on platform 231. With this example, machine learning model system 220 is configured to output images with a number of parameters predicted for surface anomalies at anomaly locations on platforms 201 for future time frames using inputs comprising input images of platforms 201 at image locations and platform data for the platforms from the reference time frames to future time frames.

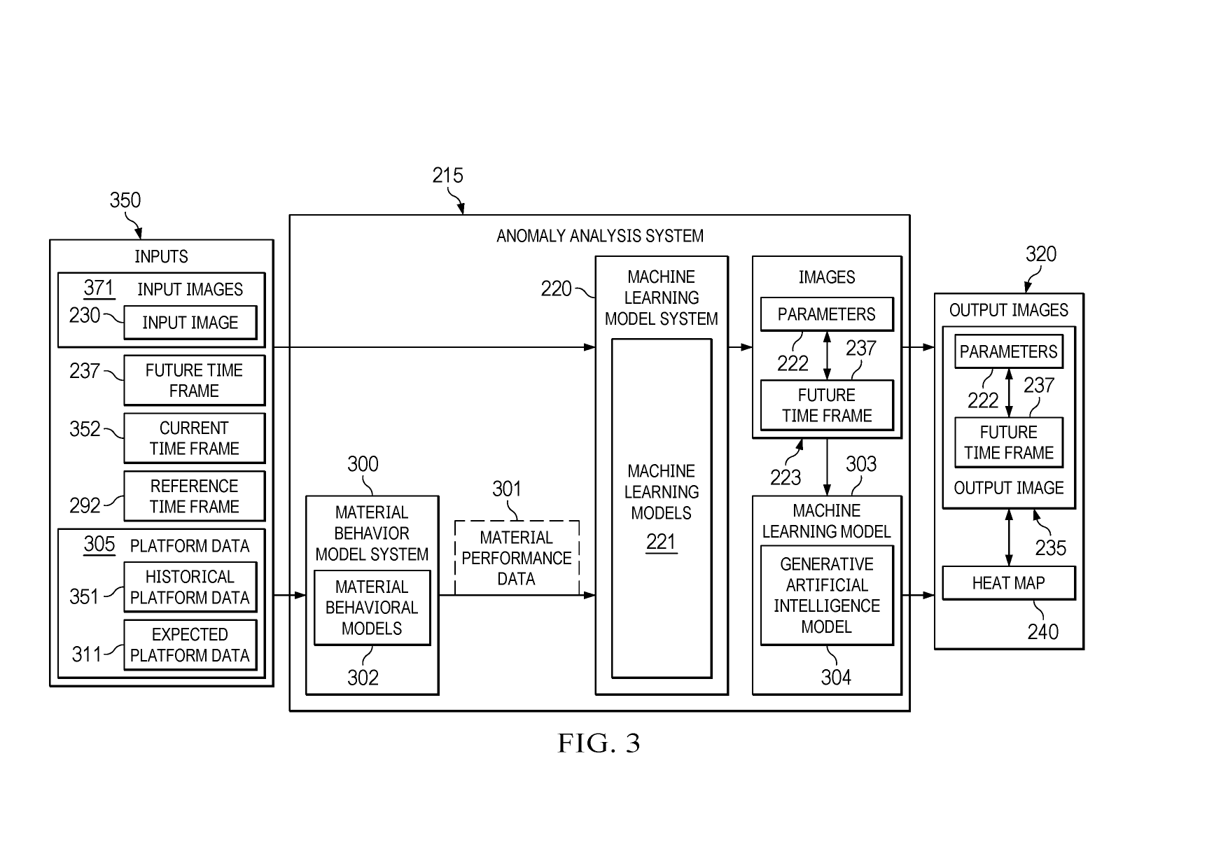

Turning to FIG. 3, an illustration of a block diagram of an anomaly analysis system is depicted in accordance with an illustrative embodiment. In the illustrative examples, the same reference numeral may be used in more than one figure. This reuse of a reference numeral in different figures represents the same element in the different figures.

As depicted, anomaly analysis system 215 receives input image 230 and future time frame 237 as inputs 350 to generate output image 235 with a number of parameters 222 predicted for platform 231 at future time frame 237. As depicted, these inputs are sent to machine learning model system 220 in anomaly analysis system 215.

As depicted, anomaly analysis system 215 can also include material behavior model system 300. In this example, material behavior model system 300 is configured to receive platform data 305 in inputs 350 and output material performance data 301 that is an input to machine learning model system 220. Platform data 305 is information about a platform.

For example, platform data 305 can be information about characteristics of a platform. For example, platform data 305 can comprise contextual information associated with the platform. This contextual information can be functional characteristics of the platform, physical condition characteristics of the platform, identification of the platform, historical usage of the platform, and environmental conditions for the platform. Platform data 305 can also include operational parameters, condition parameters, identity attributes, usage records, and environmental data suitable for characterizing behavior of the platform or circumstances associated with the platform.

This information can be obtained from measurements made by sensors for the platform or the environment around the platform. Further, this information can also include service information about the operation of the platform.

For example, platform data 305 comprises at least one of weather data, platform telemetry, temperature, a pressure, an acceleration, an engine temperature, a hydraulic pressure, a vibration, a tail number, maintenance data, a pilot identification, flight hours, engine cycles, flight cycles, route information, maintenance history, component removal history, a compliance record, or other suitable information with respect to the history for platforms 201.

For platform 231 in the form of an aircraft, platform data 305 can comprise at least one of a size of an anomaly, a type of anomaly, a location of the anomaly on the aircraft, a tail number, a base of the aircraft, a hangar for the aircraft, an aircraft model, an aircraft variant, an aircraft sub variant, flight hours, flight hours at a number of speeds, flight hours at a number of altitudes, a time since last maintenance of an area on the aircraft, a maintenance record of the aircraft, prior fleet data on a likelihood of a given anomaly changing, seasonality information (winter, summer, autumn, spring), aircraft stationary hours, and aircraft stationary hours in weather conditions (rain, humidity, sun exposure).

As depicted, material behavior model system 300 comprises a number of material behavioral models 302. These material behavior models can be implemented using a number of different types of models. For example, material behavioral models 302 can be selected from at least a physics based model, a chemical reaction model, an empirical model showing relationships from observations, program code implementing equations, a finite element analysis model, a machine learning model, or other suitable models. This model can be used for predicting anomalies including surface and subsurface anomalies.

For example, these material behavioral models can generate material performance data 301 in a number of different forms. For example, material performance data 301 can be selected from at least one of corrosion expansion data, oxidation, creep, total bending load, crack propagation, air resistance on surface, strain on a component, stress on a component, material degradation data, thermal degradation, chemical interaction data, cumulative stress over time, or other information. In this illustrative example, machine learning model system 220 can also be input into machine learning model system 220.

In this illustrative example, machine learning model system 220 can also receive platform data 305 in inputs 350. In some illustrative examples, images 223 are output images 320. Output image 235 is an example of an output image in output images 320. In another illustrative example, images 223 output by machine learning model system 220 can be processed to form output images 320.

For example, machine learning model 303, such as generative artificial intelligence model 304, can be configured to create output images 320 from images 223 output by the machine learning model system 220.

For example, images 223 can take the form of masks. A mask is a type of image in which the pixels are binary, such as either 0 or 1 in which areas with anomalies are white and areas without anomalies are black. In another example, the mask can be value from 0 to 10. In still another example, the mask can have values from 0 to 256 that represent pixel colors. In yet other examples, areas with anomalies can be black while areas without anomalies can be white. This type of image is also referred to as a segmentation mask. In these examples, the masks output by machine learning model system 220 are also referred to as output masks.

With this example, generative artificial intelligence model 304 is configured to create the output image from the output mask output by the machine learning model system 220. Output image 235 can be, for example, a color image.

In one illustrative example, output image 235 can be in the form of heat map 240. For example, heat map 240 can indicate the size of the anomaly for different probabilities. For example, a machine learning model in machine learning models 221 can determine the anomaly size for different probabilities for the future time frame. These probabilities for the area are shown in output image 235 in the form of heat map 240. Heat map 240 can be multiple areas of different sizes for an anomaly in a future time frame. These areas can be identified by colors in which each color for an area in heat map 240 indicates the probability that the anomaly will have that area. In heat map 240, each probability can have a different color and cover a different area in output image 235.

Additionally, output image 235 can also include graphical indicator 263 as a parameter in the number of parameters 222. In this example, graphical indicator 263 is used as a parameter to indicate whether a particular area in output image 235 contains at least one of surface anomaly 261 or subsurface anomaly 262.

For example, a first color indicates surface anomaly 261; a second color indicates subsurface anomaly 262; and a third color indicates both the presence of surface anomaly 261 and subsurface anomaly 262. Additionally, color can also be used to indicate the type of anomaly.

In another illustrative example, the graphical indicator 263 can be a flashing color. For example, the first color without flashing is surface anomaly 261 and the first color with flashing is subsurface anomaly 262. These and other graphical indicators can be used to distinguish between surface anomalies and subsurface anomalies in output image 235. In yet another illustrative example, graphical indicator 263 can be a combination of color and a crosshatching or dot pitch that is selected to indicate whether surface anomaly 261, subsurface anomaly 262, or both are present.

In still another illustrative example, graphical indicator 263 can be a color with different brightness to distinguish between at least one of surface anomaly 261 or subsurface anomaly 262. As yet another example, a color combined with a line type or style outlining an area can indicate the presence of at least one of surface anomaly 261 or subsurface anomaly 262. Thus, different visible cues in graphical indicator 263 can be used to identify at least one of surface anomaly 261 or subsurface anomaly 262 in output image 235.

In some examples, the number of parameters can be information associated with output image such as metadata. For example, the number of parameters can include a severity or whether the anomaly is present. This type of information for the number of parameters 222 can be made in addition to or in place of using graphical indicators.

Thus, anomaly predictor 214 can use machine learning model system 220 to generate predictions in the form of images 223 with number of parameters 222 predicted for anomalies 205, at future time frames 227, using inputs comprising input images of platforms 201 and future time frames 227.

In yet another illustrative example, machine learning model system 220 generates output image 235 using platform data 305 as an input in inputs 350. Platform data 305 is data for platform 231 from reference time frame 292 to future time frame 237. In other words, expected platform data 311 is any platform data that is predicted to occur after reference time frame 292 to future time frame 237. Depending on the selection of reference time frame 292, platform data 305 includes expected platform data 311 and can also include historical platform data 351.

For example, if future time frame 237 is 250 flight hours, platform data 305 can be the platform data from reference time frame 292 to future time frame 237 which is 250 flight hours. This platform data includes expected platform data 311 and can include historical platform data 351, depending on reference time frame 292. If platform data 305 includes weather conditions during the time from reference time frame 292 to future time frame 237, which when the aircraft is expected to have flown 250 flight hours. With this example, expected platform data 311 comprising the expected weather conditions from the current time to future time frame 237 are used. If reference time frame 292 is prior to the current time, then platform data 305 also includes historical platform data 351 for actual weather conditions from the current time back to reference time frame 292 to the current time.

As another example, platform data 305 can be altitudes that aircraft is expected to fly from reference time frame 292 to future time frame 237. If reference time frame 292 is from the current time, then expected platform data 311 for expected altitudes is used. If the reference time frame 292 is prior to the current time, then historical altitude data and historical platform data 351 for the aircraft is used from reference time frame 292 to the current time.

The amount of data present in platform data 305 can vary. For example, with expected platform data 311, weather conditions may only be predicted for a portion of the 250 flight hours while the altitudes can be predicted for all of the 250 hours.

With using platform data, anomaly predictor 214 identifies input image 230 of location 291 on platform 231 at reference time frame 292, future time frame 237 after reference time frame 292, and platform data 305 from reference time frame 292 to future time frame 237. In this example, anomaly predictor 214 generates output image 235 of location 291 with the number of parameters 222 for subsurface anomaly 262 on platform 231 using input image 230, future time frame 237, platform data 305, and anomaly analysis system 215 in response to identifying input image 230 of location 291 on platform 231 at reference time frame 292, future time frame 237 after reference time frame 292, and platform data 305 from reference time frame 292 to future time frame 237. Thus, different conditions relating to the operation of the platform can be taken into account using platform data 305 when predicting anomalies.

In this illustrative example, subsurface anomaly 262 can be absent at future time frame 237. This absence of subsurface anomaly 262 can be indicated through the number of parameters 222. For example, the number of parameters 222 can include a size for subsurface anomaly 262 anomaly 203. If the size is zero, then anomaly 203 is absent.

Anomaly predictor 214 then performs a number of actions based on output image 235 of subsurface anomaly 262.

In yet another example, Anomaly predictor 214 can predict anomalies 205 on platform 231 using this machine learning model system. For example, anomaly predictor 214 identifies an input image 230 of image location 257 on platform 231 at reference time frame 292, future time frame 237 after reference time frame 292, and platform data 305 from reference time frame 292 to future time frame 237. Anomaly predictor 214 generates output image 235 of anomaly location 258 with the number of parameters 222 for surface anomaly 261 on platform 231 using input image 230 at image location 257, future time frame 237, platform data, and anomaly analysis system 215 in response to identifying input image 230 at image location 257 on platform 231 at reference time frame 292, future time frame 237 after reference time frame 292, and platform data 305 from reference time frame 292 to future time frame 237. Anomaly predictor 214 performs a number of actions 238 based on output image 235 of surface anomaly 261.

The different components and inputs used by the anomaly analysis system are provided as an example and are not meant to limit the manner in which other illustrative examples can be implemented. For example, other types of inputs can also be used in inputs 350. For example, inputs 350 can also include at least one of an anomaly type, an anomaly size at a time of the image, an anomaly location, or other suitable inputs.

For example, in some cases, it may be desirable to predict whether subsurface anomaly 262 is present at location 291 on platform 231 at current time frame 352 rather than at future time frame 237. In other words, it may be desirable to predict whether subsurface anomaly 262 is present today rather than at some point in the future. With this example, reference time frame 292 is not at the same time as when input image 230 is generated. For example, input image 230 generated at current time frame 293. In other words, current time frame 293 is the time at which input image 230 is captured by sensor system 233. For example, current time frame 293 can be today while reference time frame 292 is a discrete point in past time prior to the current time frame.

With this example, machine learning model system 220 is configured to output output images 320 with a number of parameters 222 predicted for subsurface anomalies at locations on platforms 201 for current time frame 352 using inputs 350 comprising input images 371 of platforms 201 and historical platform data 351 for platforms 201. With this example, historical platform data 351 is platform data 305 that has been recorded or measured for a platform.

For example, anomaly predictor 214 generates inputs 350 for use in determining whether subsurface anomaly 262 is present at current time frame 352 for platform 231. Anomaly predictor 214 identifies input image 230 of location 291 on platform 231 at current time frame 352, reference time frame 292 before current time frame 352, and historical platform data 351 from reference time frame 292 before current time frame 352.

In this case, input image 230 is captured at the time at which a prediction of whether subsurface anomaly is present is desired, which is current time frame 352 in this example.

With this information in inputs 350, machine learning model system 220 in anomaly analysis system 215 generates output image 235 of location 291 with the number of parameters 222 for subsurface anomaly 262 on platform 231 using input image 230, reference time frame 292 before current time frame 352, historical platform data 351 in response to identifying input image 230 of location 291 on platforms 201 at current time frame 352, reference time frame 292 before current time frame 352, and historical platform data 351 from reference time frame 292 to current time frame 352.

The presence of subsurface anomaly 262 is indicated using a number of parameters 222. For example, a parameter can be used to indicate whether subsurface anomaly 262 is present. In another example, the presence or absence of subsurface anomaly 262 can be indicated using an existing parameter such as size. If subsurface anomaly 262 is absent, the size can be identified with the value of zero.

In another example, predicting whether subsurface anomaly 262 is present at a current point in time can be made using input image 230 that is captured at the current point in time such as today; setting reference time frame 292 to a prior time such as a year ago; and setting the future time frame 237 to the time the image was generated. Further to this example, platform data 305 can be the historical platform data 351 detected from reference time frame 292 and future time frame 237, which is the time input image 230 was captured.

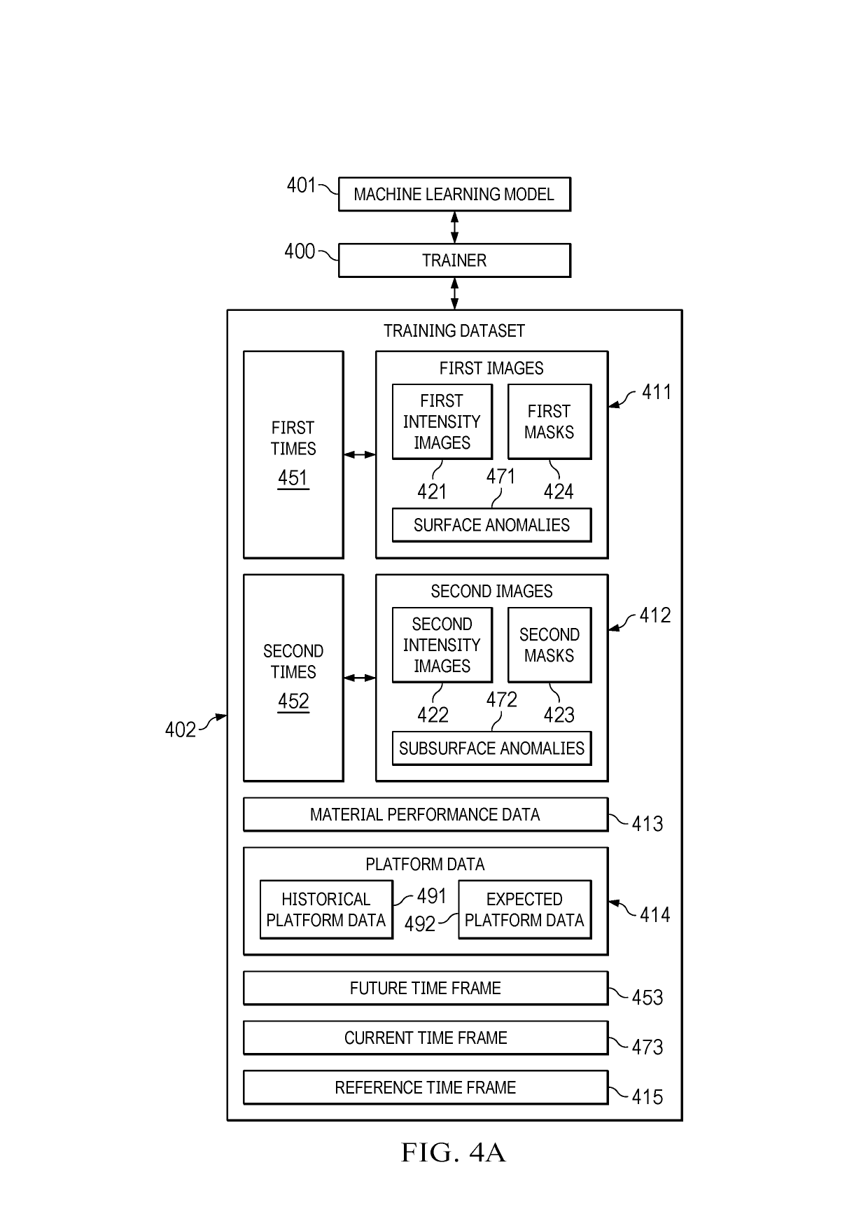

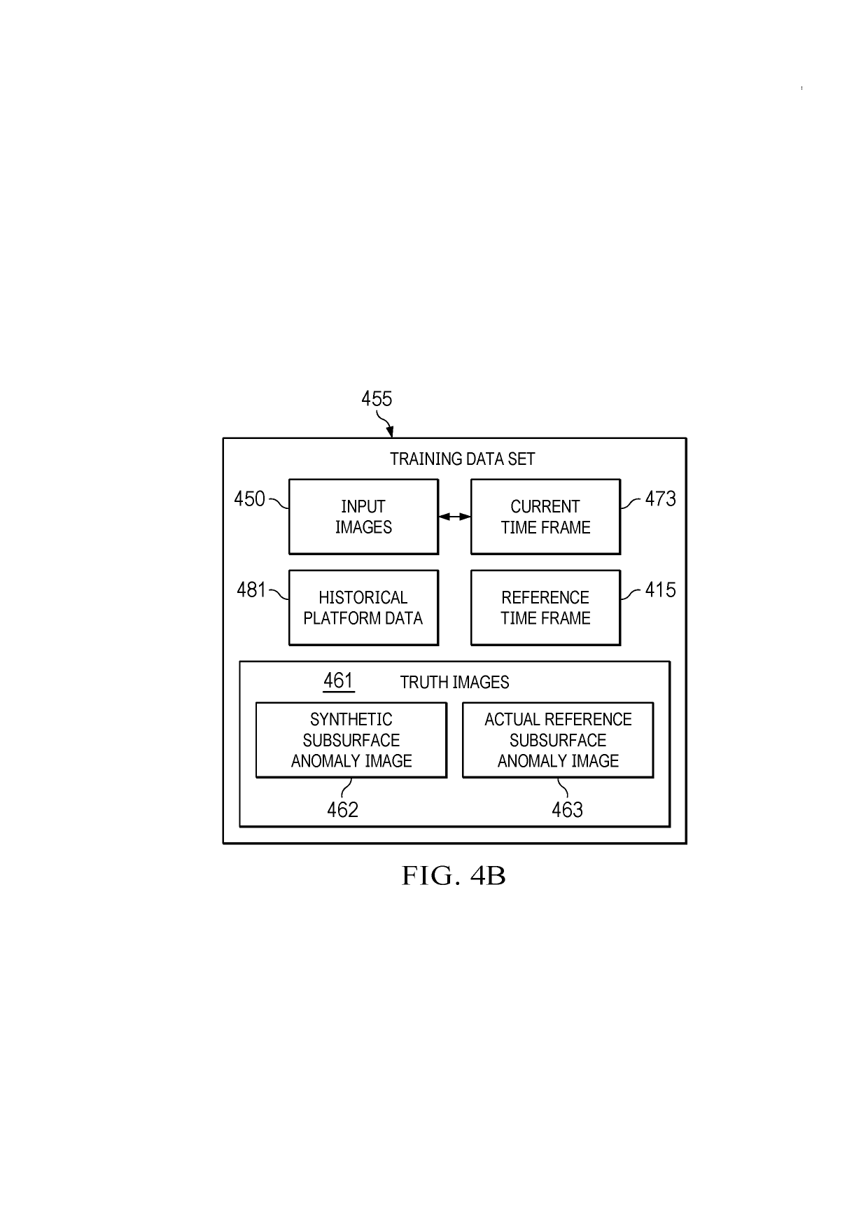

Turning next to FIGS. 4A-4B, an illustration of a training system to train a machine learning model to output images with parameters predicted for anomalies at locations on platforms for future time frames is depicted in accordance with an illustrative embodiment. In this illustrative example, trainer 400 operates to train a machine learning model 401 in FIG. 4A. Trainer 400 can be software that runs any computer system such as computer system 212 in FIG. 2. Machine learning model 401 is an example of a machine learning model in machine learning models 221 in machine learning model system 220 in FIG. 2.

Training machine learning model 401 is performed using training dataset 402. In this illustrative example, trainer 400 identifies first images 411 of locations at first times 451 on a test platform. These first images are the images input into machine learning model 401 during training. Trainer 400 identifies second images 412 of the locations at second times 452 on the test platform. The second images are the images used for comparison to images output by machine learning model 401 to determine the difference or error between the images.

In the illustrative example, when first images 411 are of surface anomalies and second images 412 are of subsurface anomalies, first images 411 can be in a first imaging modality while second images 412 can be any other second imaging modality. For example, first images 411 can be visible light images. Second images 412 can be ultrasound images. In yet other illustrative examples, second images 412 can be in multiple modalities such as ultrasound images, x-ray images, and thermal images. Thus, machine learning model 401 can be trained to predict subsurface anomalies from surface anomalies using images of different modalities.

In this example, second times 452 are later time frames than first times 451. For example, a first image is present in first images 411 for a location at a first time frame in first times 451. A second image is present in second images 412 for the same location at a second time frame in second times 452. With this example, a first image corresponds to the second image because these images are images of the same location. The first time frame is an earlier time frame than the second time frame for these corresponding images.

In this example, first times 451 and second times 452 can also be included in training dataset 402. These times can be labels for first images 411 and second images 412.

Further, anomalies may not be present in first images 411 of the location but develop and appear in second images 412. In this example, trainer 400 forms training dataset 402 using first images 411 and second images 412.

In this illustrative example, first images 411 and second images 412 can take a number of different forms. For example, first images 411 can be first intensity images 421 which can be color images or grayscale images. Second images 412 can be second intensity images 422 or second masks 423. Second images 412 can be at least one of second intensity images 422 or second masks 423 with anomalies corresponding to those in first intensity images 421. In other words, both an intensity image and a mask can be present at the same time in second images 412.

Further, when second masks 423 are present in second images 412 with second intensity images 422, first masks 424 can also be present with first intensity images 421 in first images 411. With this example, first masks 424 have anomalies that correspond to any anomalies present in first intensity images 421. In some examples, an anomaly may not be present in these input images.

When training machine learning model 401 to predict subsurface anomalies based on inputs of surface anomalies, first images 411 are images of surface anomalies 471. Further, second images 412 are images of subsurface anomalies 472. In this example, first times 451 and second times 452 can be the same. In other words, first images 411 of surface anomalies 471 can be at reference time frame 415 and second images 412 are at the same reference time frame. Thus, machine learning model 401 can be trained to predict the presence of a subsurface anomaly based on an input image of surface anomaly at the same location. In other examples, the prediction can be for some future time frame such as second times 452 or any future time from first times 451.

In this example, the selection of a first image of surface anomaly and a second image of subsurface anomaly can be made based on a correlation between the presence of the surface anomaly and the subsurface anomaly. Thus, images can be paired to enable machine learning model 401 to learn patterns of subsurface anomalies 472 occurring when corresponding surface anomalies in surface anomalies 471 are present. Thus, training dataset 402 can be used to train machine learning model 401 to predict the presence of subsurface anomalies 472 from surface anomalies 471.

In the illustrative example, training dataset 402 can be data in addition to the images. For example, training dataset 402 can also include at least one of material performance data 413 or platform data 414. This data can also be selected for first times 451 and second times 452.

In this example, platform data 414 in training dataset 402 is data about a platform such as an aircraft, a building, a car, or other platforms. Platform data 414 includes expected platform data 492. Platform data 414 can include historical platform data 491 depending on reference time frame 415 selected. For example, if reference time frame 415 is one month in the past and the future time frame 453 is two months in the future, then platform data 414 includes historical platform data 491 from one month in the past to the current time and expected platform data 492 from the current time to two months in the future.

Environmental information can include at least one of temperature ranges, pressure conditions, humidity levels, wind conditions, altitude parameters, terrain features, weather patterns, and geographical locations for the location or locations where the platform operated or is expected to operate.

Operational information can include predictions or projections for at least one of operational patterns, altitudes, deployment scenarios, or other utilization that has occurred for the platform or is expected to occur for the platform. For example, operational data can be hours of operation, flight hours, workload levels, environmental conditions present during platform use, usage conditions that define how the platform is engaged during a defined period, and geographic locations associated with platform deployment. For a platform in the form of an aircraft, operational information can be hours of operation, flight hours, workload levels, usage conditions that define how the platform is engaged during a defined period, and geographic locations associated with platform deployment.

Thus, the environmental and operational information can be historical information or predicted or anticipated information. The type of information used, historical or expected, depends on reference time frame 415 and future time frame 453.

Platform data 414 can also include platform information that specifies hardware configurations, software configurations and other information about how a platform is set up or configured. In this example, structural data can be present that defines physical components or assemblies and maintenance data identifies completed maintenance for deferred maintenance.

For example, the platform information for an aircraft is referred to as aircraft information and can include specifications, configurations, and operational parameters of the aircraft. The aircraft information represents actual characteristics of the aircraft.

For example, the aircraft information can include airframe specifications, propulsion system parameters, avionics configurations, component specifications, and performance characteristics that define the aircraft as manufactured or configured.

In one illustrative example, platform data 414 can include data associated with additional platforms belonging to a defined platform category. A platform category can be defined by explicit operational characteristics, structural characteristics, or configuration characteristics. For example, an aircraft category can include a fixed-wing sub-category defined by a consistent set of structural characteristics or configuration characteristics associated with fixed-wing platforms. Further granularity can be introduced within the fixed-wing sub-category by defining variants and sub-variants. A variant is a grouping of fixed-wing platforms that share distinct structural characteristics or configuration characteristics, such as a shared airframe family. A sub-variant is a further division of a variant that reflects additional differences in design features, mission configurations, or operational capabilities. Platform heuristics can also be included to describe behavioral patterns associated with each platform category, platform sub-category, variant, or sub-variant.

This platform data in training dataset 402 is used to train machine learning model 401 to make predictions of anomalies using platform data 305 as an input. Platform data 414 can be correlated to anomalies in different images to train machine learning model 401 to predict the occurrence of anomalies based on what platform data is expected from a reference time frame to a future time frame using the images and platform data 414 from first times 451 and second times 452 in training machine learning model 401.

This additional data can be used for training with the images in training dataset 402 in a number of different ways. For example, labels can be used with the images and the additional data to correlate this information with each other for training machine learning model 401. In other examples, the images and the additional input data can be associated with each other by inputting this information at the same time into machine learning model 401. For example, a first image at time x, material performance data 413 at time X, and platform data 414 at time X can be input into machine learning model 401 at the same time. This machine learning model can concatenate this data together for processing to generate an output image that is compared to the second image at time X.

In this example, trainer 400 trains machine learning model 401 using training dataset 402. The training can be deep learning in which machine learning model 401 is trained to predict a mask which mimics the anomaly in some future state at a future time frame. This type of learning enables training using the outputs of machine learning model 401, providing a "natural" means of answering the question. For example, the questions can be: what is the probability the defect will grow/change in N days?

In yet another illustrative example, machine learning model 401 can be trained to predict a mask which mimics the anomaly in some future state at future time frame 453 from a reference time frame 415 based on platform data 414 that is anticipated forward from the reference time frame 415 to future time frame 453. In other words, platform data 414 can also include platform data 414 anticipated during the time from reference time frame 415 through the future time frame 453. This anticipated platform data is expected platform data 492.

In another example, machine learning model 401 in the form of a generative artificial intelligence model can be trained to answer questions such as what will the corrosion look like in two years? In response, this model can provide an image that is a visual representation of the future state of the corrosion. This image can then be analyzed for a number of parameters for the corrosion. These and other types of training techniques and machine learning models can be used to predict the future status of anomalies at future time frames.

In still another example, the future time frames can be flight hours. With this type of training, training dataset 402 comprises input images at a time frame of time X, output masks at time Y, and flight hours between corresponding pairs of input images and ground truth from time X to time Y. In this example, time X is a reference time frame and time Y is a future time frame for some number of flight hours between the reference time frame and the future time frame.

With this example, an input image at time X is input into a vision embedding layer in the machine learning model 401. Flight hours for this input image are normalized between 0 and 1. The normalized flight hours are concatenated with an output of image embedding layers. The concatenated vector is passed through the remaining portion of the model to receive an output mask for time Y. The output mask is compared to the corresponding ground truth mask for time Y. A loss is determined and machine learning model 401 is updated to reduce loss. This process is repeated using the different input images and ground truth mask pairs.

In another example in FIG. 4B, training dataset 455 is another example of training data used by trainer 400 to train machine learning model 401 to predict the presence of subsurface anomalies at a point in time in which the input image captured at that same point in time.

With this example, training dataset 455 comprises input images 450, historical platform data 491, reference time frame 415, current time frame 473, and truth images 461.

With this example, reference time frame 415 is a point in time before current time frame 473. Current time frame 473 is a point in time in which a prediction is to be made as to whether an anomaly such as a subsurface anomaly is present. With this example, a surface anomaly may not be present in the prediction.

Historical platform data 491 is platform data 414 actually recorded for the platform from reference time frame 415 to current time frame 473. Input images 450 are images captured at current time frame 473. In this example, current time frame 473 can be future time frame 453 in the prior example.

Truth images 461 are images of the subsurface anomaly that is present at current time frame 473 but not seen in the input image. These images are ones that machine learning model 401 is being trained to generate using training dataset 455. Truth images 461 can be at least one of synthetic subsurface anomaly image 462 or actual reference subsurface anomaly image 463.

In this example, synthetic subsurface anomaly image 462 can be an image generated based on parameters measured for the subsurface anomaly. For example, synthetic subsurface anomaly image 462 can be generated from historical platform data 491 that provides patterns of the platform data that results in subsurface anomalies. Actual reference subsurface anomaly image 463 can be an actual image of the subsurface anomaly that can be generated from removing materials to expose the subsurface anomaly or using nondestructive inspection (NDI) techniques to create an image of the subsurface anomaly.

When trained using training dataset 455, machine learning model 401 is now configured to output images with a number of parameters predicted for subsurface anomalies at locations on platforms for a current time frame using inputs comprising input images of the platforms and historical platform data for the platforms.

Thus, anomaly predictor 214 can identify an input image of a location on a platform at a current time frame, a reference time frame before the current time frame, and the historical platform data from the reference time frame before the current time frame. Anomaly predictor 214 can generate an output image of the location with the number of parameters for a subsurface anomaly on the platform using the input image, the reference time frame before the current time frame, the historical platform data, and the anomaly analysis system in response to identifying the input image of the location on the platform at the current time frame, the reference time frame before the current time frame, and the historical platform data from the reference time frame to the current time frame.

As a result, an input image can be captured at the time of interest, which is current time frame 473. This input image can be used as an input with historical platform data 491 from reference time frame 415 to current time frame 473 to predict whether an anomaly is present at current time frame 473. In this example, the anomaly is a subsurface anomaly. However, the prediction can also be made for a surface anomaly that may not be easily visible to a human operator from a visual inspection. In this manner, historical data can be used to predict current anomalies such as subsurface anomalies.

The illustration of training machine learning model 401 in FIGS. 4A and 4B is provided as an example and is not meant to limit the manner in which training is implemented in other illustrative examples. For example, rather than defining time frames by timestamps such as first times 451 and second times 452, future time frame 453 can be used in training dataset 402 and can be a time period that indicates the future time frame from first image in first images 411 to the second image in second images 412.

Further, illustration of training dataset 402 and training dataset 455 are provided as examples. Depending on the type of predictions generated, these training datasets can change to include the types of data needed to train machine learning model 401 to make the desired predictions. Further, the training by trainer 400 can be supervised or unsupervised in which labels are added for supervised training to identify the correct or desired outputs.

Further, the machine learning models, such as machine learning model 401 in FIG. 4A can be trained to predict anomalies for both current and future time based on the training datasets employed. For example, machine learning model 401 can be trained to predict anomalies at a future time frame. With this example, the training datasets can include input images selected from at least one of an image with no anomalies, an image with a surface anomaly, an image with the subsurface anomaly, and an image with anomalies selected from at least one of a subsurface or surface anomaly. Another input for predicting anomalies at a future time includes the future time frame. These inputs are input with a number of other inputs. These additional inputs can be platform data, a sensor input, and material performance data.

Platform data comprises expected platform data. The platform data can also include historical platform data based on the date of the future timeframe.

Sensor data can include images generated by sensors that generate images using infrared light, millimeter waves, ultrasonic energy, structural wire, or other types of electromagnetic energy. The second image can be used with the input image as part of the training and input into the machine learning model.

In this example, the material performance data can be historical data from prior tests located in a database or table. Material performance data can also be obtained from a material behavior model such as a model from material behavioral models 302 in FIG. 3.

The outputs from machine learning model 401 take the form of images in these illustrative examples. These images can be, for example, a heat map, a probability map, a mask, and an image with visualizations and parameters.

A heat map can show information including at least one of a size, a location, a severity, or a type of anomaly. The probability map can include a likelihood of parameters such as size, location, severity, and type. A mask can be for anomalies that a generative artificial intelligence system converts to an image for visualizing the anomaly. The parameters can provide information such as appearance, severity, type, size, and location.

In another illustrative example, machine learning model 401 can be trained to predict anomalies at a current time frame. With this example, the training dataset can include input images selected from at least one of an image with no anomalies, an image with a surface anomaly, an image with a subsurface anomaly, and an image with anomalies selected from at least one of a subsurface or surface anomaly.

Other inputs for predicting anomalies at a current time frame can include one or more of historical platform data, sensor input, and material performance data. The potential outputs for machine learning model 401 are the same as those for predicting anomalies in the future time frames.

Thus, in the illustrative example, the training dataset composition takes forms depending on the inputs and outputs desired for machine learning model 401.

In this manner, machine learning model 401 can be trained to output images and a number of parameters for a number of anomalies. The anomalies predicted by the machine learning model can be for at least one of a surface anomaly or a subsurface anomaly.

Thus, machine learning model system 220 can generate output images that enable growth prediction to predict the change in size of the same anomaly at a future point in time. Additionally, these output images can also be for anomaly change prediction to predict the change in the type of anomaly at a future point in time. For example, an anomaly may initially be a type that is referred to as exposed primer and this type can change from exposed primer to another type that is referred to as bare metal at a future point in time.

Also, prediction of subsurface anomalies is enabled using machine learning model system 220 to predict the actual extent of the subsurface anomaly at the time that the input image was captured. In one example, the time that the input image was captured is the reference time frame. This prediction can also extend to predicting changes in the subsurface anomaly at a future time frame. These changes can be a growth or a reduction in the size of the subsurface anomaly.

In one illustrative example, one or more technical solutions are present that overcome a technical problem with anomalies that may occur on platforms at future time frames. As a result, one or more technical solutions may provide a technical effect enabling the prediction of anomalies on a platform at a future time frame using images from a prior time frame. An input image of the platforms is identified and an output image is generated using the input image and anomaly analysis system. This anomaly analysis system includes a machine learning model system that predicts one or more parameters for anomalies at locations on platforms using the input images and future time frames. This anomaly analysis system generates output images with the parameters for the anomalies.

Computer system 212 can be configured to perform at least one of the steps, operations, or actions described in the different illustrative examples using software, hardware, firmware or a combination thereof. As a result, computer system 212 operates as a special purpose computer system in which anomaly predictor 214 in computer system 212 enables computer system 212 to be able to predict parameters for anomalies on a platform at a future time frame using an image from an earlier time frame. In particular, anomaly predictor 214 transforms computer system 212 into a special purpose computer system as compared to currently available general computer systems that do not have anomaly predictor 214.

In the illustrative example, the use of anomaly predictor 214 in computer system 212 integrates processes into a practical application performing maintenance at locations on platforms such as aircraft. The maintenance can be more accurately scheduled and performed using these predictions of parameters for anomalies and output images generated by computer system 212 and in particular, computer system 212 using anomaly predictor 214.

The illustration of anomaly prediction environment 200 and the different components in FIGS. 2-4B is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, anomalies can be identified by anomaly predictor 214 locating input image 230 in a database instead of receiving this image from sensor system 233. In another illustrative example, output image 235 generated by anomaly analysis system 215 can include one or more types of anomalies in addition to or in place of anomaly 203 in which these anomalies can be different types of anomalies.

Further, in some cases the anomalies may be of the same type, but the locations are far enough apart to be considered different anomalies of the same type. For example, an anomaly can be corrosion on a wing panel and another anomaly can be corrosion on a fuselage of an aircraft.

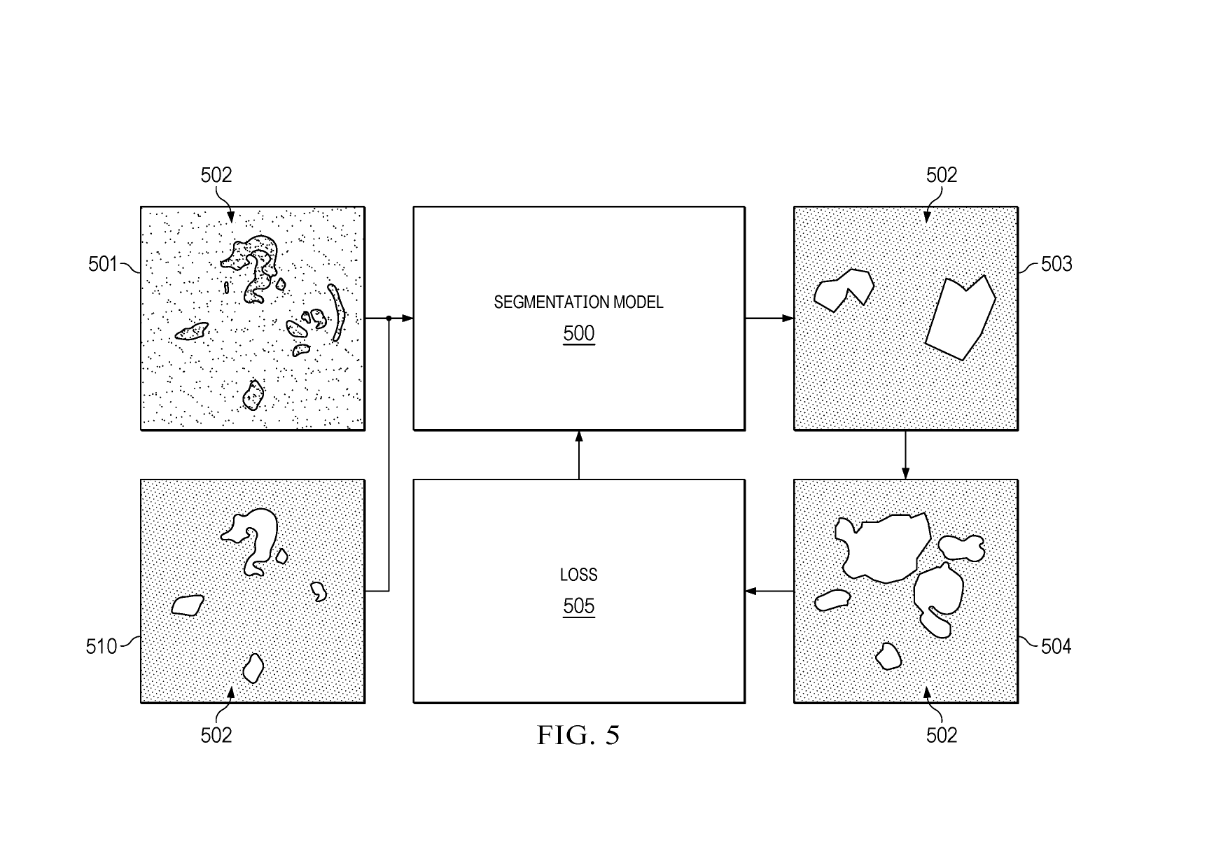

Turning next to FIG. 5, an illustration of a dataflow for training in a segmentation model is depicted in accordance with an illustrative embodiment. In this illustrative example, segmentation model 500 is trained using trainer 400 in FIG. 4. Different operations described in this dataflow are performed by trainer 400 in FIG. 4. Segmentation model 500 is an example of a machine learning model in machine learning models 221 in machine learning model system 220 in FIG. 3.

As depicted, input intensity image 501 contains anomaly 502. In these examples, an intensity image is a color image, a grayscale image, or some other type of image that has multiple intensities to represent an object. Intensity images are different from a mask which uses binary values in which one logic value is used to indicate an absence of an anomaly in the pixel and another logic value is used to indicate the presence of an anomaly in the pixel.

Additionally, input mask 510 can also be used as an input into segmentation model 500 for training. In this example, input mask 510 includes anomaly 502 in the same time frame as input intensity image 501.

In response to receiving input images such as input intensity image 501 and input mask 510, segmentation model 500 predicts changes in pixels that correspond to changes in parameters for anomaly 502 for a future time frame. As depicted, segmentation model 500 outputs an image in the form of output mask 503.

As depicted, output mask 503 is a mask that indicates a number of parameters predicted for anomaly 502 at a future time frame. This mask depicts a number of parameters predicted for anomaly 502 at a future time frame from input intensity image 501 and input mask 510. In other words, output mask 503 can provide a visualization of changes in one or more parameters of anomaly 502 at the future time frame. In this example, the number of parameters can be the area and shape for anomaly 502 at the future time frame.

Output mask 503 is compared to ground truth mask 504, which is a mask identifying the actual area and shape for anomaly 502. Output mask 503 is compared to ground truth mask 504 to determine the difference between these two images. Loss 505 is calculated using the difference between these two masks.

A number of different functions can be used to calculate loss 505. For example, loss 505 can be calculated using a loss function such as Mean Squared Error (MSE) and Cross-Entropy Loss.

Loss 505 is then used to update segmentation model 500. Different weights and other parameters can be adjusted in segmentation model 500 to reduce the difference between an output image and a ground truth image in future training iterations.

The illustration of the dataflow to train segmentation model 500 is an example of one manner in which a machine learning model can be trained to output images with a number of parameters predicted for anomalies on a platform. This illustration is not meant to limit the manner in which other illustrative examples can be implemented for training. For example, a future time frame may be input into segmentation model 500 as part of the training process. In yet other illustrative examples, other inputs such as material performance data and platform data can also be input. In yet other examples, another type of machine learning model such as a generative artificial intelligence model outputs an intensity image in place of output mask 503 and ground truth mask 504 can be a ground truth intensity image.

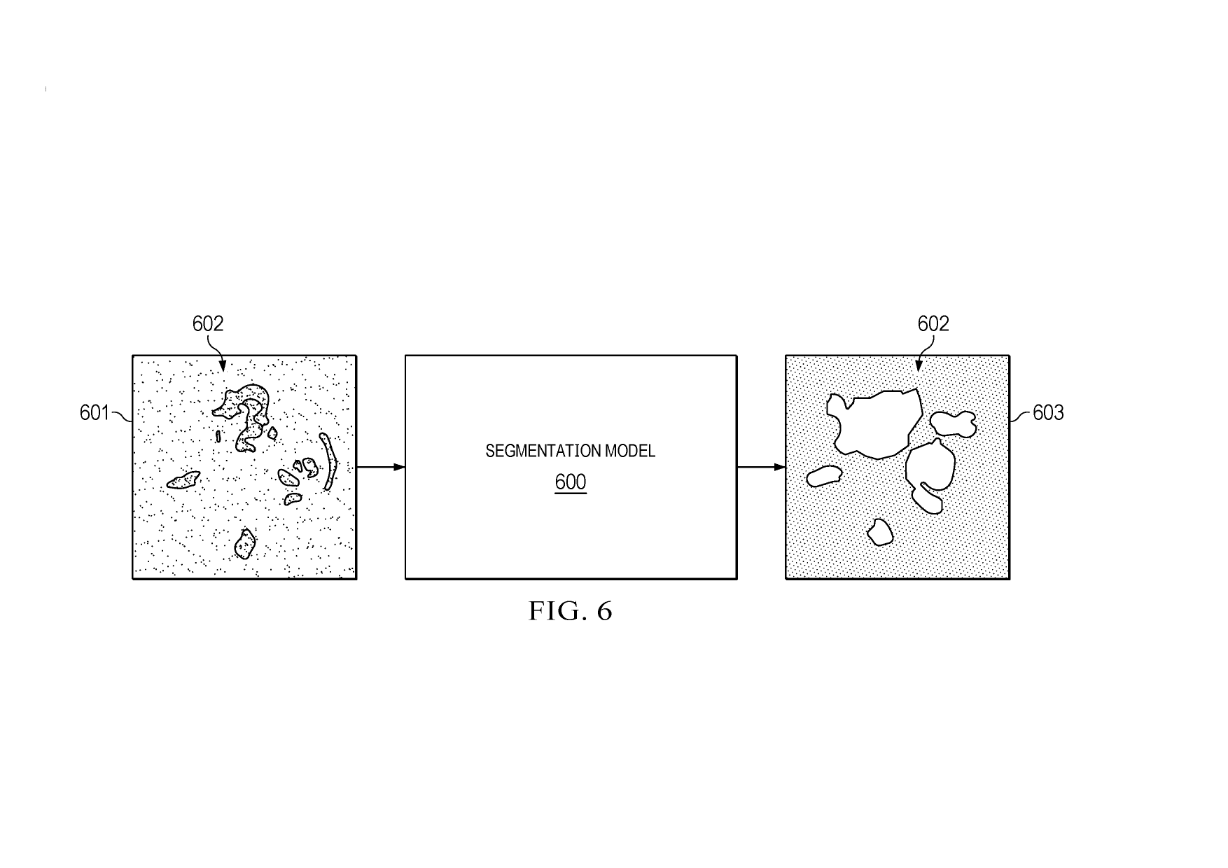

Turning to FIG. 6, an illustration of using a segmentation model to generate an output image with a number of parameters predicted for an anomaly is depicted in accordance with an illustrative embodiment. In this illustrative example, segmentation model 600 receives input image 601 at a first time frame. Segmentation model 600 is an example of a segmentation model trained by trainer 400 in FIG. 4.

In this example, input image 601 contains anomaly 602. Segmentation model 600 outputs output image 603 at a future time frame from the first time frame. This output image shows anomaly 602 with a number of parameters predicted for this anomaly at the future time frame.

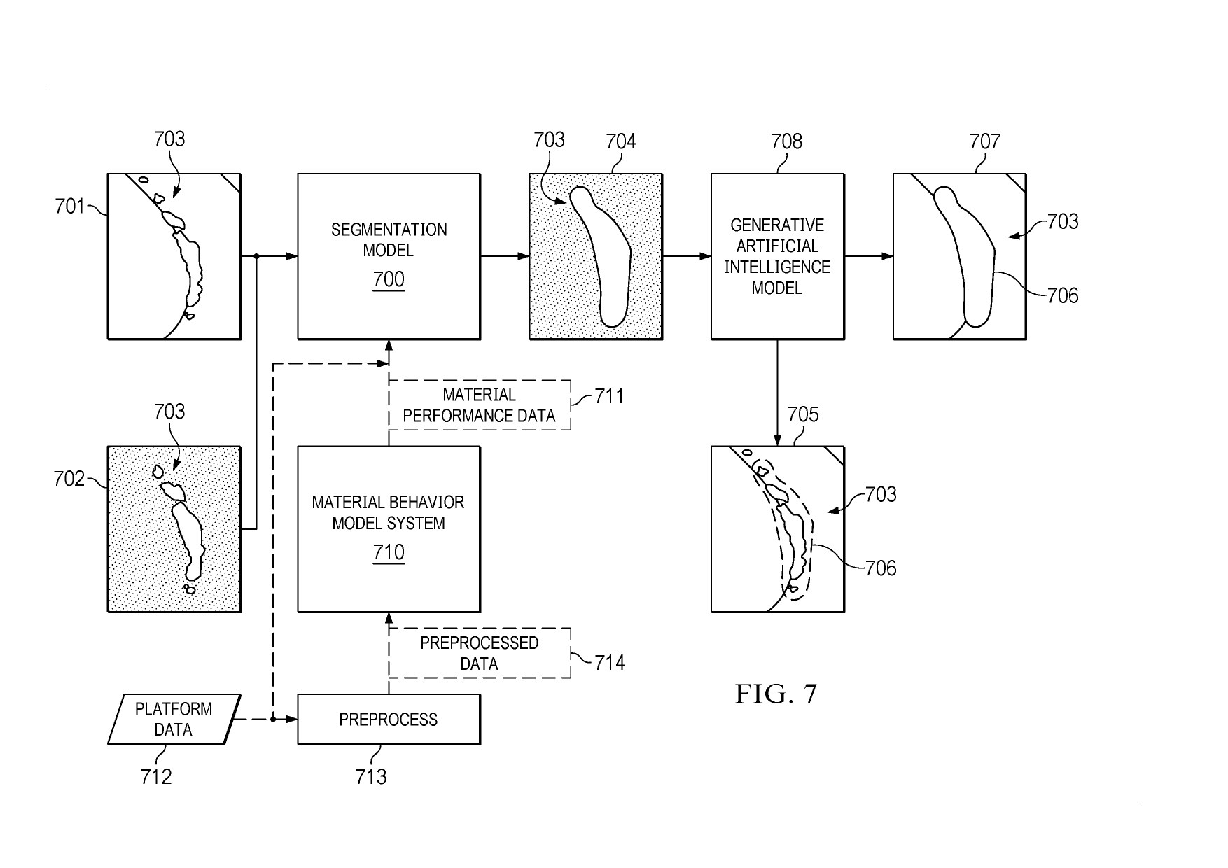

Next in FIG. 7, another illustration of using a segmentation model to generate an output image with a number of parameters predicted for an anomaly is depicted in accordance with an illustrative embodiment. Segmentation model 700 is an example of a segmentation model trained by trainer 400 in FIG. 4.

In this illustrative example, segmentation model 700 receives input intensity image 701 and input mask 702 at a first time frame. In this example, input intensity image 701 and input mask 702 contains anomaly 703. In response, segmentation model 700 outputs output mask 704 with anomaly 703 having changes in the number of parameters as compared to the number of parameters for anomaly 703 in input intensity image 701.

In one illustrative example, segmentation model 700 outputs output intensity image 705 instead of output mask 704, which is input intensity image 701 with outline 706. This outline has the same area as identified for anomaly 703 in output mask 704 and indicates the change in the number of parameters for anomaly 703. In another example, segmentation model 700 outputs output mask 704.

Postprocessing can be performed to identify the area and shape of the anomaly within output mask 704 for an overlay of that area on input intensity image 701 with anomaly 703 with the number of parameters before the change at the future time frame.

In yet another illustrative example, output intensity image 707 is generated using output mask 704. In this example, generative artificial intelligence model 708 has been trained to generate pixel data for pixels within output mask 704 to provide a visualization of anomaly 703 in place of white pixels in output mask 704. In other words, generative artificial intelligence model 708 produces a visualization in output intensity image 707 of what anomaly 703 looks like at a future time frame within the bounds of output mask 704.

In this illustrative example, other inputs can also be used in addition to input intensity image 701 and input mask 702. For example, material performance data 711 is an example of another input that can be sent into segmentation model 700 in generating output mask 704. In this example, material performance data 711 is generated by material behavior model system 710 using platform data 712.

Additionally, platform data 712 can be processed by preprocess 713 to form preprocessed data 714 that is sent into material behavior model system 710 to generate material performance data 711. In this example, processing performed by preprocess 713 can include at least one of cleaning, transforming, structuring, and performing other operations on platform data 712. This processing can be performed to provide platform data 712 used by material behavior model system 710. This preprocessing can include principal component (PCA) analysis, scaling, normalizing with distribution coefficients of data, and other types of preprocessing.

Further, segmentation model 700 can directly receive platform data 712 in addition to or in place of material performance data 711. The use of this additional data may help improve the prediction of changes in the number of parameters for anomalies.

In this illustrative example, input intensity image 701 can be used with one or more of output mask 704, output intensity image 705, and output intensity image 707 to generate various metrics. These metrics can be generated by an anomaly predictor such as anomaly predictor 214 in FIG. 2. For example, metrics such as percentage growth from the time frame of input intensity image 701 to the future time frame for output mask 704 can be used. Other metrics can include determining a change in size, severity, shape, location, or other information regarding the change in the number of parameters for the anomaly at the future time frame.

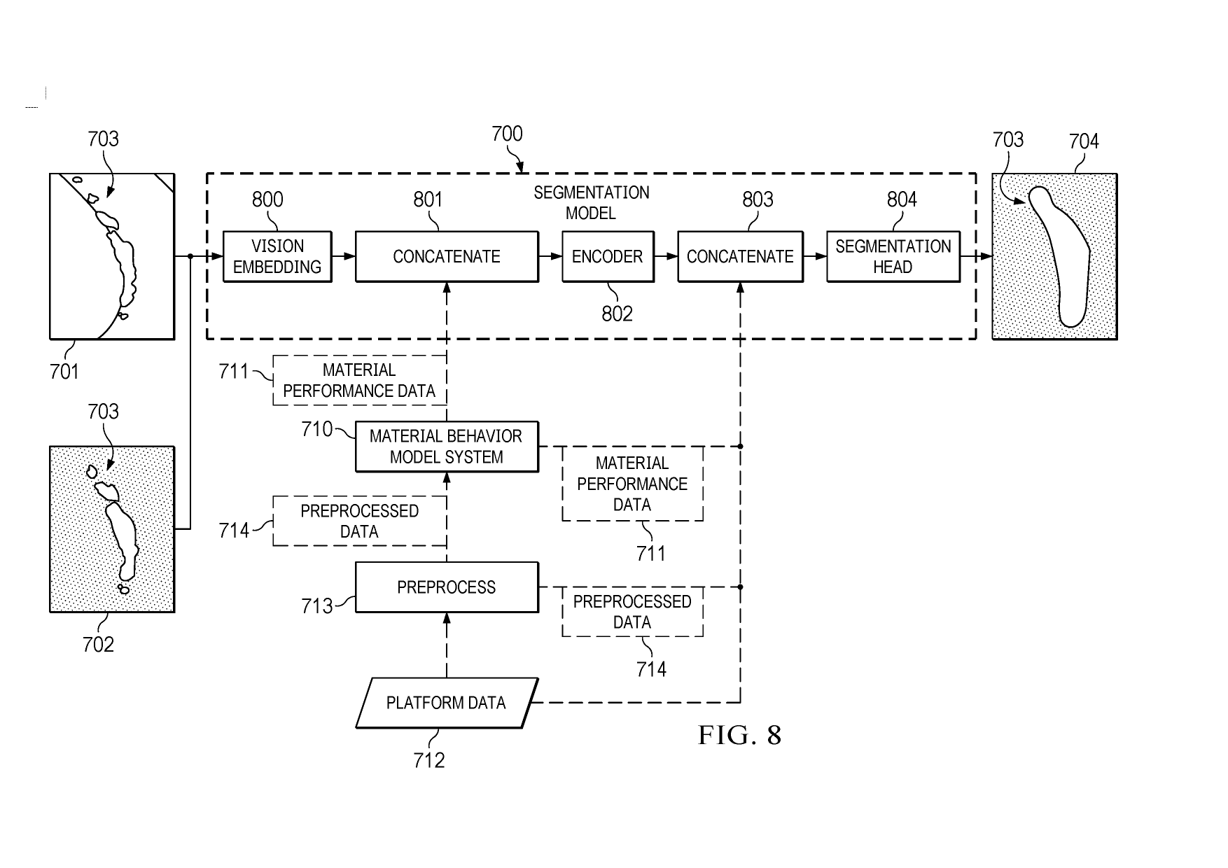

Turning next to FIG. 8, an illustration of passing data into a segmentation model is depicted in accordance with an illustrative embodiment. In this figure, components in segmentation model 700 that receive and process inputs are depicted.

As depicted, input intensity image 701 and input mask 702 are input into vision embedding 800. This component receives input images which are in shape [batch size, width, height, channel] and outputs data in shape [batch size, embedding dimension]. These shapes can be a matrix in which a row represents an encoded vector for one sample in the batch. The batch size can refer to the number of samples being processed simultaneously. Embedding dimension is the length of a vector containing the information for the sample.

The output of vision embedding 800 is sent to concatenate 801. Material performance data 711 is input into concatenate 801 in segmentation model 700. In this illustrative example, concatenate 801 operates to connect output of vision embedding 800 with material performance data 711. At the least two sets of data are combined into a single set of data for further processing. These two sets of data are combined into a single vector and sent to encoder 802.

In this illustrative example, encoder 802 component can be a number of layers such as neural network layers and can implement a transformer architecture. Encoder 802 processes the data and extracts information. For example, encoder 802 can identify patterns and relationships between the image data output by vision embedding and material performance data 711 in the vector combining the concatenation of the state received by encoder 802. This component can output data in a shape [batch size, encoding dimension].

This output from encoder 802 is sent to concatenate 803. Additionally, at least one of platform data 712, preprocessed data 714, or material performance data 711 can be input into segmentation model 700 through concatenate 803. Concatenate 803 combines this data with the output from encoder 802 to form a vector that is sent to segmentation head 804.

In this illustrative example, segmentation head 804 performs a final set of operations and outputs data in shape [batch size, number of classes, mask width, mask height] to form output mask 704. In this example, the number of classes are two classes: an anomalous class for anomaly 703 and a non-anomalous class.

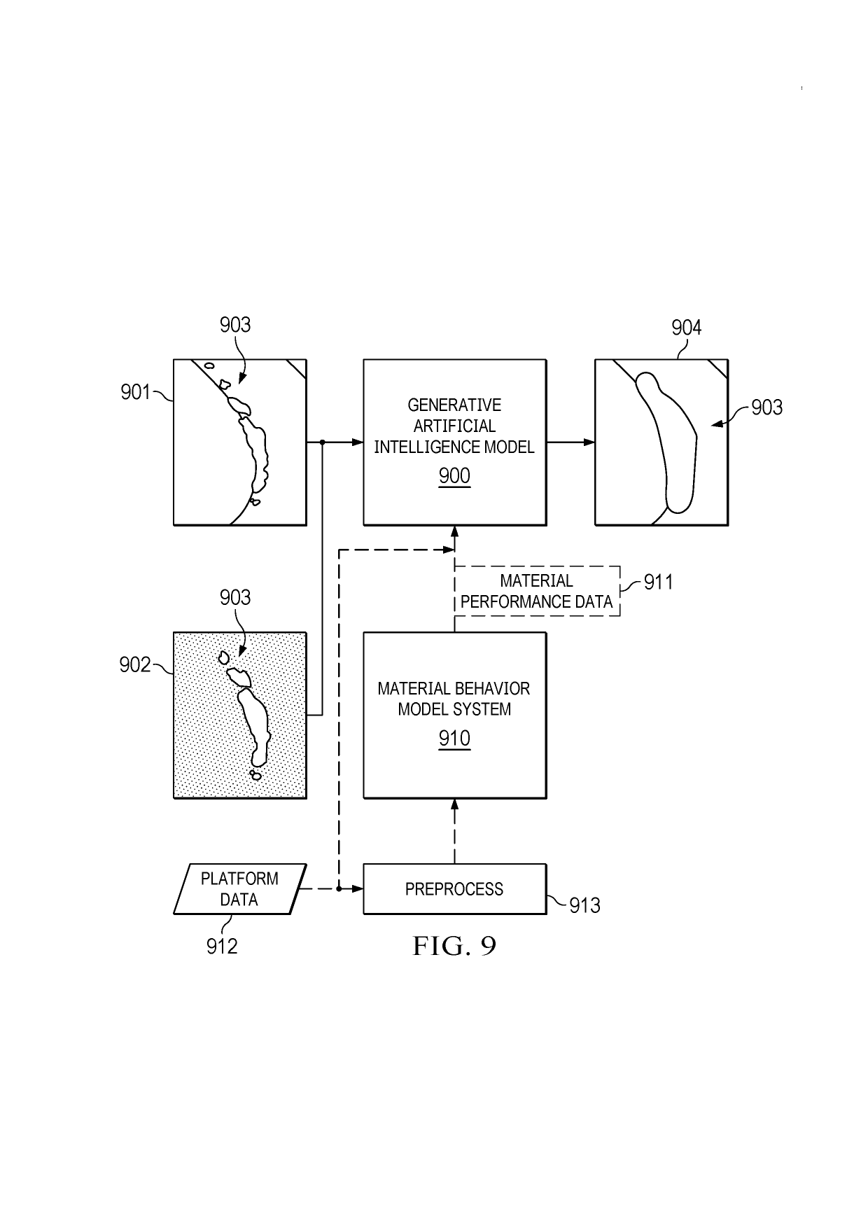

With reference to FIG. 9, an illustration of a generative artificial intelligence model used to generate an output image of a number of parameters predicted for an anomaly is depicted in accordance with an illustrative embodiment. Generative artificial intelligence model 900 is an example model that can be trained by trainer 400 in FIG. 4.

As depicted, input intensity image 901 and input mask 902 at a first time frame are input into generative artificial intelligence model 900. In this example, anomaly 903 is present in input intensity image 901 and input mask 902. In response to these inputs, generative artificial intelligence model 900 outputs output intensity image 904 with anomaly 903 having changes in the number of parameters as compared to the number of parameters for anomaly 903 in input intensity image 901.

Further, as with segmentation model 700 in FIG. 7, additional inputs can be input into generative artificial intelligence model 900 in addition to input intensity image 901 and input mask 902. Material performance data 911 generated by material behavior model system 910 using platform data 912 is an example of another input that can be used by generative artificial intelligence model 900 to generate output intensity image 904.

Additionally, platform data 912 can be processed by preprocess 913 prior to being sent into material behavior model system 910 to generate material performance data 911. Further, generative artificial intelligence model 900 can directly receive platform data 912 in addition to or in place of material performance data 911. The use of this additional data may help improve the prediction of changes in the number of parameters for anomalies.

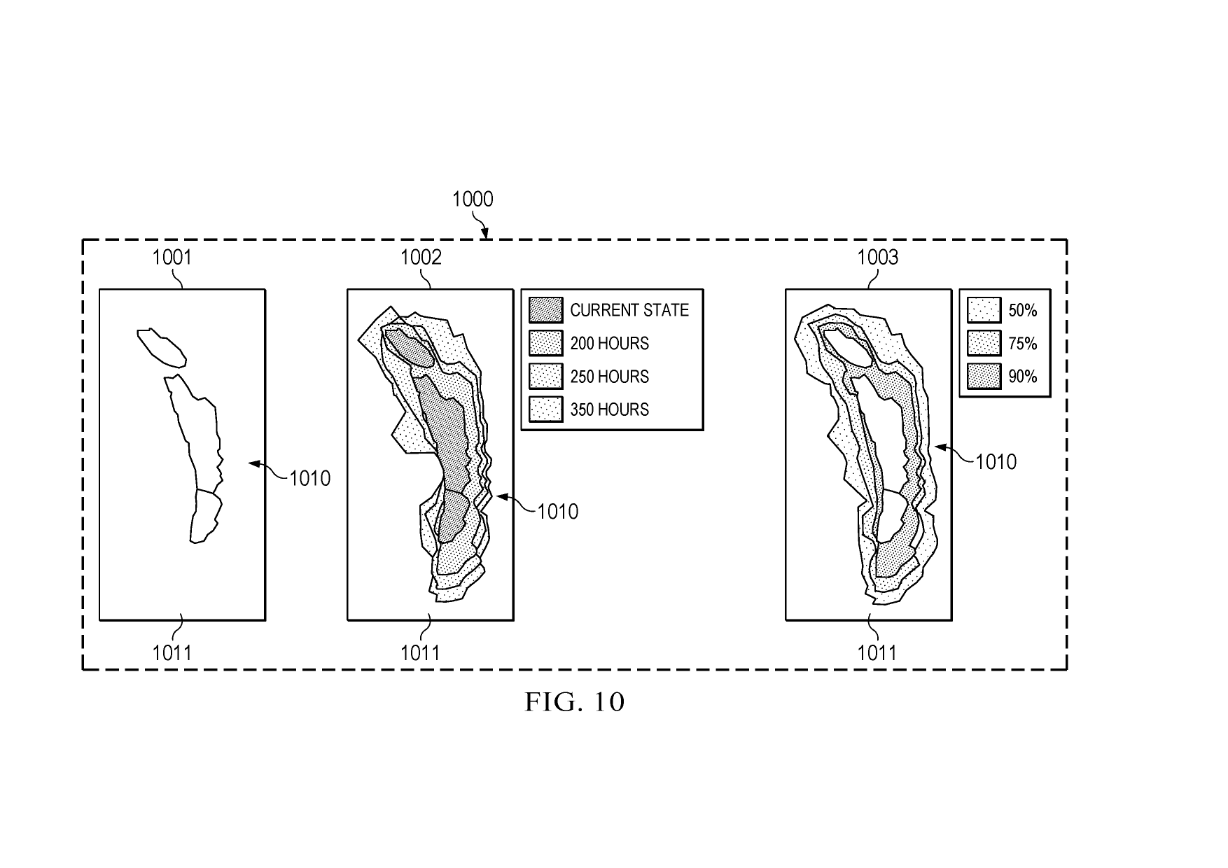

With reference to FIG. 10, an illustration of images for an anomaly is depicted in accordance with an illustrative embodiment. In this example, images 1000 are images for anomaly 1010. Image 1001 is an example of input image 230 in FIG. 2. Image 1002 and image 1003 are examples of output image 235 output by an anomaly analysis system, such as anomaly analysis system 215 in FIG. 2.

Image 1001 is an intensity image of anomaly 1010 on a platform 1011 at a reference time frame. This reference time frame is a time frame from which a prediction of parameters for anomaly 1010 at future time frames can be made. In this example, these parameters can be, for example, an area and shape.

In this illustrative example, image 1002 in images 1000 illustrates a change in anomaly 1010 at different future time frames from the reference time frame shown in image 1001. As depicted, image 1002 shows the change in anomaly 1010 predicted at 200 flight hours, 250 flight hours, and 350 flight hours. These flight hours are future time frames from reference time frame in image 1001.

Image 1003 in images 1000 illustrates the probability of anomaly 1010 having a collected change in size after 200 flight hours as a future time frame from the reference time frame. As depicted, area and shape of anomaly 1010 are shown for a probability of 90%, 75%, and 50%.

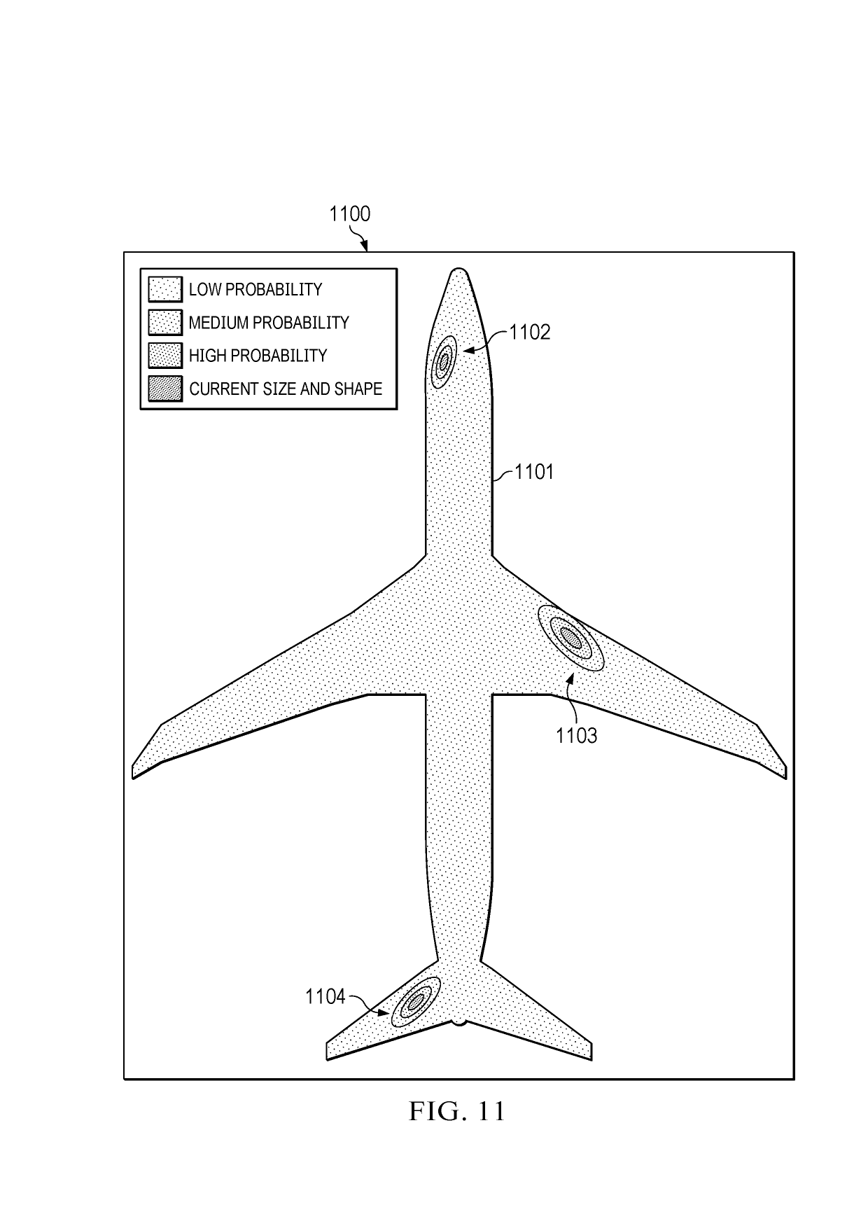

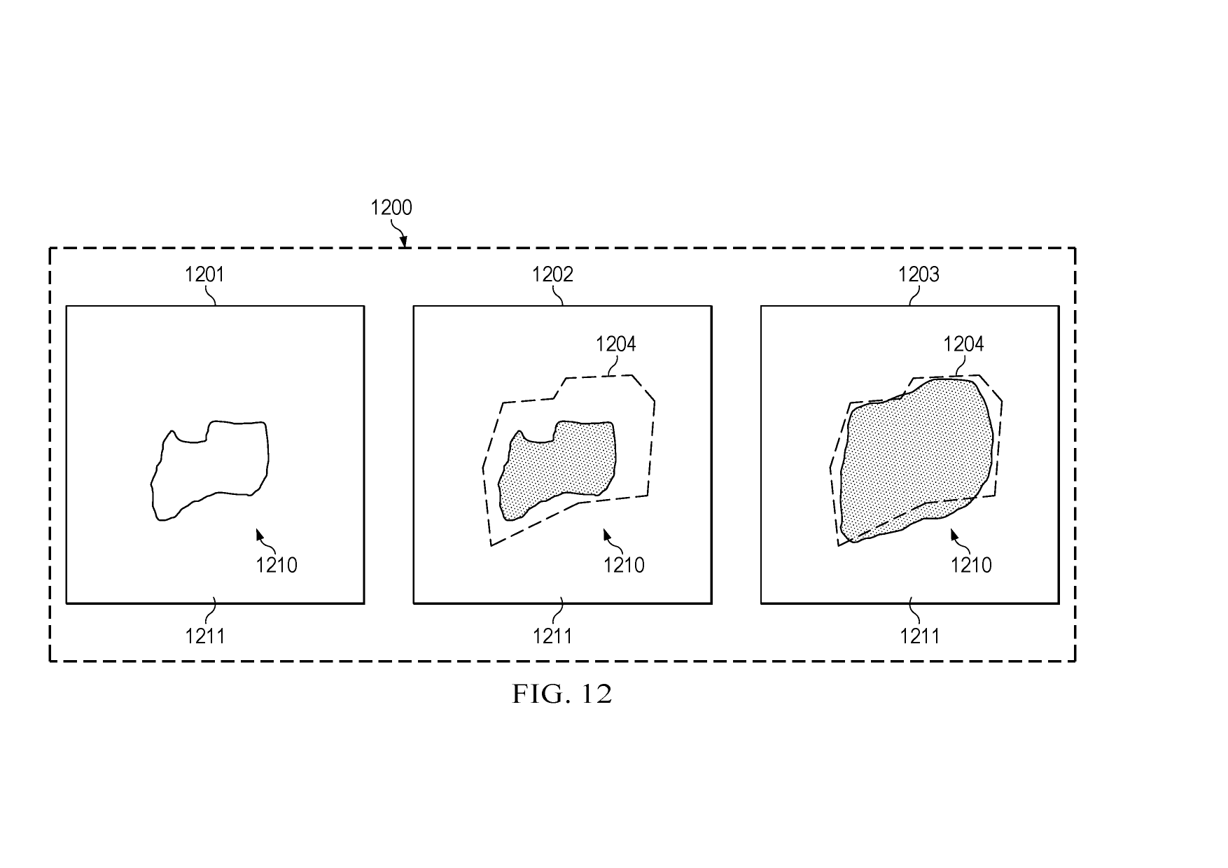

Next in FIG. 11, an illustration of a heat map of an aircraft is depicted in accordance with an illustrative embodiment. As depicted, heat map 1100 is an example of an image generated for aircraft 1101. Heat map 1100 is generated using an anomaly analysis system, such as anomaly analysis system 215 in FIG. 2. Heat map 1100 is an example of output image 235 in FIG. 2.

In this illustrative example, this image is not a photograph of aircraft 1101, but is a rendering of aircraft 1101. In this example, heat map 1100 can be generated using multiple images captured for aircraft 1101. For example, images can be taken of aircraft 1101 by at least one of an unmanned aerial vehicle, a crawler, a human operator using a camera, a fixed camera, or other sensor systems that can capture images of aircraft 1101.

As depicted in heat map 1100, three anomalies, anomaly 1102, anomaly 1103, and anomaly 1104, are shown on aircraft 1101 in heat map 1100.

In the illustrative example, heat map 1100 shows the size and shape of anomaly 1102, anomaly 1103, and anomaly 1104 after 400 flight hours as a future time frame from the current time frame of an image or images used as input.

As depicted, heat map 1100 shows locations of anomalies on aircraft 1101. This heat map also shows a size of the anomalies at a future time frame of 400 flight hours. Further, different sizes are shown for different probabilities at this future time frame in the different locations on aircraft 1101.

The illustration of the images in FIGS. 10 and 11 are represented as an example of one manner in which images can be generated to illustrate a number of parameters predicted for anomalies and future time frames. This illustration is not meant to limit the manner in which other illustrative examples can be implemented.

For example, a three-dimensional image can be displayed to a human operator in which the human operator may navigate and move to different reference points relative to the three-dimensional image to see whether anomalies are present and whether parameters for anomalies may have changed over time. In another example, rather than putting a rendering of an aircraft, an image of the aircraft can be a photograph or actual visual representation with changes made by a machine learning model such as a generative artificial intelligence model, to show changes in parameters for anomalies. In yet another illustrative example, these images can be for other types of platforms in addition to an aircraft. For example, images can be for a ship, a spacecraft, a building, or other platform.

Turning to FIG. 13, an illustration of images for change prediction of an anomaly is depicted in accordance with an illustrative embodiment. In this example, images 1300 are images for anomaly 1310. Image 1301 is an example of input image 230 in FIG. 2. Image 1302 is an example of output image 235 output by an anomaly analysis system, such as anomaly analysis system 215 in FIG. 2. Image 1303 illustrates the actual change in anomaly 1310.

Image 1301 is an image of initial anomaly 1310 on platform 1311 at a reference time frame. This reference time frame is a time frame from which a prediction of parameters for a growth prediction of initial anomaly 1310 at the future time frame can be made. In this example, these parameters can be, for example, an area and shape.

In this illustrative example, image 1302 in images 1300 illustrates a predicted change in the initial anomaly 1310 as a growth in initial anomaly 1310 to form predicted change anomaly 1304 at a future time frame from the reference time frame shown in image 1301. As depicted predicted change anomaly 1304 shows a change in the shape of initial anomaly 1310 as well as a change in the area covered. This image also includes another predicted change in initial anomaly 1310 in the form of predicted change anomaly 1305 at the future time frame from the reference time frame. In this example, predicted change anomaly 1305 has grown. These two predicted change anomalies can have different probabilities. In this example, the two predicted change anomalies have different severity levels. For example, predicted change anomaly 1304 is a minor anomaly while predicted change anomaly 1305 is a major anomaly.

Predicted change anomaly 1305 is considered a major anomaly because this anomaly is out of tolerance or does not meet a desired performance specification. In this example, predicted change anomaly 1305 is related to initial anomaly 1310 because predicted change anomaly 1305 is a change in initial anomaly 1310.

Image 1303 shows the actual changes in initial anomaly 1310 to at the future timeframe. In this example, actual change anomaly 1312 is also shown with respect to the prediction of the change from predicted change anomaly 1304 and predicted change anomaly 1305.

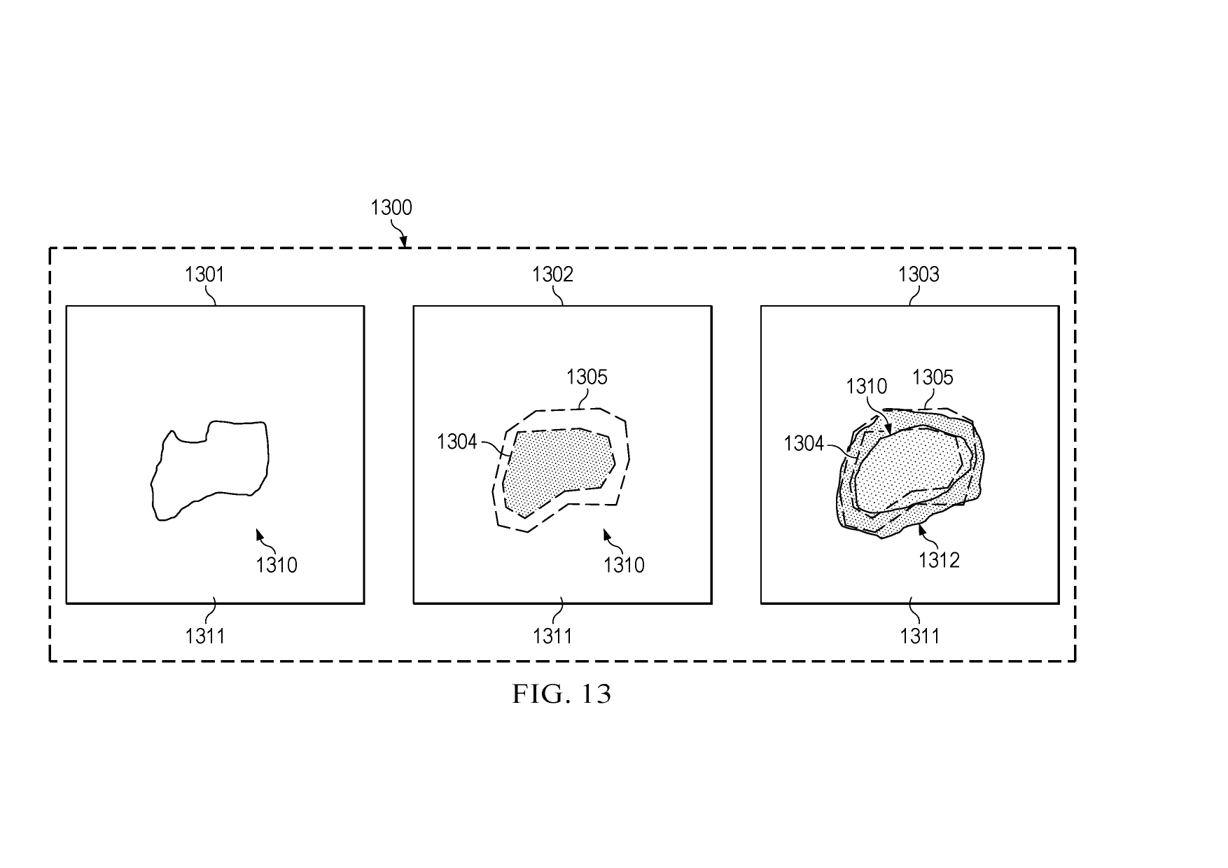

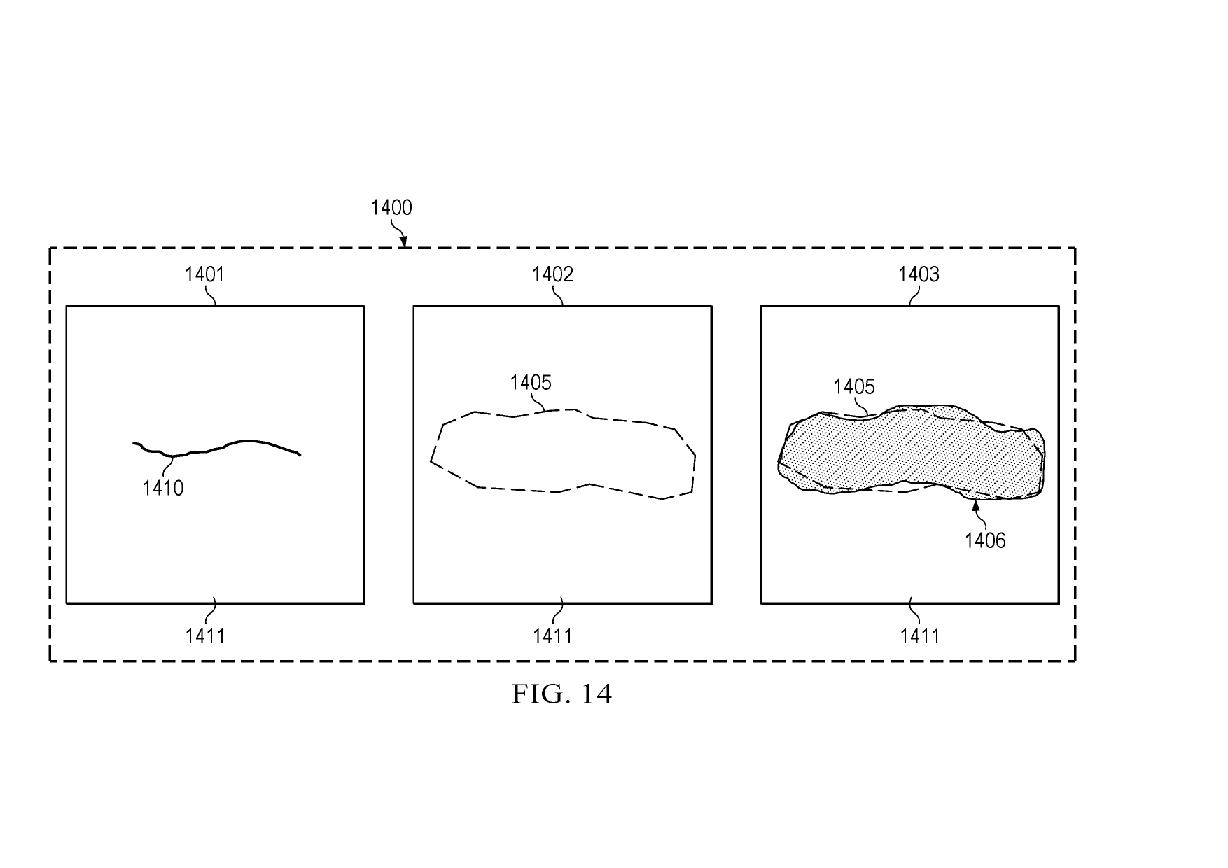

Turning to FIG. 14, an illustration of images for a subsurface prediction is depicted in accordance with an illustrative embodiment. In this example, images 1400 are images for showing a prediction of a subsurface anomaly from surface anomaly 1410. Image 1401 is an example of input image 230 in FIG. 2. Image 1402 is an example of output image 235 output by an anomaly analysis system, such as anomaly analysis system 215 in FIG. 2. Image 1403 illustrates the actual subsurface anomaly.

Image 1401 is an image of surface anomaly 1410 on platform 1411. This image can be a visible light image and can be used to predict the presence of subsurface anomaly 1406 even though that anomaly is not visible in image 1401. In this example, the prediction can be of parameters of subsurface anomaly 1406. In this example, these parameters can be, for example, an area and shape.

Image 1401 is an image of surface anomaly 1410 on platform 1211. Surface anomaly 1410 is visible from the surface of platform 1411.

In this illustrative example, image 1402 in images 1400 illustrates predicted subsurface anomaly 1405 that can be predicted from surface anomaly 1410 in image 1401.

As depicted, image 1403 shows predicted subsurface anomaly 1405 in comparison to actual subsurface anomaly 1406 that is present at the future timeframe. This image can be generated using a different type of sensor from the camera used to generate image 1401. For example, image 1403 can be generated using an x-ray system, and ultrasound system, or a thermographic camera.

Also, this prediction can be for at least one of the reference time frame or for a future timeframe from the reference time frame. In other words, the prediction of subsurface anomaly 1406 can be made from a visible light image such as image 1401 only showing surface anomaly 1410 at the same time as the reference time. In other examples, the prediction of subsurface anomaly 1406 can be for some period of time in the future from the reference time at which image 1401 was generated.

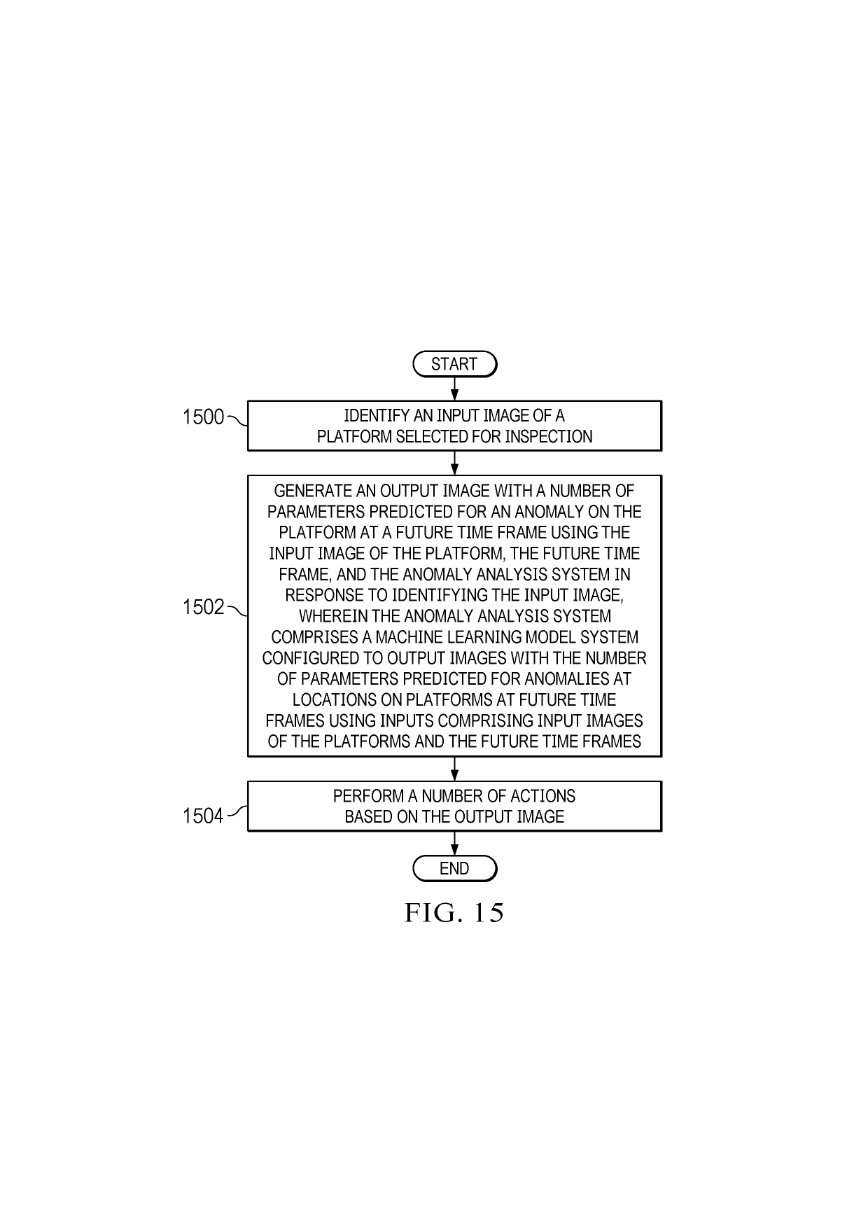

Turning next to FIG. 15, an illustration of a flowchart of a process for predicting an anomaly is depicted in accordance with an illustrative embodiment. The process in FIG. 15 can be implemented in hardware, software, or both. When implemented in software, the process can take the form of program instructions that are run by one or more processor units located in one or more hardware devices in one or more computer systems. For example, the process can be implemented in anomaly predictor 214 in computer system 212 in FIG. 2.

The process begins by identifying an input image of a platform selected for inspection (operation 1500). In operation 1500, the identifying of the image can be performed by the process receiving the input image, searching for the input image, or other actions to obtain the input image needed for processing. The process generates an output image with a number of parameters predicted for an anomaly on the platform at a future time frame using the input image of the platform, the future time frame, and the anomaly analysis system in response to identifying the input image, wherein the anomaly analysis system comprises a machine learning model system configured to output images with the number of parameters predicted for anomalies at locations on platforms at future time frames using inputs comprising input images of the platforms and the future time frames (operation 1502).

The process performs a number of actions based on the output image (operation 1504). The process terminates thereafter. In operation 1504, the actions performed are also based on the number of parameters for predicted for the anomaly.

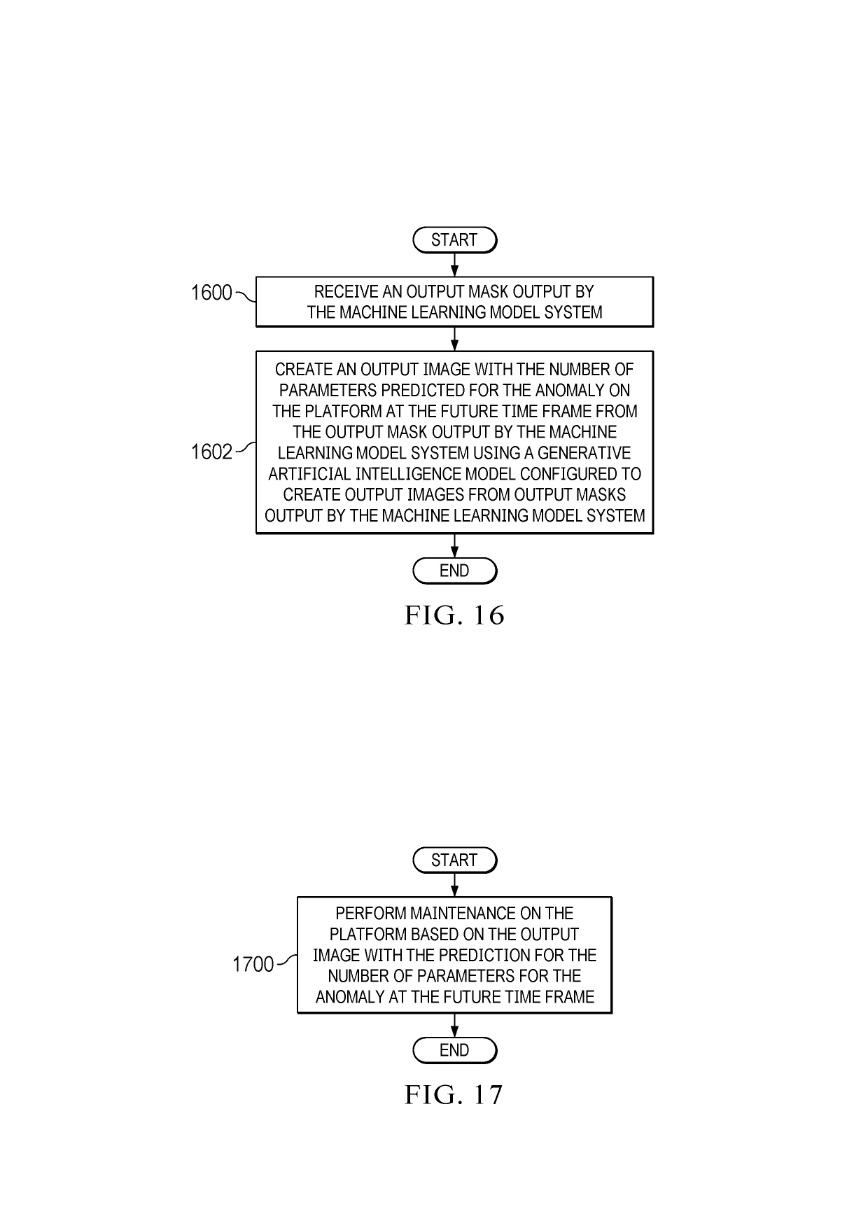

With reference to FIG. 16, an illustration of a flowchart of a process for generating output images from output masks is depicted in accordance with an illustrative embodiment. The process in this example is an example of an additional operation that is to be performed with the operations of FIG. 15 and can be implemented in a generative artificial intelligence model, such as generative artificial intelligence model 304 in FIG. 3.

The process receives an output mask output by the machine learning model system (operation 1600). The process creates an output image with the number of parameters predicted for the anomaly on the platform at the future time frame from the output mask output by the machine learning model system using a generative artificial intelligence model configured to create output images from output masks output by the machine learning model system (operation 1602). The process terminates thereafter.

Next in FIG. 17, an illustration of a flowchart of a process for performing maintenance is depicted in accordance with an illustrative embodiment. The process in this flowchart is an example of an additional operation that can be performed with the operations in FIG. 15.

The process performs maintenance on the platform based on the output image with the prediction for the number of parameters for the anomaly at the future time frame (operation 1700). The process terminates thereafter.

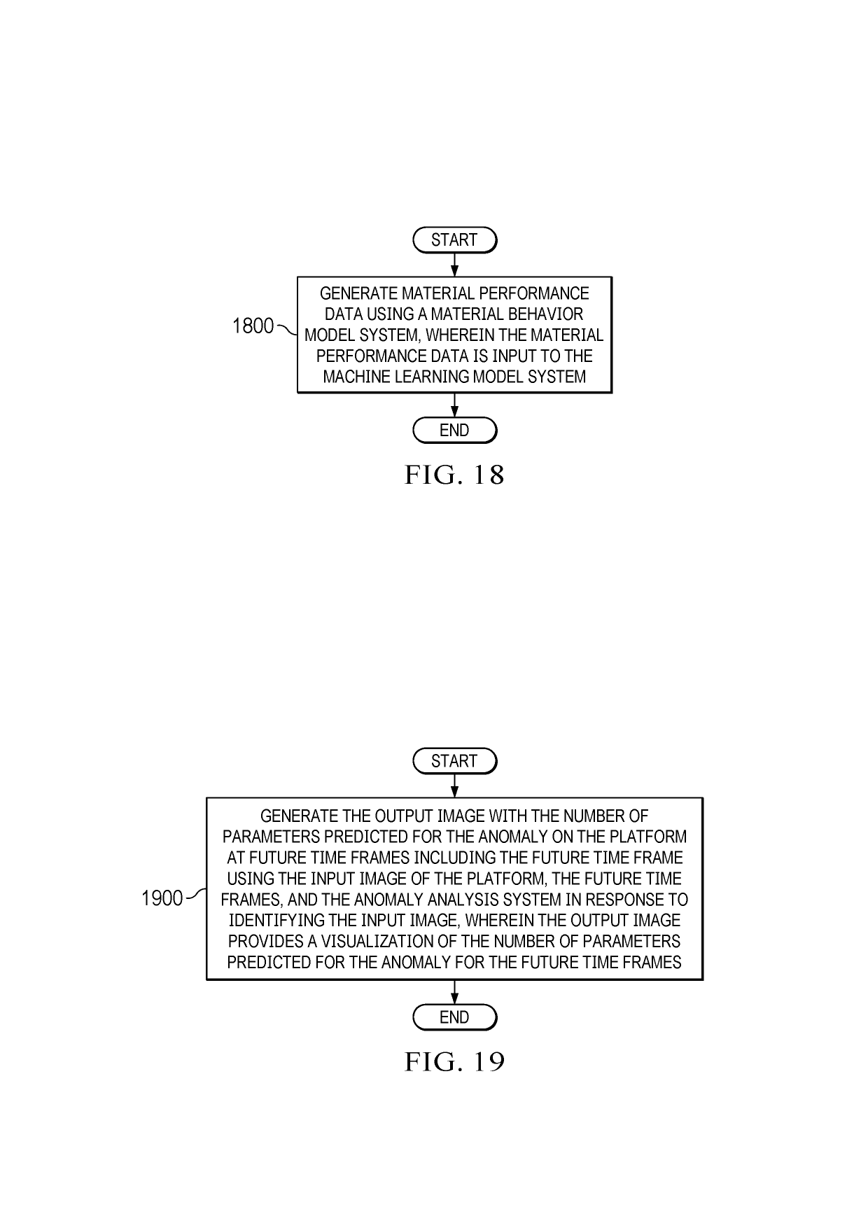

Turning now to FIG. 18, an illustration of a flowchart of a process for generating material performance data is depicted in accordance with an illustrative embodiment. The process in this flowchart is an example of an additional operation that can be performed with the operations in FIG. 15.

The process generates material performance data using a material behavior model system, wherein the material performance data is input to the machine learning model system (operation 1800). The process terminates thereafter.

With reference to FIG. 19, an illustration of a flowchart of a process for generating an output image is depicted in accordance with an illustrative embodiment. The process of this flowchart is an example of an implementation for operation 1502 in FIG. 15.

The process generates the output image with the number of parameters predicted for the anomaly on the platform at future time frames including the future time frame using the input image of the platform, the future time frames, and the anomaly analysis system in response to identifying the input image, wherein the output image provides a visualization of the number of parameters predicted for the anomaly for the future time frames (operation 1900). The process terminates thereafter.

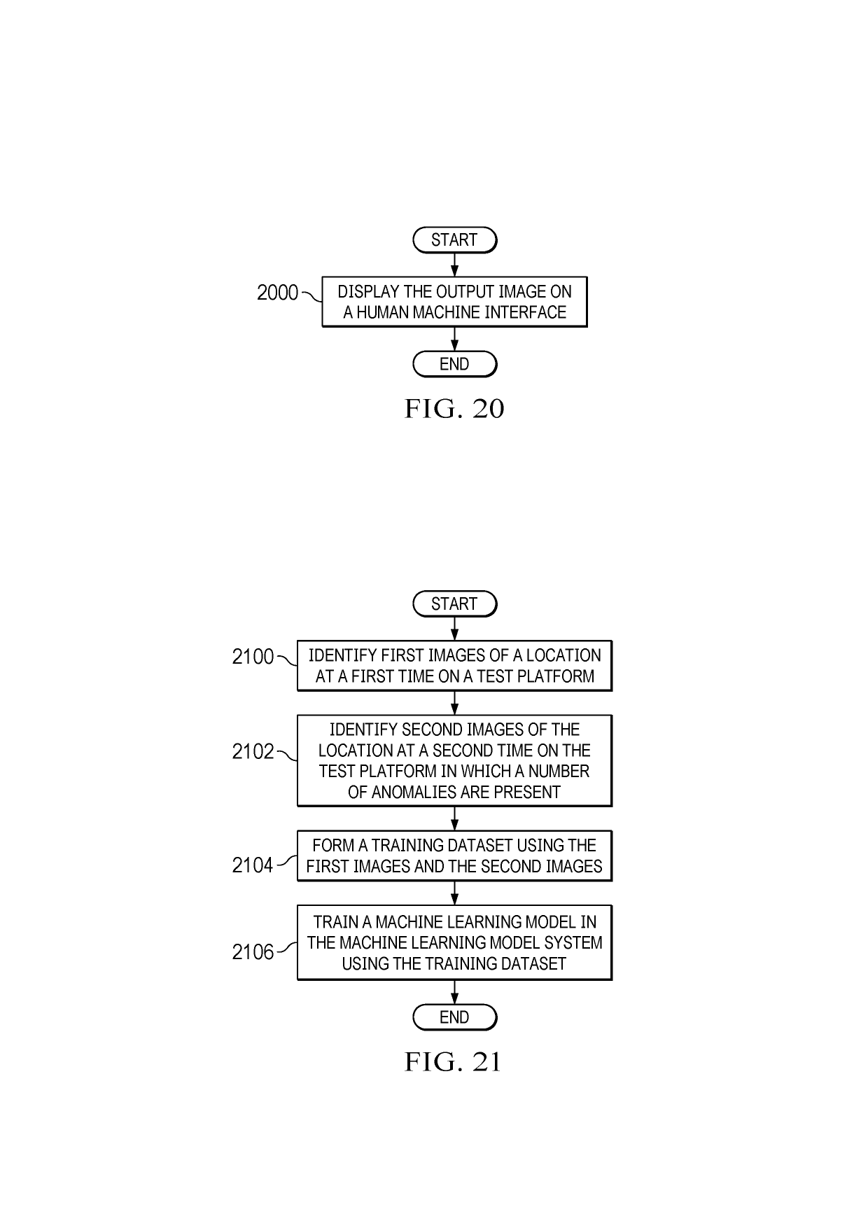

Next in FIG. 20, an illustration of a flowchart of a process for displaying an output image is depicted in accordance with an illustrative embodiment. The process in this flowchart is an example of an additional operation that can be performed with the operations in FIG. 15.

The process displays the output image on a human machine interface (operation 2000). The process terminates thereafter.

Turning now to FIG. 21, an illustration of a flowchart of a process for training a machine learning model is depicted in accordance with an illustrative embodiment. The process in FIG. 21 can be implemented in hardware, software, or both. When implemented in software, the process can take the form of program instructions that are run by one of more processor units located in one or more hardware devices in one or more computer systems. For example, the process can be implemented in trainer 400 in FIG. 4.

The process identifies first images of a location at a first time on a test platform (operation 2100). In these examples, the test platform can be any platform from which images or other data are collected for training or validating a machine learning model. In operation 2100, the test platform is any platform from which images are generated for use in training. The process identifies second images of the location at a second time on the test platform in which a number of anomalies are present (operation 2102).

The process forms a training dataset using the first images and the second images (operation 2104). The process trains a machine learning model in the machine learning model system using the training dataset (operation 2106). The process terminates thereafter.

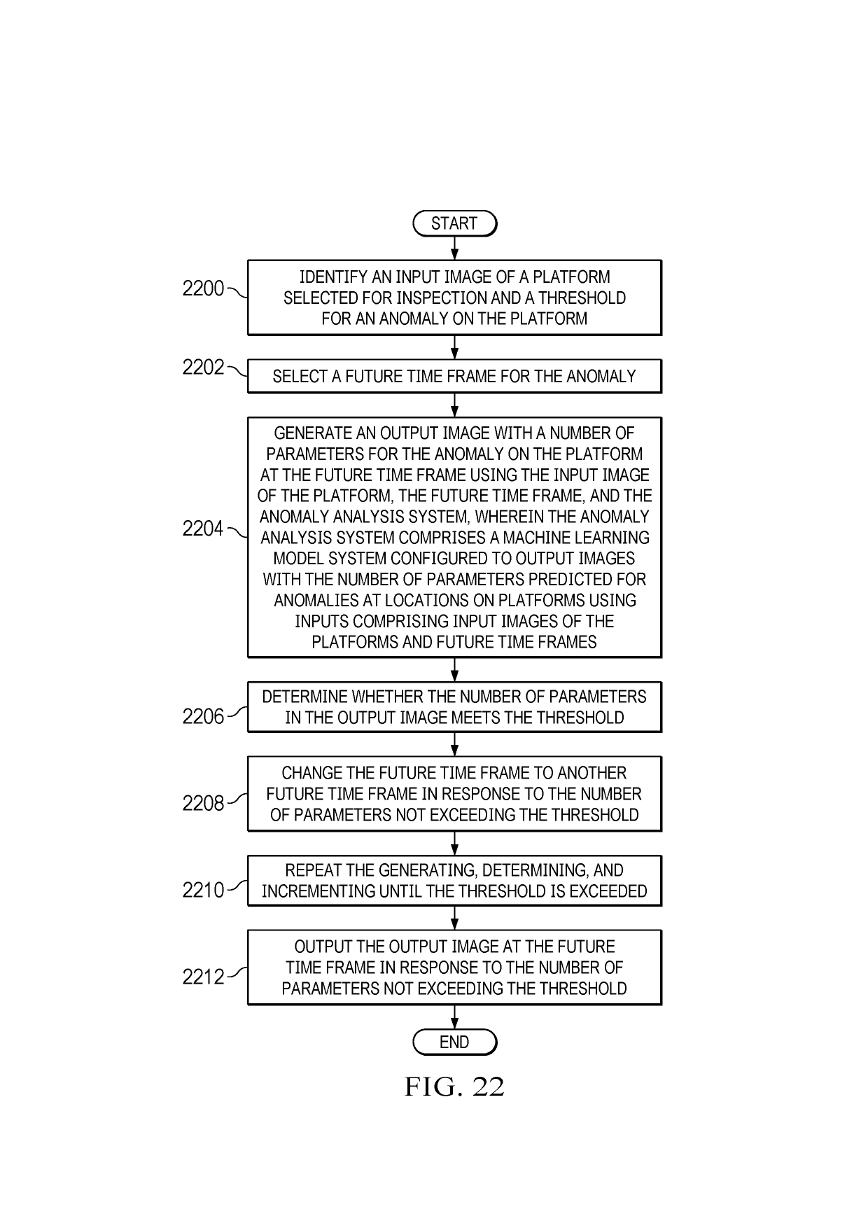

With reference next to FIG. 22, an illustration of a flowchart of a process for predicting an anomaly is depicted in accordance with an illustrative embodiment. The process in FIG. 22 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process begins by identifying an input image of a platform selected for inspection and a threshold for an anomaly on the platform (operation 2200). The process selects a future time frame for the anomaly (operation 2202). The process generates an output image with a number of parameters for the anomaly on the platform at the future time frame using the input image of the platform, the future time frame, and the anomaly analysis system, wherein the anomaly analysis system comprises a machine learning model system configured to output images with the number of parameters predicted for anomalies at locations on platforms using inputs comprising input images of the platforms and future time frames (operation 2204).

The process determines whether the number of parameters in the output image meets the threshold (operation 2206). The process changes the future time frame to another future time frame in response to the number of parameters not exceeding the threshold (operation 2208).

In operation 2208, the future time frame is changed using one of a linear search and a binary search. A linear search involves incrementing the threshold by some selected amount. For example, the future time frame can be incremented by one flight hour, ten flight hours, or some other number of flight hours.

With a binary search, the search begins by selecting an initial future time frame. This initial future time frame can be in the middle of a possible range of time frames. For example, the future time frame can be the midpoint between zero and the maximum possible value for the future time frame. The possible range is divided in half for the selected future time frame. The selected future time frame is evaluated to determine whether the threshold for the number of parameters is exceeded. If the future time frame results in a number of parameters exceeding the threshold, the lower half of the remaining range is searched in the same manner. If the future time frame does not result in the number of parameters exceeding the threshold, the upper half of the remaining range is searched. These steps are repeated until a future time frame is found that matches the threshold within an acceptable margin.

The process repeats the generating, determining, and incrementing until the threshold is exceeded (operation 2210). The process outputs the output image at the future time frame in response to the number of parameters not exceeding the threshold (operation 2212). The process terminates thereafter.

Thus, with the process in FIG. 22, output images can be generated that provides identifying a future time frame in which the anomaly becomes out of tolerance. For example, a threshold of a 50% growth in the area of an anomaly can be set. With this process, the future time frame can be identified when the anomaly grows by 50%. Thus, a future time frame such as the number of hours until maintenance can be determined.

By knowing this future time frame, maintenance can be scheduled proactively at a time that is convenient. With the ability to determine when maintenance is needed sooner, as compared to current inspection techniques, the amount of time a platform such as an aircraft will be out of service at an undesired time can be reduced.

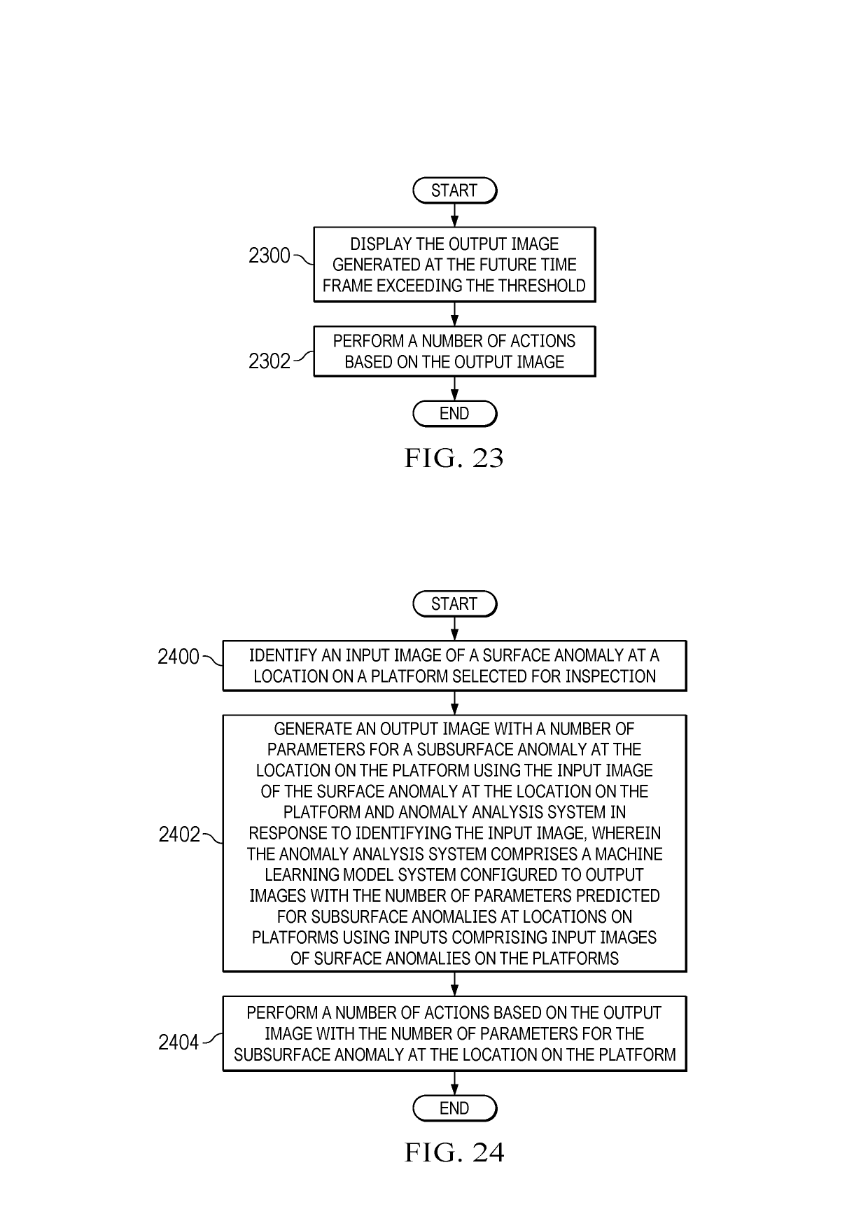

Turning next to FIG. 23, an illustration of a flowchart of a process for performing actions is depicted in accordance with an illustrative embodiment. This flowchart is an example of additional operations that can be performed with the operations in FIG. 22.

The process displays the output image generated at the future time frame exceeding the threshold (operation 2300). The process performs a number of actions based on the output image (operation 2302). The process terminates thereafter.

With reference next to FIG. 24, an illustration of a flowchart of a process for predicting current subsurface anomalies is depicted in accordance with an illustrative embodiment. The process in FIG. 24 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process identifies an input image of a surface anomaly at a location on a platform selected for inspection (operation 2400). The process generates an output image with a number of parameters for a subsurface anomaly at the location on the platform using the input image of the surface anomaly at the location on the platform and anomaly analysis system in response to identifying the input image, wherein the anomaly analysis system comprises a machine learning model system configured to output images with the number of parameters predicted for subsurface anomalies at locations on platforms using inputs comprising input images of surface anomalies at the locations on the platforms (operation 2402).

In one example, the input image is for the surface anomaly at a reference time frame and the output image is for the subsurface anomaly at a future time frame. In this example, the prediction is for a subsurface anomaly at some time in the future. The future time frame can be measured in hours, days, flight hours, a selected date in the future, engine cycles, flight cycles, and other measurements of time or operation. This measurement is from a reference time frame which is the time at which the input image is generated.

In another example, the input image is for the surface anomaly at a current time frame and the output image is for the subsurface anomaly at the current time frame. In other words, the prediction is for the presence of a subsurface anomaly at the time in which the surface anomaly is captured in the input image.

In yet another illustrative example, the input image can be at a current time frame. In this case, a surface anomaly may not be present in the input image. This current time frame is the future time frame in this example when it desirable to know whether a subsurface anomaly is present at the current time. With this example, the reference time frame is a prior time in the past and historical platform data from the reference time frame (a time in the past) to the current time frame (the current time) for the aircraft is used. Thus, in this example, the machine learning model system predicts whether a subsurface anomaly is present in the input image and the expected platform data from the reference time frame (prior time) to the future time frame (current time).

The process performs a number of actions based on the output image with the number of parameters for the subsurface anomaly at the location on the platform (operation 2404). The process terminates thereafter.

Thus, the operations in this flowchart uses an input image that has a surface anomaly at a location. These input images are used to predict a subsurface anomaly at the location based on the presence of the surface anomaly in the input image.

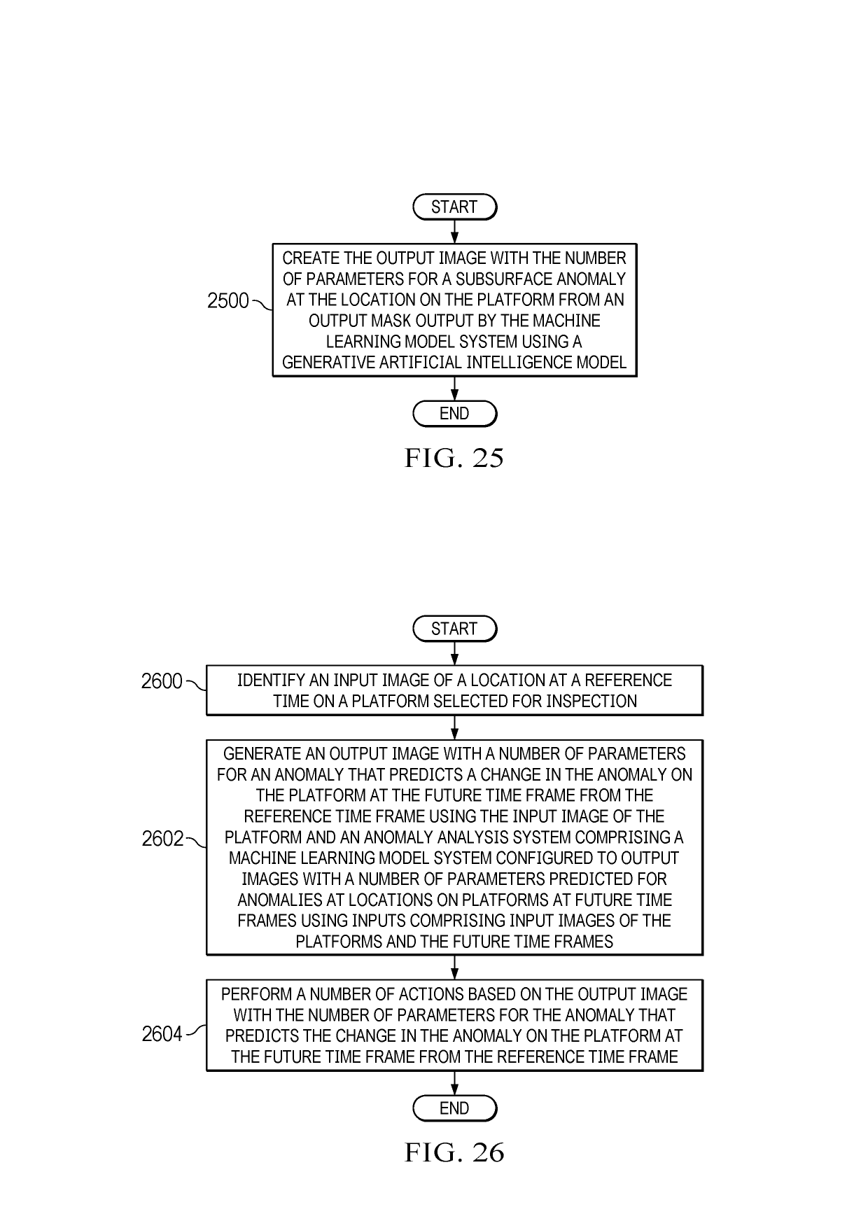

Turning to FIG. 25, an illustration of a flowchart of a process for creating an output image is depicted in accordance with an illustrative embodiment. The process in this flowchart is an example of an implementation for operation 2402 in FIG. 24.

The process creates the output image with the number of parameters for a subsurface anomaly at the location on the platform from an output mask output by the machine learning model system using a generative artificial intelligence model (operation 2500). The process terminates thereafter.

Turning to FIG. 26, an illustration of a flowchart of a process for predicting future changes in anomalies is depicted in accordance with an illustrative embodiment. The process in FIG. 26 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process identifies an input image of a location at a reference time on a platform selected for inspection (operation 2600). The process generates an output image with a number of parameters for an anomaly that predicts a change in the anomaly on the platform at the future time frame from the reference time frame using the input image of the platform and an anomaly analysis system comprising a machine learning model system configured to output images with a number of parameters predicted for anomalies at locations on platforms at future time frames using inputs comprising input images of the platforms and the future time frames (operation 2602). In operation 2602, the change is selected from at least one of a growth of the anomaly, a type of the anomaly, or a severity of the anomaly at the future time frame.

The process performs a number of actions based on the output image with the number of parameters for the anomaly that predicts the change in the anomaly on the platform at the future time frame from the reference time frame (operation 2604). The process terminates thereafter.

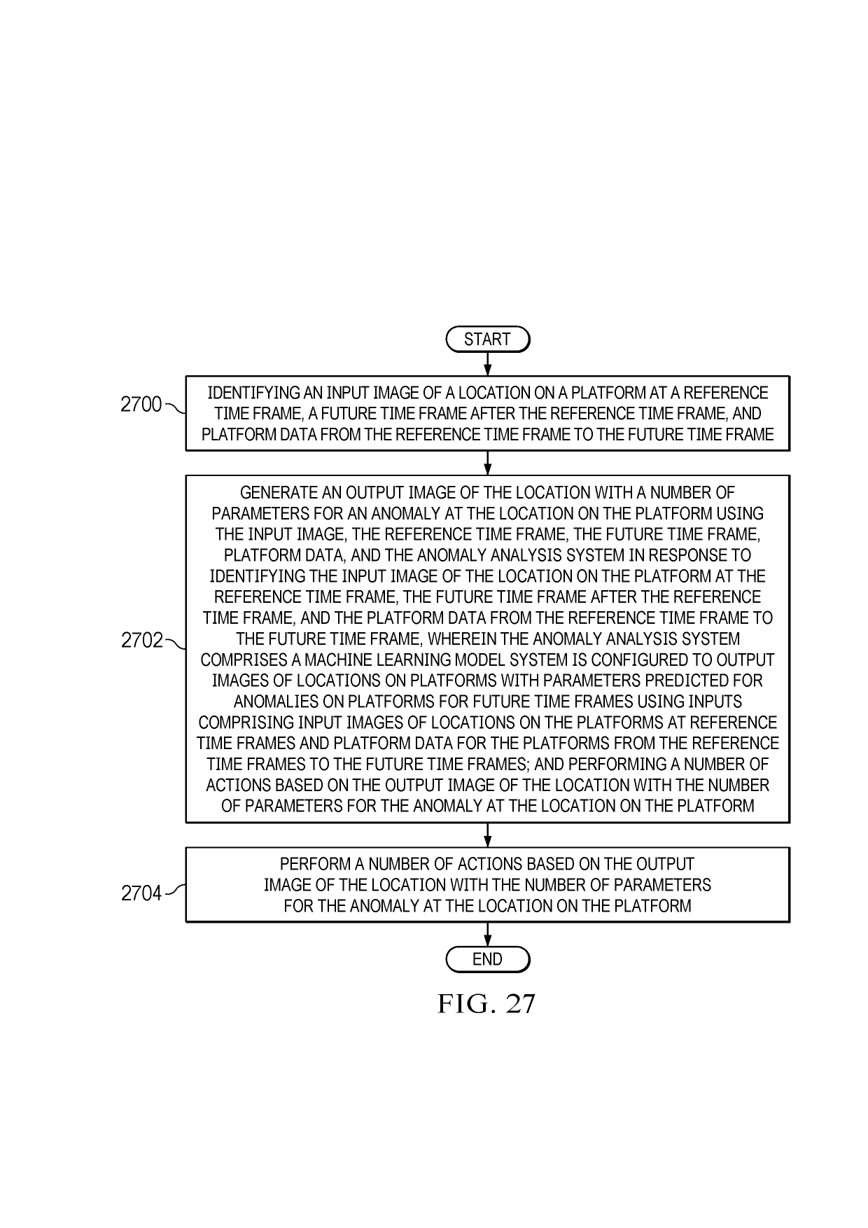

Next in FIG. 27, an illustration of a flowchart of process for predicting future subsurface anomalies is depicted in accordance with an illustrative embodiment. The process in FIG. 27 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process identifies an input image of a location on a platform at a reference time frame, a future time frame after the reference time frame, and the platform data from the reference time frame to the future time frame (operation 2700). In operation 2700, the platform data can include expected platform data and can include historical platform data depending on the reference timeframe selected. For example, if the reference time frames is one month in the past, and the future timeframe is two months in the future, then the platform data includes historical platform data from one month in the past to the current time and expected platform data from the current timeframe.

The process generates an output image of the location with a number of parameters for an anomaly at the location on the platform using the input image, the reference time frame, the future time frame, platform data, and the anomaly analysis system in response to identifying the input image of the location on the platform at the reference time frame, the future time frame after the reference time frame, and the platform data from the reference time frame to the future time frame, wherein the anomaly analysis system comprises a machine learning model system is configured to output images of locations on platforms with parameters predicted for anomalies on platforms for future time frames using inputs comprising input images of locations on the platforms at reference time frames and platform data for the platforms from the reference time frames to the future time frames (operation 2702).

In this example, the anomalies predicted by the machine learning model system can be surface anomalies and subsurface anomalies, and the anomaly is selected from a group comprising a surface anomaly and a subsurface anomaly. As another example, the anomalies predicted by the machine learning model system can be subsurface anomalies, wherein the number of parameters for the anomaly is for a subsurface anomaly. In yet another example, the anomalies predicted by the machine learning model system are surface anomalies and subsurface anomalies, wherein the number of parameters for the anomaly is one of a surface anomaly and a subsurface anomaly. In another example, one of the parameters can have a value indicating the absence of the anomaly. For example, the size parameter can be zero when the anomaly is absent in the output image.

The process performs a number of actions based on the output image of the location with the number of parameters for the anomaly at the location on the platform (operation 2704). The process terminates thereafter. In operation 2704, the number of actions comprises at least one of changing an operational status of the platform based on the number of parameters predicted, storing the output image, generating an alert in response to the output image for the number of parameters predicted for the anomaly at the future time frame being out of a tolerance, scheduling maintenance for the platform, displaying the output image, or sending an email message with the output image.

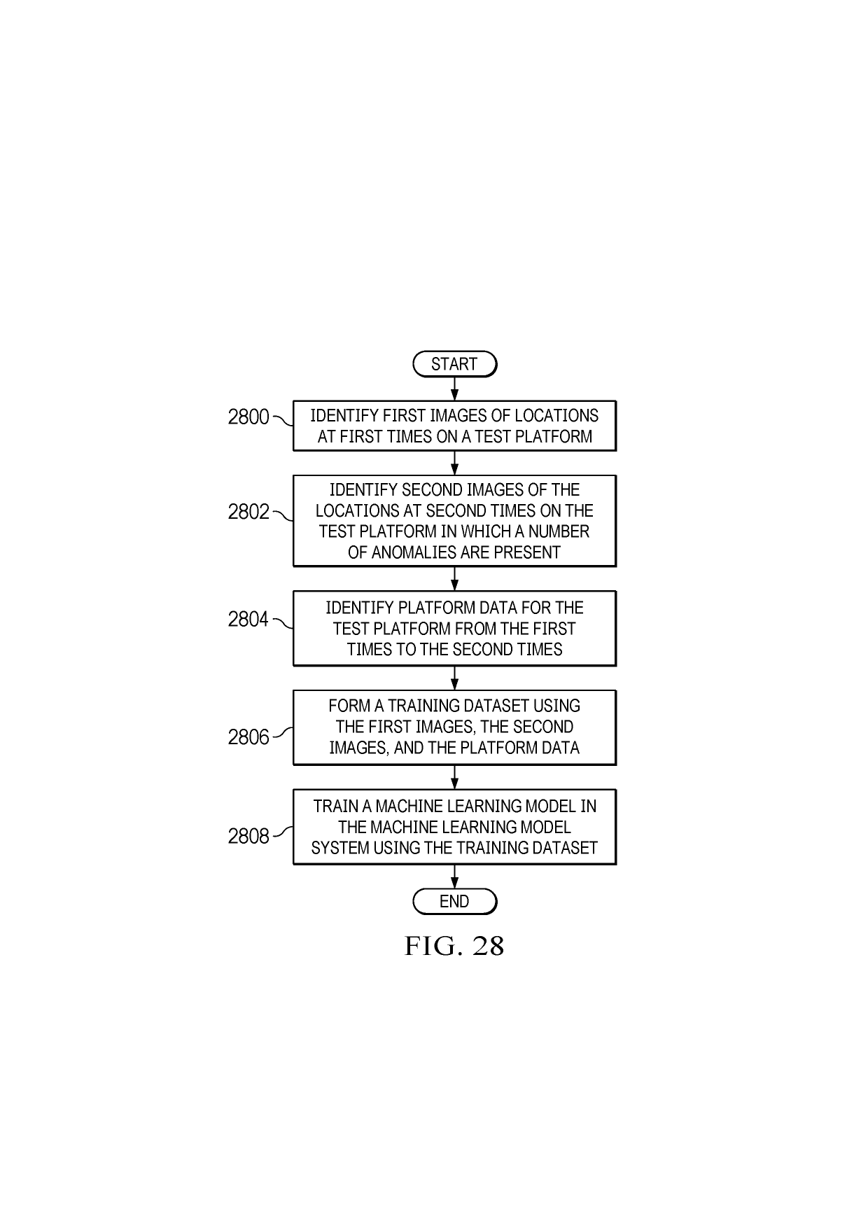

Referring now to FIG. 28, an illustration of flowchart of a process for training machine learning models is depicted in accordance with an illustrative embodiment. The process in this flowchart is an example of additional operations that can be performed with the operations in FIG. 27.

The process identifies first images of locations at first times on a test platform (operation 2800). The process identifies second images of the locations at second times on the test platform in which a number of anomalies are present (operation 2802). In operation 2802, the anomalies can be at least one of surface anomalies or subsurface anomalies.

The process identifies platform data for the test platform from the first times to the second times (operation 2804). In this operation, the platform data can be specifically data for the platform. Further, the platform data can also include data from other platforms that are categorized to be in the same category as the platform such as an airplane of the same model, variant, or subvariant.

The process forms a training dataset using the first images, the second images, and the platform data (operation 2806). The process trains a machine learning model in the machine learning model system using the training dataset (operation 2808). The process terminates thereafter.

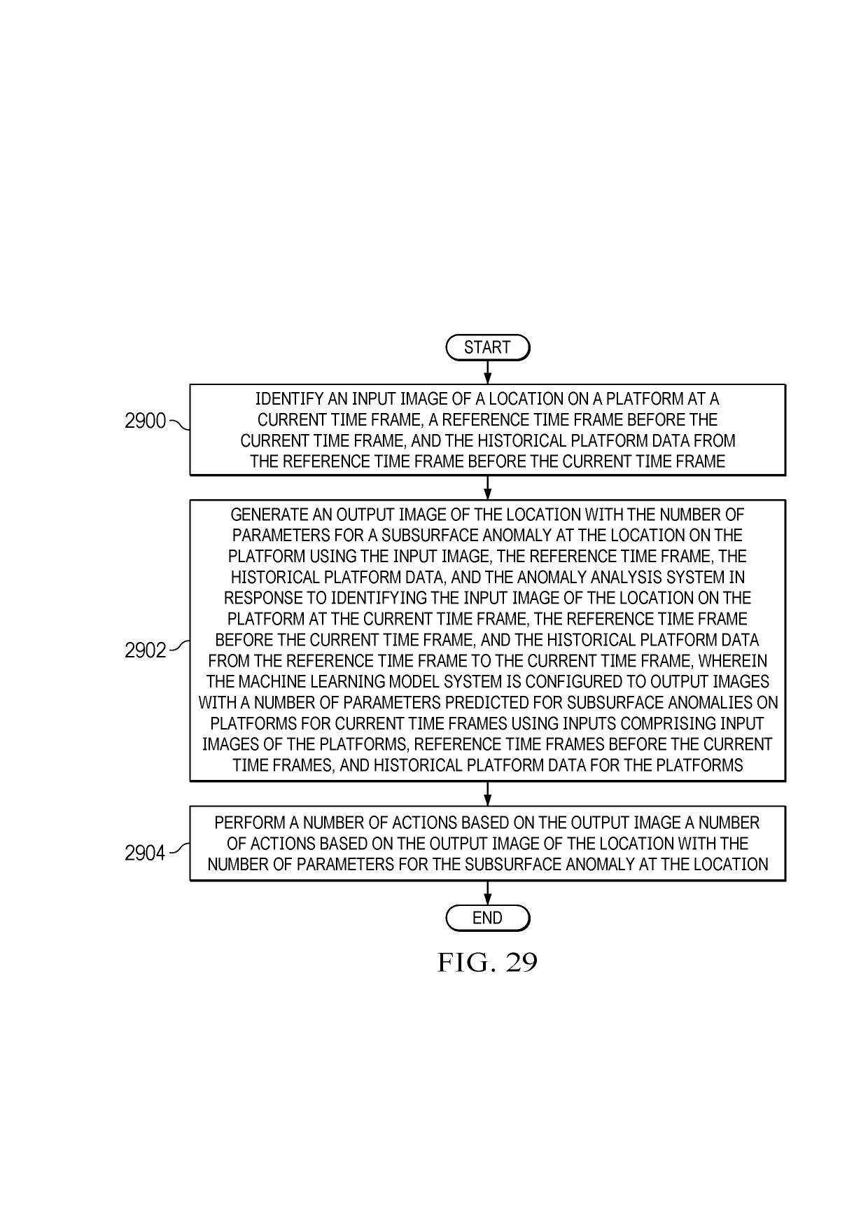

Turning now to FIG. 29, an illustration of a flowchart of a process for predicting subsurface and surface anomalies in accordance with an illustrative embodiment. The process in FIG. 29 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

This process operates to predict the presence of subsurface anomalies at a current time frame using historical platform data. In this illustrative example, the process uses an input image at a current time frame. This current time frame is the time at which the input image is captured.

The process identifies an input image of a location on a platform at a current time frame, a reference time frame before the current time frame, and the historical platform data from the reference time frame before the current time frame (operation 2900). The process generates an output image of the location with the number of parameters for a subsurface anomaly at the location on the platform using the input image, the reference time frame, the historical platform data, and the anomaly analysis system in response to identifying the input image of the location on the platform at the current time frame, the reference time frame before the current time frame, and the historical platform data from the reference time frame to the current time frame, wherein the machine learning model system is configured to output images with a number of parameters predicted for subsurface anomalies on platforms for current time frames using inputs comprising input images of the platforms, reference time frames before the current time frames, and historical platform data for the platforms (operation 2902).

The process performs a number of actions based on the output image a number of actions based on the output image of the location with the number of parameters for the subsurface anomaly at the location (operation 2904). The process terminates thereafter. Thus, this process can predict the presence of a subsurface anomaly at a current time of an image. As a result, the process provides a technological improvement in which actions can be performed based on predictions of subsurface anomalies that are currently present at a particular location on the platform.

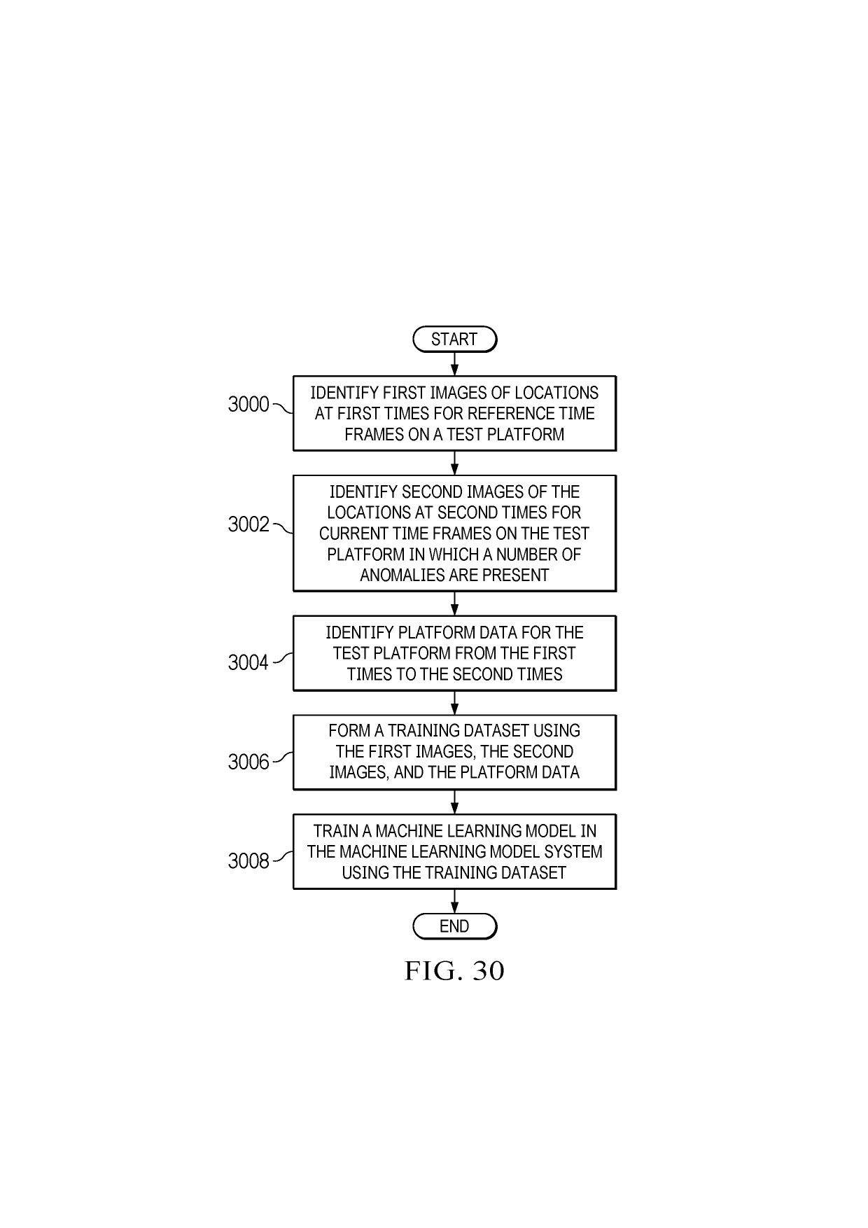

Next in FIG. 30, an illustration of a flowchart of a process for training machine learning models is depicted in accordance with an illustrative embodiment. The process in this flowchart is an example of additional operations that can be performed with the operations in FIG. 29.

The process identifies first images of locations at first times for reference time frames on a test platform (operation 3000). The process identifies second images of the locations at second times for current time frames on the test platform in which a number of anomalies are present (operation 3002). In operation 3002, the anomalies can be at least one of surface anomalies or subsurface anomalies.

The process identifies platform data for the test platform from the first times to the second times (operation 3004). In this operation, the platform data can be specifically data for the platform. Further, the platform data can also include data from other platforms that are categorized to be in the same category as the platform such as an airplane of the same model, variant, or subvariant.

The process forms a training dataset using the first images, the second images, and the platform data (operation 3006). The process trains a machine learning model in the machine learning model system using the training dataset (operation 3008). The process terminates thereafter.

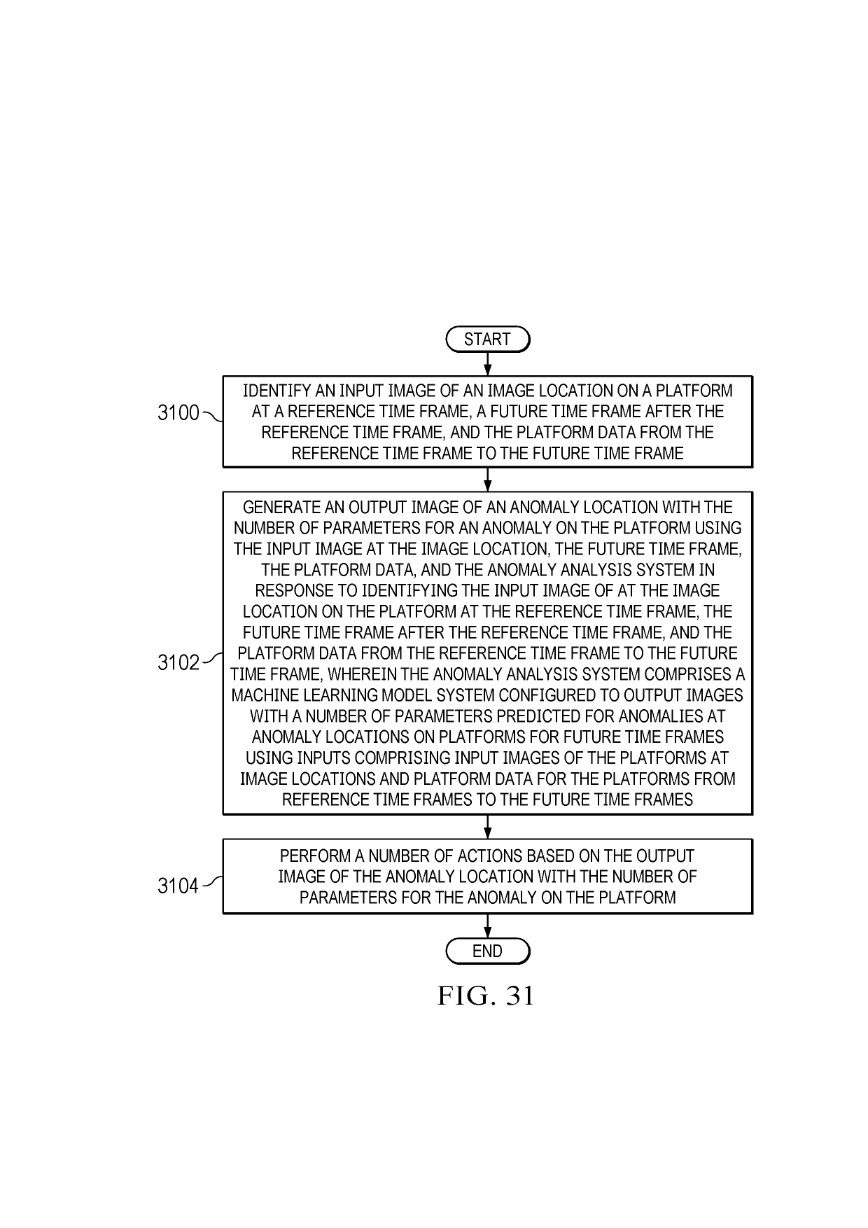

Turning now to FIG. 31, an illustration of a flowchart of a process for predicting subsurface and surface anomalies in accordance with an illustrative embodiment. The process in FIG. 31 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2. This process can be used to predict anomalies at locations that can be different from the location of the image input for processing. The reference time frame can be any point in time before the future time frame with this example. These anomalies can include surface anomalies and subsurface anomalies. For example, the anomaly predicted can be a subsurface anomaly, a surface anomaly, or both subsurface and surface anomaly.

The process identifies an input image of an image location on a platform at a reference time frame, a future time frame after the reference time frame, and the platform data from the reference time frame to the future time frame (operation 3100). In this example, the image can be of any location on the platform.

The process generates an output image of an anomaly location with the number of parameters for an anomaly on the platform using the input image at the image location, the future time frame, the platform data, and the anomaly analysis system in response to identifying the input image at the image location on the platform at the reference time frame, the future time frame after the reference time frame, and the platform data from the reference time frame to the future time frame, wherein the anomaly analysis system comprises a machine learning model system configured to output images with a number of parameters predicted for anomalies at anomaly locations on platforms for future time frames using inputs comprising input images of the platforms at image locations and platform data for the platforms from reference time frames to the future time frames (operation 3102).

In this example, the anomaly location can be a different location from the image location. For example, with the platform in the form of a wing, the image location can be a faring on a left wing and the anomaly location can be a fairing on the right wing. In this example, the image location can be different from the anomaly location. Further, the anomaly can be selected from one of a surface anomaly and a subsurface anomaly. Also, although not expressly recited, this output image can also include a number of anomalies in addition to the anomaly. For example, the anomaly in the image can be a surface anomaly. Another anomaly can be present in the image such as a surface anomaly for a subsurface anomaly.

The process performs a number of actions based on the output image of the anomaly (operation 3104). The process terminates thereafter.

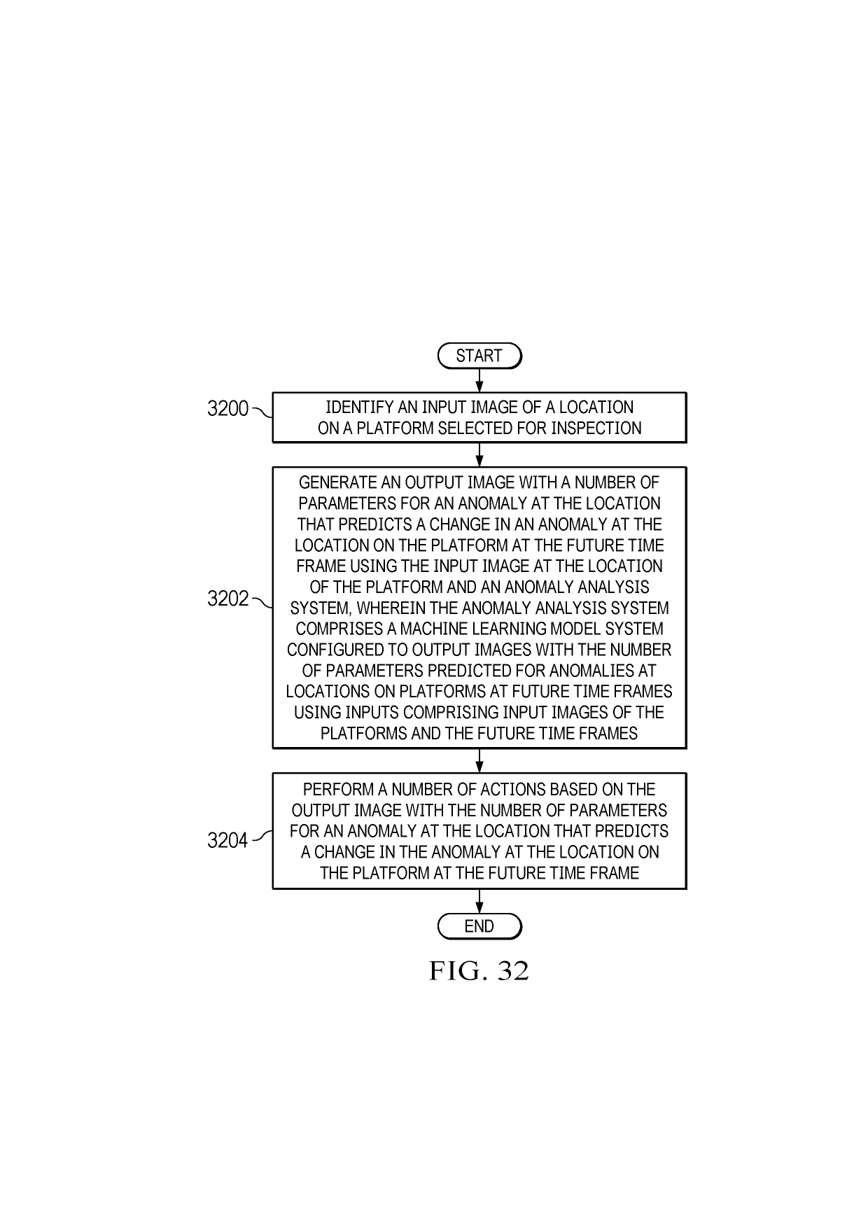

With reference to FIG. 32 an illustration of a flowchart of a process for predicting a change in an anomaly is depicted in accordance with an illustrative embodiment. The process in FIG. 32 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process identifies an input image of a location on a platform selected for inspection (operation 3200). The process generates an output image with a number of parameters for an anomaly at the location that predicts a change in the anomaly at the location on the platform at the future time frame using the input image at the location of the platform and an anomaly analysis system, wherein the anomaly analysis system comprises a machine learning model system configured to output images with the number of parameters predicted for anomalies at locations on platforms at future time frames using inputs comprising input images of the platforms and the future time frames (operation 3202).

The process performs a number of actions based on the output image with the number of parameters for an anomaly at the location that predicts a change in the anomaly at the location on the platform at the future time frame (operation 3204). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

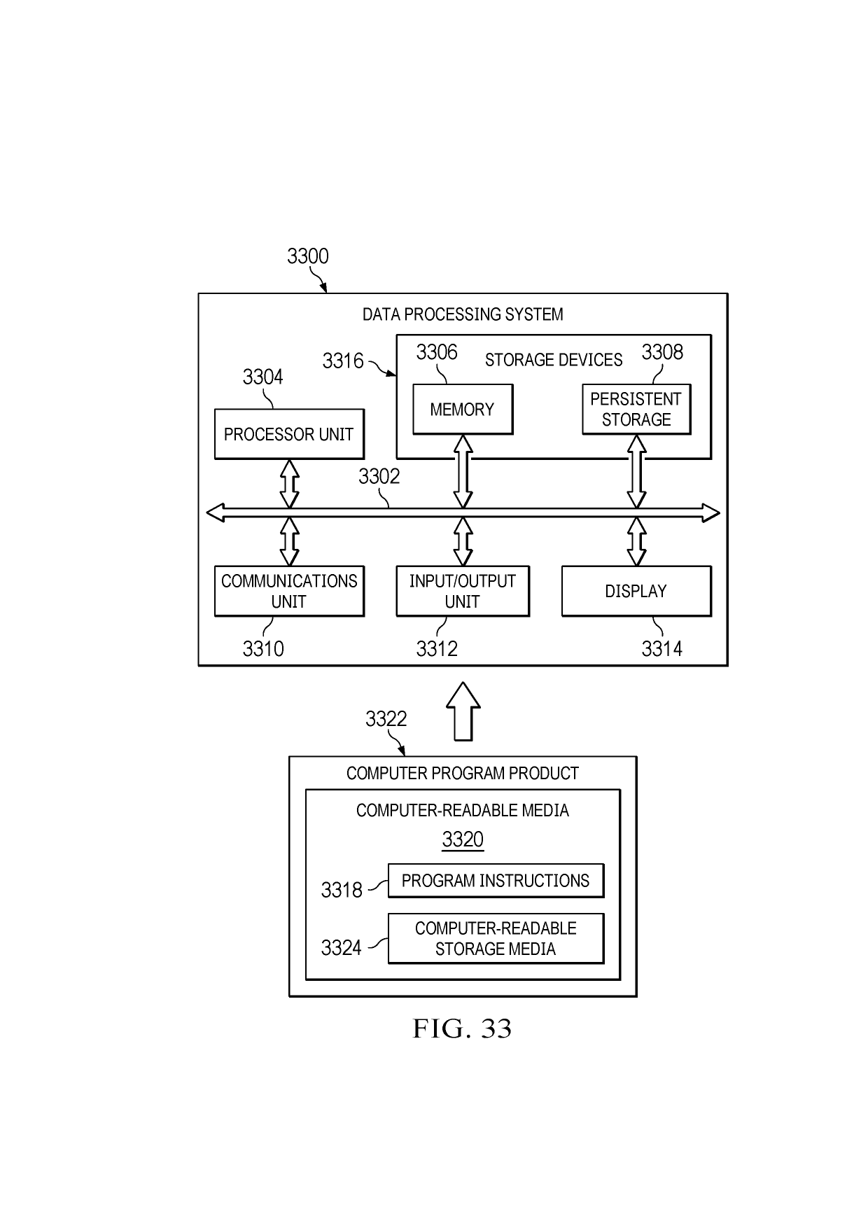

Turning now to FIG. 33, an illustration of a block diagram of a data processing system is depicted in accordance with an illustrative embodiment. Data processing system 3300 can be used to implement computer 105 in FIG. 1. Data processing system 3300 can also be used to implement computer system 212 in FIG. 2. In this illustrative example, data processing system 3300 includes communications framework 3302, which provides communications between processor unit 3304, memory 3306, persistent storage 3308, communications unit 3310, input/output (I/O) unit 3312, and display 3314. In this example, communications framework 3302 takes the form of a bus system.

Processor unit 3304 serves to execute instructions for software that can be loaded into memory 3306. Processor unit 3304 includes one or more processors. For example, processor unit 3304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 3304 can be implemented using one or more heterogeneous processor systems in which a main processor is present with secondary processors on a single chip. As another illustrative example, processor unit 3304 can be a symmetric multi-processor system containing multiple processors of the same type on a single chip.

Memory 3306 and persistent storage 3308 are examples of storage devices 3316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 3316 may also be referred to as computer-readable storage devices in these illustrative examples. Memory 3306, in these examples, can be, for example, a random-access memory or any other suitable volatile or non-volatile storage device. Persistent storage 3308 may take various forms, depending on the particular implementation.

For example, persistent storage 3308 may contain one or more components or devices. For example, persistent storage 3308 can be a hard drive, a solid-state drive (SSD), a flash memory, a rewritable optical disk, a rewritable magnetic tape, or some combination of the above. The media used by persistent storage 3308 also can be removable. For example, a removable hard drive can be used for persistent storage 3308.

Communications unit 3310, in these illustrative examples, provides for communications with other data processing systems or devices. In these illustrative examples, communications unit 3310 is a network interface card.

Input/output unit 3312 allows for input and output of data with other devices that can be connected to data processing system 3300. For example, input/output unit 3312 may provide a connection for user input through at least one of a keyboard, a mouse, or some other suitable input device. Further, input/output unit 3312 may send output to a printer. Display 3314 provides a mechanism to display information to a user.

Instructions for at least one of the operating system, applications, or programs can be located in storage devices 3316, which are in communication with processor unit 3304 through communications framework 3302. The processes of the different embodiments can be performed by processor unit 3304 using computer-implemented instructions, which may be located in a memory, such as memory 3306.

These instructions are referred to as program instructions, computer usable program instructions, or computer-readable program instructions that can be read and executed by a processor in processor unit 3304. The program instructions in the different embodiments can be embodied on different physical or computer-readable storage media, such as memory 3306 or persistent storage 3308.

Program instructions 3318 are located in a functional form on computer-readable media 3320 that is selectively removable and can be loaded onto or transferred to data processing system 3300 for execution by processor unit 3304. Program instructions 3318 and computer-readable media 3320 form computer program product 3322 in these illustrative examples. In the illustrative example, computer-readable media 3320 is computer-readable storage media 3324.

Computer-readable storage media 3324 is a physical or tangible storage device used to store program instructions 3318 rather than a medium that propagates or transmits program instructions 3318. Computer-readable storage media 3324 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits / lands formed in a major surface of a disc, or any suitable combination thereof.

Computer-readable storage media 3324, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 3318 can be transferred to data processing system 3300 using a computer-readable signal media. The computer-readable signal media are signals and can be, for example, a propagated data signal containing program instructions 3318. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 3320” can be singular or plural. For example, program instructions 3318 can be located in computer-readable media 3320 in the form of a single storage device or system. In another example, program instructions 3318 can be located in computer-readable media 3320 that is distributed in multiple data processing systems. In other words, some instructions in program instructions 3318 can be located in one data processing system while other instructions in program instructions 3318 can be located in one data processing system. For example, a portion of program instructions 3318 can be located in computer-readable media 3320 in a server computer while another portion of program instructions 3318 can be located in computer-readable media 3320 located in a set of client computers.

The different components illustrated for data processing system 3300 are not meant to provide architectural limitations to the manner in which different embodiments can be implemented. In some illustrative examples, one or more of the components may be incorporated in or otherwise form a portion of, another component. For example, memory 3306, or portions thereof, may be incorporated in processor unit 3304 in some illustrative examples. The different illustrative embodiments can be implemented in a data processing system including components in addition to or in place of those illustrated for data processing system 3300. Other components shown in FIG. 33 can be varied from the illustrative examples shown. The different embodiments can be implemented using any hardware device or system capable of running program instructions 3318.

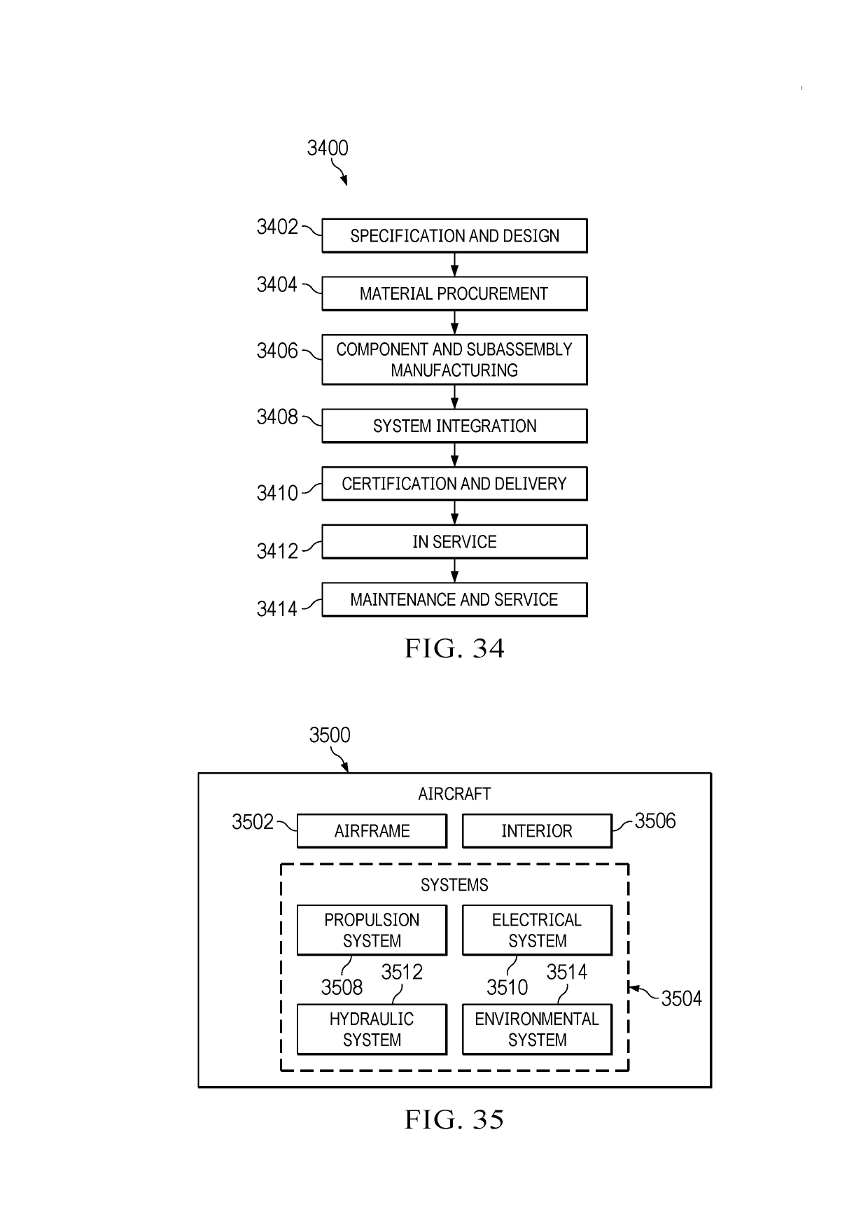

Illustrative embodiments of the disclosure may be described in the context of aircraft manufacturing and service method 3400 as shown in FIG. 34 and aircraft 3500 as shown in FIG. 35. Turning first to FIG. 34, an illustration of a block diagram of an aircraft manufacturing and service method is depicted in accordance with an illustrative embodiment. During pre-production, aircraft manufacturing and service method 3400 may include specification and design 3402 of aircraft 3500 in FIG. 35 and material procurement 3404.

During production, component and subassembly manufacturing 3406 and system integration 3408 of aircraft 3500 in FIG. 35 takes place. Thereafter, aircraft 3500 in FIG. 35 can go through certification and delivery 3410 in order to be placed in service 3412. While in service 3412 by a customer, aircraft 3500 in FIG. 35 is scheduled for routine maintenance and service 3414, which may include modification, reconfiguration, refurbishment, and other maintenance or service.

Each of the processes of aircraft manufacturing and service method 3400 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a government entity, a service organization, and so on.

With reference now to FIG. 35, an illustration of a block diagram of an aircraft is depicted in which an illustrative embodiment may be implemented. In this example, aircraft 3500 is produced by aircraft manufacturing and service method 3400 in FIG. 34 and may include airframe 3502 with plurality of systems 3504 and interior 3506. Examples of systems 3504 include one or more of propulsion system 3508, electrical system 3510, hydraulic system 3512, and environmental system 3514. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 3400 in FIG. 34.

In one illustrative example, components or subassemblies produced in component and subassembly manufacturing 3406 in FIG. 34 can be fabricated or manufactured in a manner similar to components or subassemblies produced while aircraft 3500 is in service 3412 in FIG. 34. As yet another example, one or more apparatus embodiments, method embodiments, or a combination thereof can be utilized during production stages, such as component and subassembly manufacturing 3406 and system integration 3408 in FIG. 34. One or more apparatus embodiments, method embodiments, or a combination thereof may be utilized while aircraft 3500 is in service 3412, during maintenance and service 3414 in FIG. 34, or both. The use of a number of the different illustrative embodiments may substantially expedite the assembly of aircraft 3500, reduce the cost of aircraft 3500, or both expedite the assembly of aircraft 3500 and reduce the cost of aircraft 3500.

For example, anomaly prediction system 202 in FIG. 2 can be used during at least one of in service 3412 or maintenance and service 3414 to determine whether maintenance is needed for aircraft 3500. In this manner, maintenance can be determined more accurately and with more time to schedule maintenance for aircraft 3500. As a result, unexpected maintenance can occur less often resulting in aircraft 3500 being in service with more predictability.

Some features of the illustrative examples are described in the following clauses. These clauses are examples of features and are not intended to limit other illustrative examples.

Clause A1:

An anomaly prediction system comprising:

a computer system; and

an anomaly analysis system in the computer system, wherein the anomaly analysis system comprises:

a machine learning model system configured to output images with a number of parameters predicted for subsurface anomalies on platforms for a current time frame using inputs comprising input images of the platforms, reference time frames before the current time frames, and historical platform data for the platforms; and

an anomaly predictor in the computer system, wherein the anomaly predictor is configured to perform operations comprising:

identifying an input image of a location on a platform at a current time frame, a reference time frame before the current time frame, and the historical platform data from the reference time frame before the current time frame;

generating an output image of the location with the number of parameters for a subsurface anomaly at the location using the input image, the reference time frame, the historical platform data, and the anomaly analysis system in response to identifying the input image of the location on the platform at the current time frame, the reference time frame before the current time frame, and the historical platform data from the reference time frame to the current time frame; and

performing a number of actions based on the output image of the location with the number of parameters for the subsurface anomaly at the location.

Clause A2:

The anomaly prediction system of clause A1, wherein input image is in a first imaging modality and the output image is in a second imaging modality.

Clause A3:

The anomaly prediction system of clause A1, wherein a surface anomaly is present in the input image.

Clause A4:

The anomaly prediction system of clause A1, wherein the number of actions comprises at least one of changing an operational status of the platform based on the number of parameters predicted, storing the output image, generating an alert in response to the output image for the number of parameters predicted for the subsurface anomaly at the future time frame being out of a tolerance, scheduling maintenance for the platform, displaying the output image, or sending an email message with the output image.

Clause A5:

The anomaly prediction system of clause A1, wherein the machine learning model system outputs images in the form of output masks and wherein the anomaly analysis system further comprises:

a generative artificial intelligence model that is configured to create the output image from an output mask output by the machine learning model system.

Clause A6:

The anomaly prediction system of clause A1, further comprising:

a sensor system configured to generate the input image.

Clause A7:

The anomaly prediction system of clause A1, wherein the platform data comprises at least one of weather data, platform telemetry, temperature, a pressure, an acceleration, an engine temperature, a hydraulic pressure, a vibration, a tail number, maintenance data, a pilot identification, flight hours, engine cycles, flight cycles, or route information.

Clause A8:

The anomaly prediction system of clause A1, further comprising:

a trainer configured to perform training operations comprising:

identifying first images of locations at first times on a test platform;

identifying second images of the locations at second times on the test platform in which a number of anomalies are present;

identifying platform data for the test platform from the first times to the second times;

forming a training dataset using the first images, the second images, and the platform data; and

training a machine learning model in the machine learning model system using the training dataset.

Clause A9:

The anomaly prediction system of clause A8, wherein the training dataset further comprises material performance data.

Clause A10:

A method for predicting a subsurface anomaly comprising:

identifying an input image of a location on a platform at a current time frame, a reference time frame before the current time frame, and the historical platform data from the reference time frame before the current time frame;

generating an output image of the location with a number of parameters for a subsurface anomaly at the location using the input image, the reference time frame, the historical platform data, and the anomaly analysis system in response to identifying the input image of the location on the platform at the current time frame, the reference time frame before the current time frame, and the historical platform data from the reference time frame to the current time frame, wherein the machine learning model system is configured to output images with a number of parameters predicted for subsurface anomalies on platforms for current time frames using inputs comprising input images of the platforms, reference time frames before the current time frames, and historical platform data for the platforms; and

performing a number of actions based on the output image of the location with the number of parameters for the subsurface anomaly at the location.

Clause B1:

An anomaly prediction system comprising:

a computer system; and

an anomaly analysis system in the computer system, wherein the anomaly analysis system comprises:

a machine learning model system configured to output images with a number of parameters predicted for anomalies at anomaly locations on platforms for future time frames using inputs comprising input images of the platforms at image locations and platform data for the platforms from reference time frames to the future time frames; and

an anomaly predictor in the computer system, wherein the anomaly predictor is configured to perform operations comprising:

identifying an input image of an image location on a platform at a reference time frame, a future time frame after the reference time frame, and the platform data from the reference time frame to the future time frame;

generating an output image of an anomaly location with the number of parameters for an anomaly on the platform using the input image at the image location, the future time frame, the platform data, and the anomaly analysis system in response to identifying the input image at the image location on the platform at the reference time frame, the future time frame after the reference time frame, and the platform data from the reference time frame to the future time frame; and

performing a number of actions based on the output image of the anomaly location with the number of parameters for the anomaly on the platform.

Clause B2:

The anomaly prediction system of clause B1, wherein the image location is different from the anomaly location.

Clause B3:

The anomaly prediction system of clause B1, wherein the inputs to the machine learning model system further comprises material performance data and wherein the anomaly predictor is further configured to:

identify material performance data.

Clause B4:

The anomaly prediction system of clause B1, wherein the number of actions comprises at least one of changing an operational status of the platform based on the number of parameters predicted, storing the output image, generating an alert in response to the output image for the number of parameters predicted for the subsurface anomaly at the future time frame being out of a tolerance, scheduling maintenance for the platform, displaying the output image, or sending an email message with the output image.

Clause B5:

The anomaly prediction system of clause B1, wherein the machine learning model system outputs images in a form of output masks and wherein the anomaly analysis system further comprises:

a generative artificial intelligence model that is configured to create the output image from an output mask output by the machine learning model system.

Clause B6:

The anomaly prediction system of clause B1, further comprising:

a sensor system configured to generate the input image.

Clause B7:

The anomaly prediction system of clause B1, wherein the platform is selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, an unmanned aerial vehicle, an artificial intelligence controlled drone, a surface ship, a tank, a personnel carrier, a train, a spacecraft, a space station, a satellite, a high altitude platform system (HAPS), a submarine, an automobile, a power plant, a bridge, a dam, a house, a manufacturing facility, and a building.

Clause B8.

A method for predicting an anomaly at an anomaly location comprising:

identifying an input image of an image location on a platform at a reference time frame, a future time frame after the reference time frame, and the platform data from the reference time frame to the future time frame;

generating an output image of an anomaly location with the number of parameters for an anomaly on the platform using the input image at the image location, the future time frame, the platform data, and the anomaly analysis system in response to identifying the input image at the image location on the platform at the reference time frame, the future time frame after the reference time frame, and the platform data from the reference time frame to the future time frame, wherein the anomaly analysis system comprises a machine learning model system configured to output images with a number of parameters predicted for anomalies at anomaly locations on platforms for future time frames using inputs comprising input images of the platforms at image locations and platform data for the platforms from the reference time frame to the future time frames; and

performing a number of actions based on the output image of the anomaly location with the number of parameters for the anomaly on the platform.

Clause C1:

An anomaly prediction system comprising:

a computer system;

an anomaly analysis system in the computer system, wherein the anomaly analysis system comprises:

a machine learning model system configured to output images with a number of parameters predicted for anomalies at locations on platforms at future time frames using inputs comprising input images of the platforms and the future time frames; and

an anomaly predictor in the computer system, wherein the anomaly predictor is configured to perform operations comprising:

identifying an input image of a location on a platform selected for inspection;

generating an output image with the number of parameters for an anomaly at a location that predicts a change in the anomaly at the location on the platform at the future time frame using the input image at the location of the platform and the anomaly analysis system; and

performing a number of actions based on the output image with the number of parameters for an anomaly at the location that predicts a change in the anomaly at the location on the platform at the future time frame.

Clause C2:

The anomaly prediction system of clause C1, wherein the input further comprises at least one of expected platform data, historical platform data, or material data from a reference time frame to the future time frame.

Clause C3:

The anomaly prediction system of clause C1, wherein the anomaly is selected from a group comprising a surface anomaly and a subsurface anomaly.

Clause C4:

The anomaly prediction system of clause C1, wherein the change in the anomaly is selected from at least one of a change in a size of the anomaly, a type of the anomaly, or a severity of the anomaly at the future time frame.

Clause C5:

The anomaly prediction system of clause C1, wherein the input image is for a surface anomaly at a reference time frame and the output image is for the anomaly in a form of a subsurface anomaly at the reference time frame.

Clause C6:

The anomaly prediction system of clause C1, wherein the input image is for a surface anomaly at a reference time frame and the output image is for the anomaly in a form of a subsurface anomaly at a future time frame.

Clause C7:

The anomaly prediction system of clause C1, wherein the number of actions comprises at least one of changing an operational status of the platform based on the number of parameters predicted, storing the output image, generating an alert in response to the output image for the number of parameters predicted for the subsurface anomaly at the future time frame being out of a tolerance, scheduling maintenance for the platform, displaying the output image, or sending an email message with the output image.

Clause C8:

The anomaly prediction system of clause C1, wherein the machine learning model system outputs images in a form of output masks and wherein the anomaly analysis system further comprises:

a generative artificial intelligence model that is configured to create the output image from an output mask output by the machine learning model system.

Clause C9:

The anomaly prediction system of clause C1, further comprising:

a sensor system configured to generate the input image.

Clause C10:

The anomaly prediction system of clause X1, wherein the platform is selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, an unmanned aerial vehicle, an artificial intelligence controlled drone, a surface ship, a tank, a personnel carrier, a train, a spacecraft, a space station, a satellite, a high altitude platform system (HAPS), a submarine, an automobile, a power plant, a bridge, a dam, a house, a manufacturing facility, and a building.

Clause C11:

A method for predicting anomalies:

identifying an input image of a location on a platform selected for inspection;

generating an output image with a number of parameters for an anomaly at the location that predicts a change in the anomaly at the location on the platform at the future time frame using the input image at the location of the platform and an anomaly analysis system, wherein the anomaly analysis system comprises a machine learning model system configured to output images with the number of parameters predicted for anomalies at locations on platforms at future time frames using inputs comprising input images of the platforms and the future time frames; and

performing a number of actions based on the output image with the number of parameters for an anomaly at the location that predicts a change in the anomaly at the location on the platform at the future time frame.

Thus, the illustrative examples provided a method, apparatus, system, and computer program product for predicting anomalies at future time frames. In one illustrative example, a method predicts an anomaly. An input image of a platform selected for inspection is identified. An output image with a number of parameters predicted for an anomaly on the platform at a future time frame is generated using the input image of the platform, the future time frame, and an anomaly analysis system in response to identifying the input image. The anomaly analysis system comprises a machine learning model system configured to output images with the number of parameters predicted for anomalies on platforms at future time frames using inputs comprising input images of the platforms and the future time frames. A number of actions is performed based on the output image.

Thus, the illustrative examples can predict locations of anomalies over time. In particular, for example, a prediction of a number of parameters for anomalies at a future time frame can be predicted. In these examples, the number of parameters that can be predicted for future time frames can be used to determine how these anomalies may grow, move, propagate, or otherwise change over time.

In these illustrative examples, visualizations in the form of images of parameters for anomalies at future time frames can be output from an anomaly analysis system for use in determining actions that may be performed in response to the generation of these images. For example, these images can be analyzed by at least one of a computer processor or a person to determine whether the anomalies at future time frames are out of tolerance and require some action. These visualizations can take a number of forms as described above. For example, the visualizations can be output images in the form of output masks, intensity images, heat maps, or other types of visualizations.

The predictions for future states of anomalies at future time frames can be used to determine when to perform maintenance on aircraft or other platforms. These predictions can determine when maintenance is needed accurately and with more fidelity as compared to normal maintenance schedules. Thus, the illustrative examples provide a practical application for predicting future states of anomalies.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes,” “including,” “has,” “contains,” and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An anomaly prediction system comprising:
a computer system; and
an anomaly analysis system in the computer system, wherein the anomaly analysis system comprises:
a machine learning model system configured to output images of locations on platforms with parameters predicted for anomalies on platforms for future time frames using inputs comprising input images of locations on the platforms at reference time frames and platform data for the platforms from the reference time frames to the future time frames; and
an anomaly predictor in the computer system, wherein the anomaly predictor is configured to perform operations comprising:
identifying an input image of a location on a platform at a reference time frame, a future time frame after the reference time frame, and the platform data from the reference time frame to the future time frame;
generating an output image of the location with a number of parameters for an anomaly at the location on the platform using the input image, the reference time frame, the future time frame, the platform data, and the anomaly analysis system in response to identifying the input image of the location on the platform at the reference time frame, the future time frame after the reference time frame, and the platform data from the reference time frame to the future time frame; and
performing a number of actions based on the output image of the location with the number of parameters for the anomaly at the location on the platform.

2. The anomaly prediction system of claim 1, wherein the anomalies predicted by the machine learning model system are surface anomalies and subsurface anomalies and wherein the anomaly is selected from a group comprising a surface anomaly and a subsurface anomaly.

3. The anomaly prediction system of claim 1, wherein the anomalies predicted by the machine learning model system are subsurface anomalies and wherein the anomaly is a subsurface anomaly.

4. The anomaly prediction system of claim 1, wherein the anomalies predicted by the machine learning model system are surface anomalies and subsurface anomalies and wherein the anomaly is one of a surface anomaly and a subsurface anomaly.

5. The anomaly prediction system of claim 1, wherein input image is in a first imaging modality and the output image is in a second imaging modality.

6. The anomaly prediction system of claim 1, wherein a surface anomaly is present in the input image and the anomaly is a subsurface anomaly.

7. The anomaly prediction system of claim 1, wherein the number of actions comprises at least one of changing an operational status of the platform based on the number of parameters predicted, storing the output image, generating an alert in response to the output image for the number of parameters predicted for the anomaly at the future time frame being out of a tolerance, scheduling maintenance for the platform, displaying the output image, or sending an email message with the output image.

8. The anomaly prediction system of claim 1, wherein the machine learning model system outputs images in a form of output masks and wherein the anomaly analysis system further comprises:
a generative artificial intelligence model that is configured to create the output image from an output mask output by the machine learning model system.

9. The anomaly prediction system of claim 1, further comprising:
a sensor system configured to generate the input image.

10. The anomaly prediction system of claim 1, wherein the platform data comprises at least one of weather data, platform telemetry, temperature, a pressure, an acceleration, an engine temperature, a hydraulic pressure, a vibration, a tail number, maintenance data, a pilot identification, flight hours, engine cycles, flight cycles, or route information.

11. The anomaly prediction system of claim 1, further comprising:
a trainer configured to perform training operations comprising:
identifying first images of locations at first times for first time frames on a test platform;
identifying second images of the locations at second times for current time frames on the test platform in which a number of anomalies are present;
identifying platform data for the test platform from the first times to the second times;
forming a training dataset using the first images, the second images, and the platform data; and
training a machine learning model in the machine learning model system using the training dataset.

12. The anomaly prediction system of claim 11, wherein the training dataset further comprises material performance data.

13. A method for predicting anomalies, the method comprising:
identifying an input image of a location on a platform at a reference time frame, a future time frame after the reference time frame, and platform data from the reference time frame to the future time frame;
generating an output image of the location with a number of parameters for an anomaly at the location on the platform using the input image, the reference time frame, the future time frame, the platform data, and the anomaly analysis system in response to identifying the input image of the location on the platform at the reference time frame, the future time frame after the reference time frame, and the platform data from the reference time frame to the future time frame, wherein the anomaly analysis system comprises a machine learning model system configured to output images of locations on platforms with parameters predicted for anomalies on platforms for future time frames using inputs comprising input images of locations on the platforms at reference time frames and platform data for the platforms from the reference time frames to the future time frames; and
performing a number of actions based on the output image of the location with the number of parameters for the anomaly at the location on the platform.

14. The method of claim 13, wherein input image is in a first imaging modality and the output image is in a second imaging modality.

15. The method of claim 13, wherein a surface anomaly is present in the input image.

16. The method of claim 13, wherein the number of actions comprises at least one of changing an operational status of the platform based on the number of parameters predicted, storing the output image, generating an alert in response to the output image for the number of parameters predicted for the anomaly at the future time frame being out of a tolerance, scheduling maintenance for the platform, displaying the output image, or sending an email message with the output image.

17. The method of claim 13, wherein the machine learning model system outputs images in a form of output masks wherein the anomaly analysis system further comprises:
a generative artificial intelligence model that is configured to create the output image from an output mask output by the machine learning model system.

18. The method of claim 13, wherein a sensor system generates the input image.

19. The method of claim 13, wherein the platform data comprises at least one of weather data, platform telemetry, temperature, a pressure, an acceleration, an engine temperature, a hydraulic pressure, a vibration, a tail number, maintenance data, a pilot identification, flight hours, engine cycles, flight cycles, or route information.

20. The method of claim 13, further comprising:
identifying first images of locations at first times on a test platform;
identifying second images of the locations at second times on the test platform in which a number of anomalies are present;
identifying platform data for the test platform from the first times to the second times;
forming a training dataset using the first images, the second images, and the platform data; and
training a machine learning model in the machine learning model system using the training dataset.

21. The method of claim 20, wherein the training dataset further comprises material performance data.

22. A computer program product for predicting anomalies, the computer program product comprising:
a set of one or more computer-readable storage media;
program instructions stored on the set of one or more storage media to perform operations comprising:
identifying an input image of a location on a platform at a reference time frame, a future time frame after the reference time frame, and platform data from the reference time frame to the future time frame;
generating an output image of the location with a number of parameters for an anomaly at the location on the platform using the input image, the reference time frame, the future time frame, the platform data, and the anomaly analysis system in response to identifying the input image of the location on the platform at the reference time frame, the future time frame after the reference time frame, and the platform data from the reference time frame to the future time frame, wherein the anomaly analysis system comprises a machine learning model system configured to output images of locations on platforms with parameters predicted for anomalies on platforms for future time frames using inputs comprising input images of locations on the platforms at reference time frames and platform data for the platforms from the reference time frames to the future time frames; and
performing a number of actions based on the output image of the location with the number of parameters for the anomaly at the location on the platform.

23. The computer program product of claim 22, wherein a surface anomaly is present in the input image.
